(19) United States
(12) Patent Application Publication
(10) Pub. No.: US 2025/0363118 A1
(43) Pub. Date: Nov. 27, 2025

(54) INTRA-OPERATIONS OF SUB-SYSTEMS OF A DATABASE SYSTEM

(71) Applicant: Ocient Holdings LLC, Chicago, IL (US)

(72) Inventors: George Kondiles, Highland Park, IL (US); Jacob Walker Trueb, Chicago, IL (US); Philip Joseph Dakin, Chicago, IL (US); David Charles Boutcher, Newcastle upon Tyne (GB); Rob Bestgen, Rochester, MN (US); Jason Arnold, Chicago, IL (US)

(73) Assignee: Ocient Holdings LLC, Chicago, IL (US)

(21) Appl. No.: 19/289,217

(22) Filed: Aug. 4, 2025

Related U.S. Application Data
(63) Continuation-in-part of application No. 18/671,089, filed on May 22, 2024, now Pat. No. 12,380,113.
(63) Continuation-in-part of application No. 18/800,336, filed on Aug. 12, 2024.
(63) Continuation-in-part of application No. 18/619,912, filed on Mar. 28, 2024, now Pat. No. 12,405,896.
Application No. 18/671,089 is a continuation of application No. 18/353,950, filed on Jul. 18, 2023, now Pat. No. 12,032,581.
Application No. 18/353,950 is a continuation of application No. 16/985,723, filed on Aug. 5, 2020, now Pat. No. 11,755,589.
Application No. 18/800,336 is a continuation of application No. 17/932,727, filed on Sep. 16, 2022, now Pat. No. 12,099,504.
Application No. 17/932,727 is a continuation-in-part of application No. 17/073,567, filed on Oct. 19, 2020, now Pat. No. 11,507,578.
(60) Provisional application No. 63/498,881, filed on Apr. 28, 2023.

(51) Int. Cl. G06F 16/2457; G06F 16/22; G06F 16/2455

(52) U.S. Cl. CPC G06F 16/24573; G06F 16/221; G06F 16/2455

(57) ABSTRACT

A database system a data input sub-system, a query and response sub-system, and a store and compute sub-system. The data input sub-system receives, over time, a dataset, temporarily stores it, and converts it into data segments. The query and response sub-system obtains a query regarding data of the dataset prior to the dataset being stored as data segments and provides a query operation regarding the query to the store and compute sub-system. The store and compute sub-system identify data of the dataset for processing via the query operation and determines whether the identified data is stored as a set of data segments within the store and compute sub-system. When not, the store and compute sub-system sends a request for the identified data to the data input sub-system; receives a set of pages in response to the request; and executes the query operation on the received set of pages.

### CROSS REFERENCE TO RELATED APPLICATIONS

The present U.S. Utility Patent application claims priority pursuant to 35 U.S.C. § 120 as a continuation-in-part of U.S. Utility application Ser. No. 18/671,089, entitled “PROCESSING FORMATTED RECORD DATA WITH FIXED AND VARIABLE LENGTHS”, filed May 22, 2024, issuing as U.S. Pat. No. 12,380,113 on Aug. 5, 2025, which is hereby incorporated herein by reference in its entirety and made part of the present U.S. Utility Patent Application for all purposes.

The present U.S. Utility Patent Application also claims priority pursuant to 35 USC § 120 as a continuation-in-part of U.S. Utility application Ser. No. 18/800,336, entitled “DATABASE SYSTEM AND METHOD WITH ARRAY FIELD DISTRIBUTION DATA”, filed Aug. 12, 2024, which is hereby incorporated herein by reference in its entirety and made part of the present U.S. Utility Patent Application for all purposes.

The present U.S. Utility Patent Application also claims priority pursuant to 35 USC § 120 as a continuation-in-part of U.S. Utility application Ser. No. 18/619,912, entitled “PROCESSING INSTRUCTIONS TO INVALIDATE CACHED RESULTANT DATA IN A DATABASE SYSTEM”, filed Mar. 28, 2024, which is hereby incorporated herein by reference in its entirety and made part of the present U.S. Utility Patent Application for all purposes.

U.S. Utility patent application Ser. No. 18/671,089 claims priority pursuant to 35 U.S.C. § 120 as a continuation of U.S. Utility application Ser. No. 18/353,950, entitled “PROCESSING VARIABLE-LENGTH FIELDS VIA FORMATTED RECORD DATA”, filed Jul. 18, 2023, issued as U.S. Pat. No. 12,032,581 on Jul. 9, 2024, which is a continuation of U.S. Utility application Ser. No. 16/985,723, entitled “DELAYING SEGMENT GENERATION IN DATABASE SYSTEMS”, filed Aug. 5, 2020, issued as U.S. Pat. No. 11,755,589 on Sep. 12, 2023, each of which are hereby incorporated herein by reference in their entirety and made part of the present U.S. Utility Patent Application for all purposes.

U.S. Utility patent application Ser. No. 18/800,336 claims priority pursuant to 35 U.S.C. § 120 as a continuation of U.S. Utility application Ser. No. 17/932,727, entitled “UTILIZING ARRAY FIELD DISTRIBUTION DATA IN DATABASE SYSTEMS”, filed Sep. 16, 2022, issued as U.S. Pat. No. 12,099,504 on Sep. 24, 2024, which is a continuation-in-part of U.S. Utility application Ser. No. 17/073,567, entitled “DELAYING EXCEPTIONS IN QUERY EXECUTION”, filed Oct. 19, 2020, issued as U.S. Pat. No. 11,507,578 on Nov. 22, 2022, each of which are hereby incorporated herein by reference in their entirety and made part of the present U.S. Utility Patent Application for all purposes.

U.S. Utility patent application Ser. No. 18/619,912 claims priority pursuant to 35 U.S.C. § 119 (e) to U.S. Provisional Application No. 63/498,881, entitled “PROCESSING INSTRUCTIONS TO INVALIDATE CACHED RESULTANT DATA IN A DATABASE SYSTEM”, filed Apr. 28, 2023, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable

### BACKGROUND OF INVENTION

### Technical Field of Invention

The disclosed subject matter relates to relates generally to computer networking and more particularly to database system and operation.

### DESCRIPTION OF RELATED ART

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system;

FIG. 1A is a schematic block diagram of an embodiment of a database system;

FIG. 2 is a schematic block diagram of an embodiment of an administrative sub-system;

FIG. 3 is a schematic block diagram of an embodiment of a configuration sub-system;

FIG. 4 is a schematic block diagram of an embodiment of a parallelized data input sub-system;

FIG. 5 is a schematic block diagram of an embodiment of a parallelized query and response (Q&R) sub-system;

FIG. 6 is a schematic block diagram of an embodiment of a parallelized data store, retrieve, and/or process (IO& P) sub-system;

FIG. 7 is a schematic block diagram of an embodiment of a computing device;

FIG. 8 is a schematic block diagram of an embodiment of a node of a computing device;

FIG. 9 is a schematic block diagram of an embodiment of operating systems of a computing device;

FIGS. 10-18 are schematic block diagrams of an example of processing a table or data set for storage in the database system;

FIG. 19A is a schematic block diagram of a query execution plan implemented via a plurality of nodes;

FIG. 19B is a schematic block diagram of a plurality of nodes that utilize query operator execution flows;

FIG. 20A is a schematic block diagram of a query processing system that executes an instruction to execute a query expression via execution of a corresponding query accordance with various embodiments;

FIG. 20B is a schematic block diagram of a query processing system that executes an instruction to execute a query expression via accessing of cached query resultant data;

FIG. 20C is a schematic block diagram of a query processing system that executes an instruction to cache a resultant in conjunction with executing a corresponding query expression;

FIG. 20D illustrates an example embodiment of a query request that indicates an instruction to cache query resultant data;

FIG. 20E is a schematic block diagram of a query processing system that implements a resultant cache management module to remove cached resultant data based on processing a cached resultant invalidation instruction;

FIGS. 20F-20G illustrates example embodiments of a cached resultant invalidation instruction;

FIG. 20H is a schematic block diagram of a query processing system that implements a deletion scheduling module of a resultant cache management module to remove cached resultant data over a time window indicated by a corresponding cached resultant invalidation instruction;

FIGS. 20I-20J illustrates example embodiments of a cached resultant invalidation instruction that indicates a time window,

FIGS. 21A-21B are schematic block diagrams of embodiments of a database system that includes a record processing and storage system of the present invention;

FIG. 21C is a is a schematic block diagrams of an embodiment of a page generator,

FIG. 21D is a schematic block diagrams of an embodiment of a page storage system of a record processing and storage system;

FIG. 21E is a schematic block diagrams of a node that implements a query processing module that reads records from segment storage and page storage;

FIG. 22A is a schematic block diagram of a segment generator of a record processing and storage system;

FIG. 22B is a schematic block diagram illustrating operation of a page conversion determination module over time;

FIG. 22C is a schematic block diagram of a cluster key-based grouping module of a segment generator;

FIG. 23A is a schematic block diagram illustrating a record processing and storage system that receives formatted row data from a data source;

FIG. 23B is a schematic block diagram illustrating a record formatting module of a data source;

FIG. 23C is a schematic block diagram illustrating an embodiment of formatted row data;

FIG. 23D is a schematic block diagram illustrating an embodiment of a record processing and storage system that implements a page reader module of the present invention;

FIG. 24A a schematic block diagram illustrating a record formatting module of a data source;

FIG. 24B is a schematic block diagram illustrating an embodiment of formatted row data;

FIG. 24C is a schematic block diagram illustrating an embodiment of a record processing and storage system that implements a dictionary encoding module;

FIGS. 25A-25B are schematic block diagrams illustrating an embodiment of a record processing and storage system that receives row data under different schemas;

FIG. 25C is a schematic block diagram illustrating an embodiment of a schema update module;

FIG. 25D is a schematic block diagram illustrating an embodiment of a record processing and storage system that implements a schema updating module;

FIG. 26A illustrates an embodiment of a database system that implements a distribution data generator,

FIG. 26B illustrates an embodiment of example array field distribution data generated by a distribution data generator;

FIG. 26C illustrates an embodiment of a query processing system that stores dataset distribution data;

FIG. 27A is a schematic block diagram of a query processing system of the present invention;

FIG. 27B illustrates a query execution module that executes an expression evaluation operator,

FIG. 27C illustrates a query execution module that executes a filtering operator,

FIGS. 27D-27E illustrate query execution module that execute example query operator execution flows;

FIG. 27F illustrates a query processing system that executes a query operator execution flow with multiple filtering operators; and

FIG. 27G illustrates a query execution module that executes an intersection operator.

### DETAILED DESCRIPTION OF INVENTION

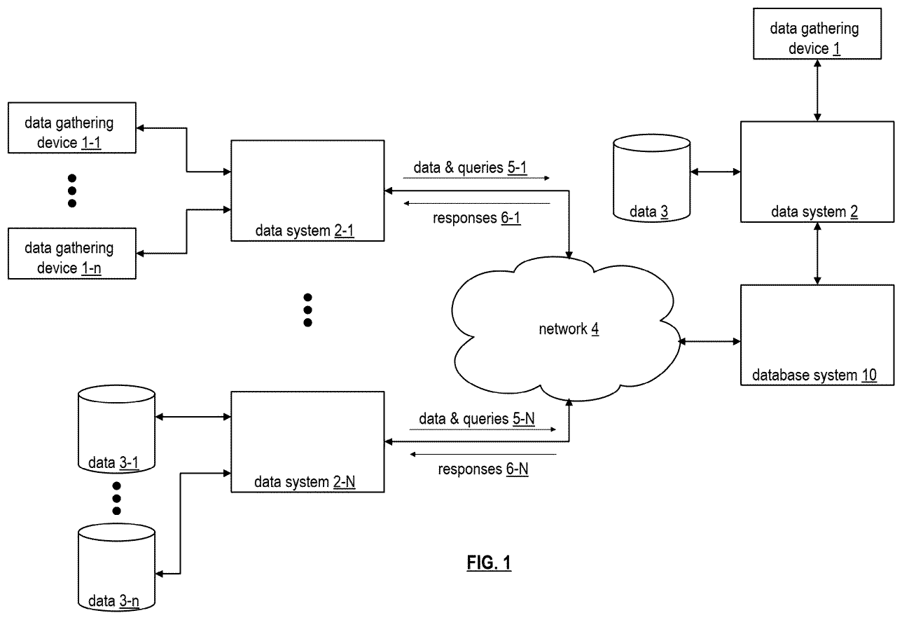

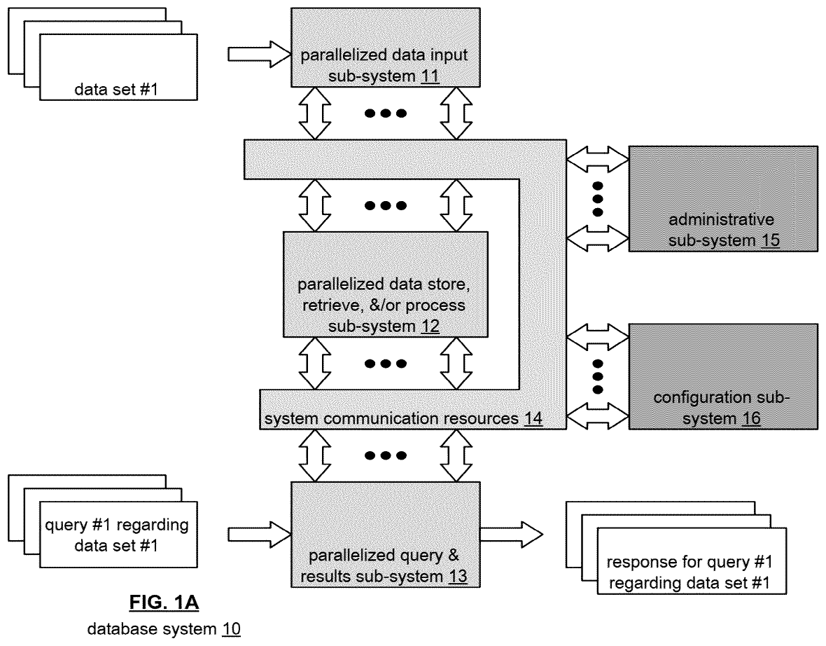

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of wide area network (WAN) connections, local area network (LAN) connections, wireless connections, wireline connections, etc. to couple the sub-systems 11, 12, 13, 15, and 16 together.

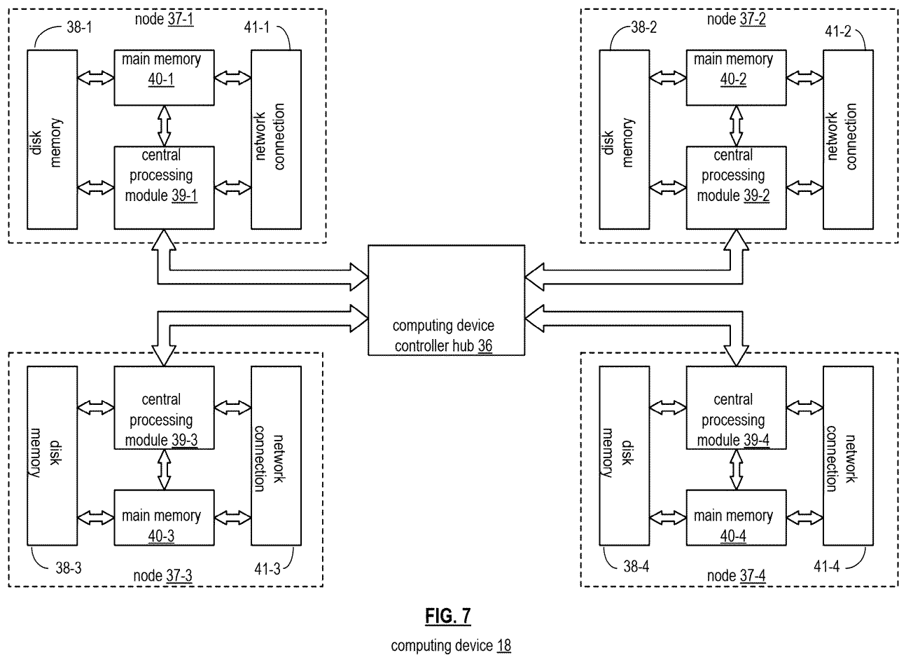

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

As is further discussed with reference to FIG. 15, the data source organizes its records of the data set into a table that includes rows and columns. The columns represent data fields of data for the rows. Each row corresponds to a record of data. For example, a table includes payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches that divide a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition are based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

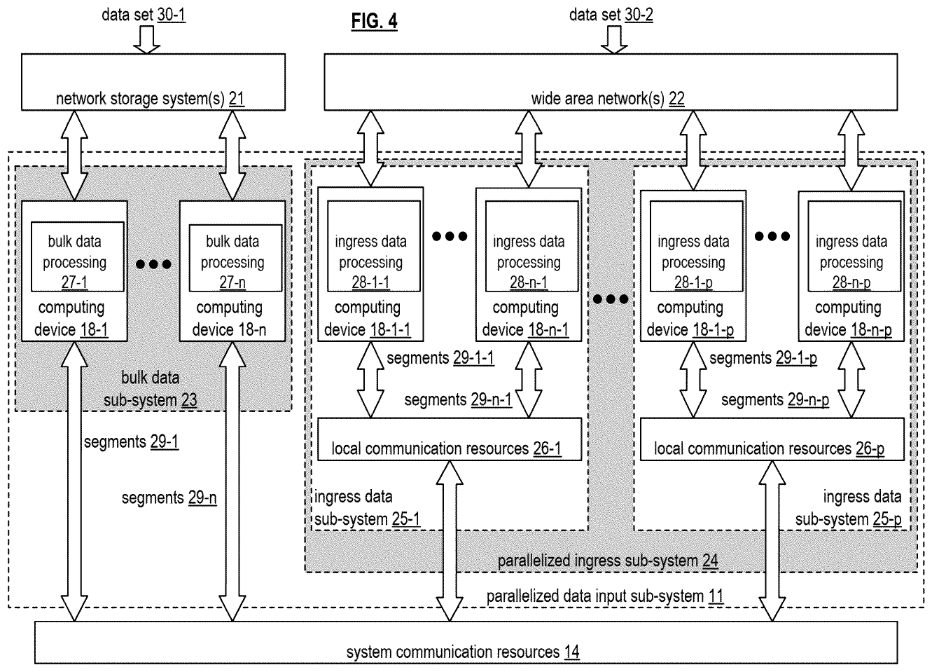

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

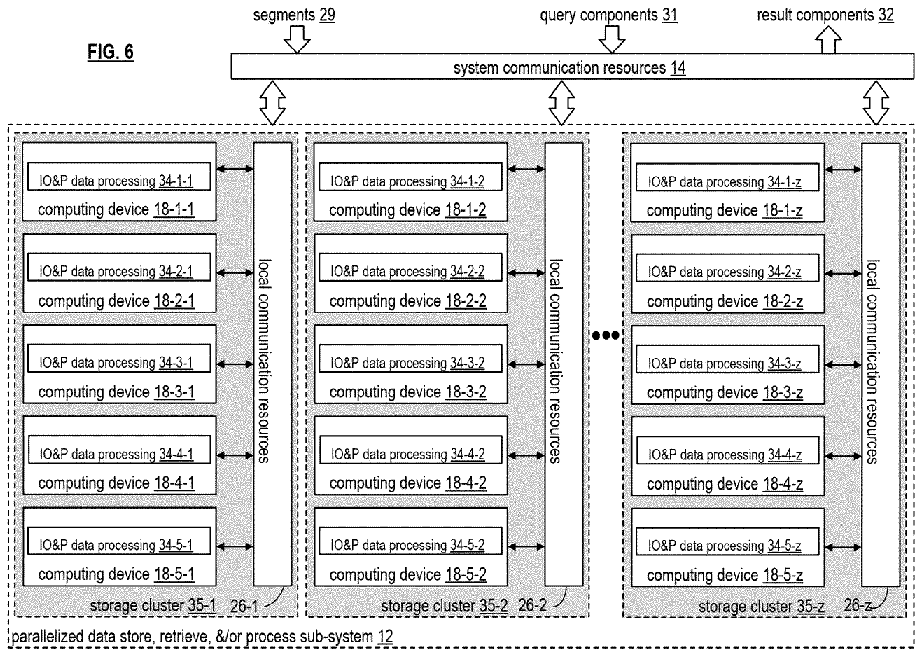

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

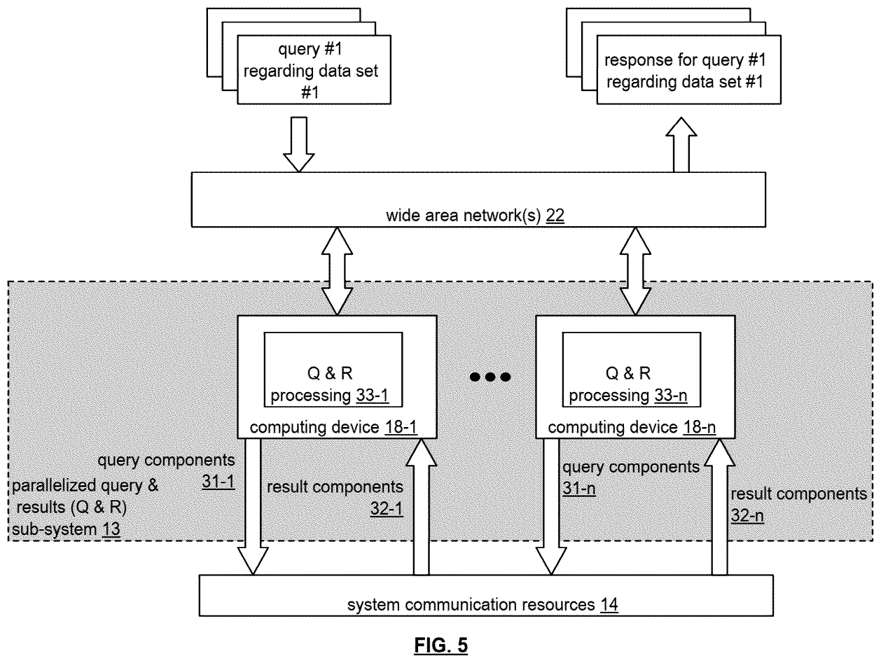

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

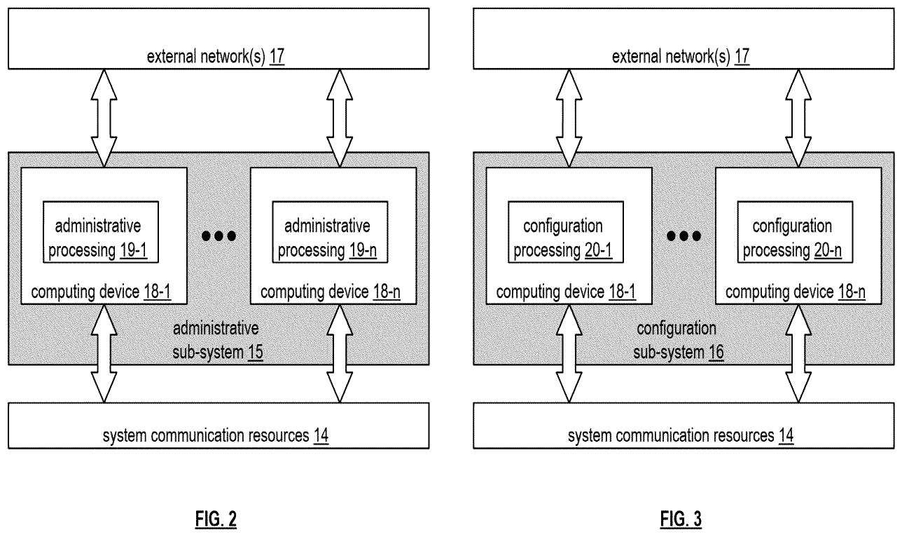

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

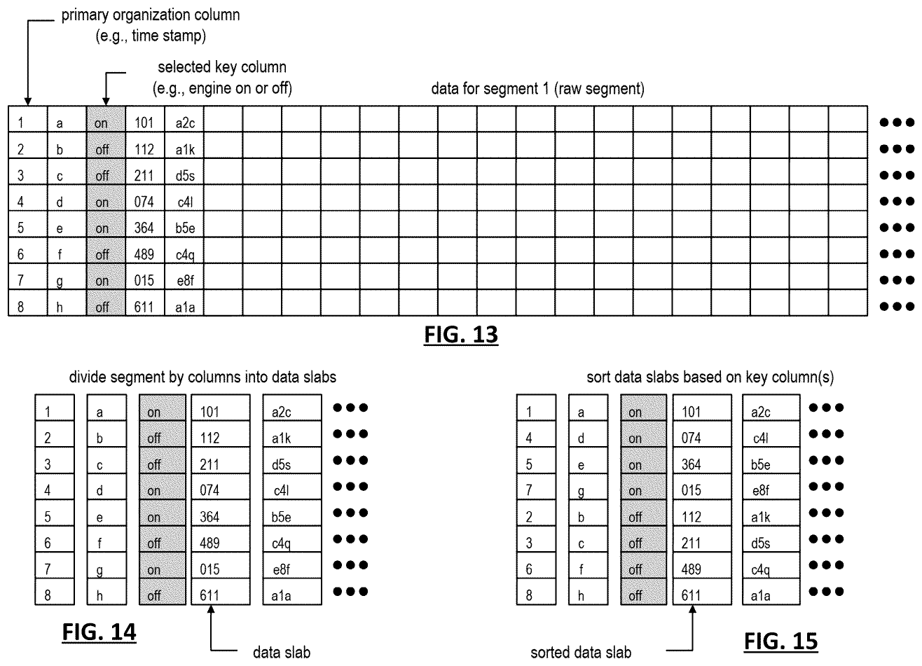

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

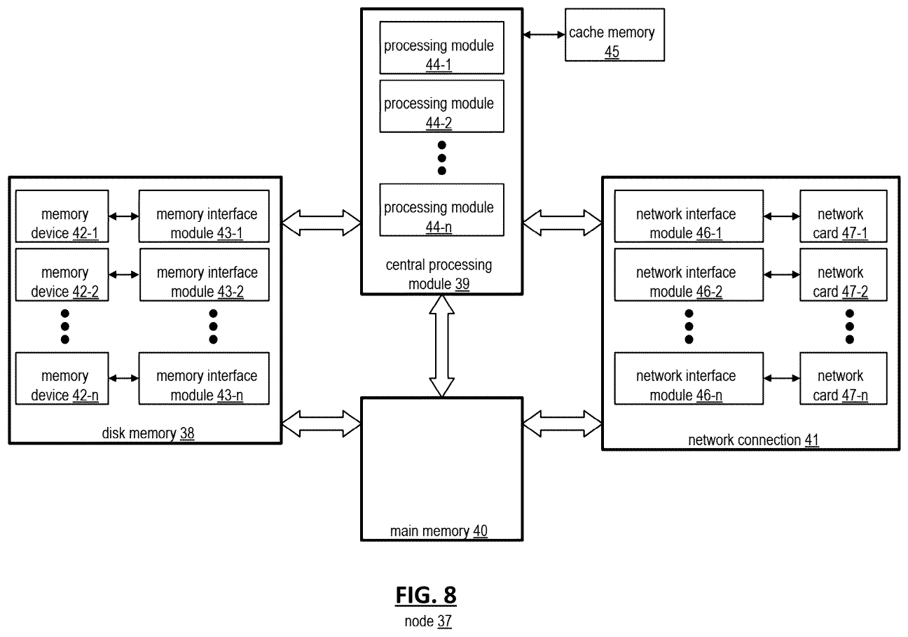

FIG. 8 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

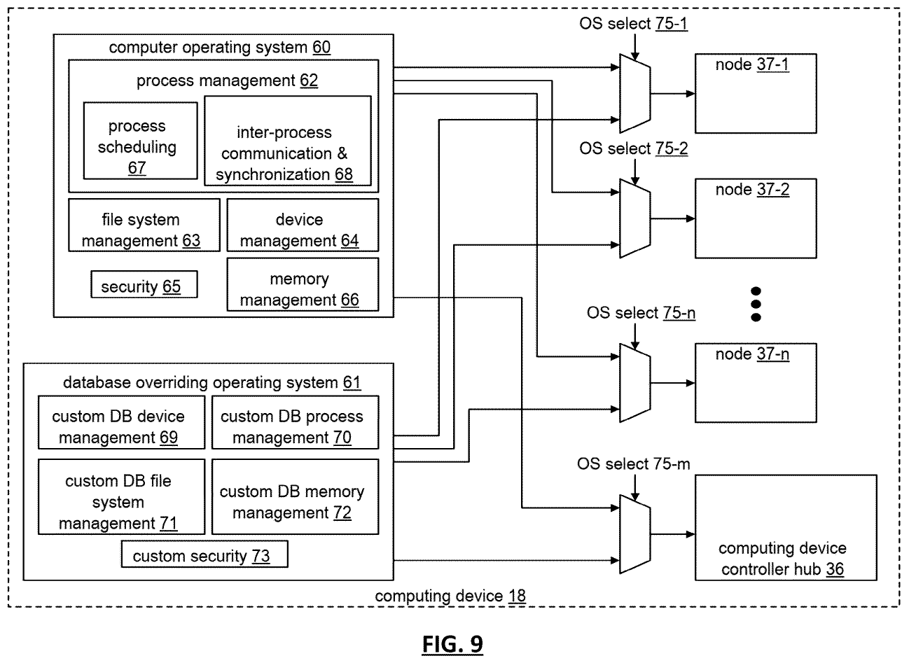

FIG. 9 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many, concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

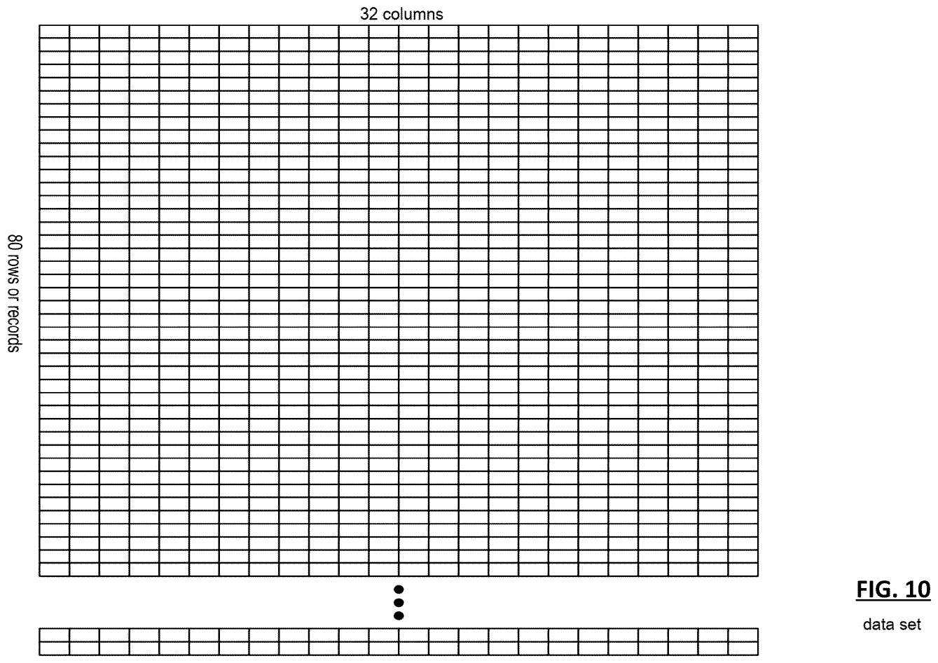

FIGS. 10-18 are schematic block diagrams of an example of processing a table or data set for storage in the database system 10. FIG. 10 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

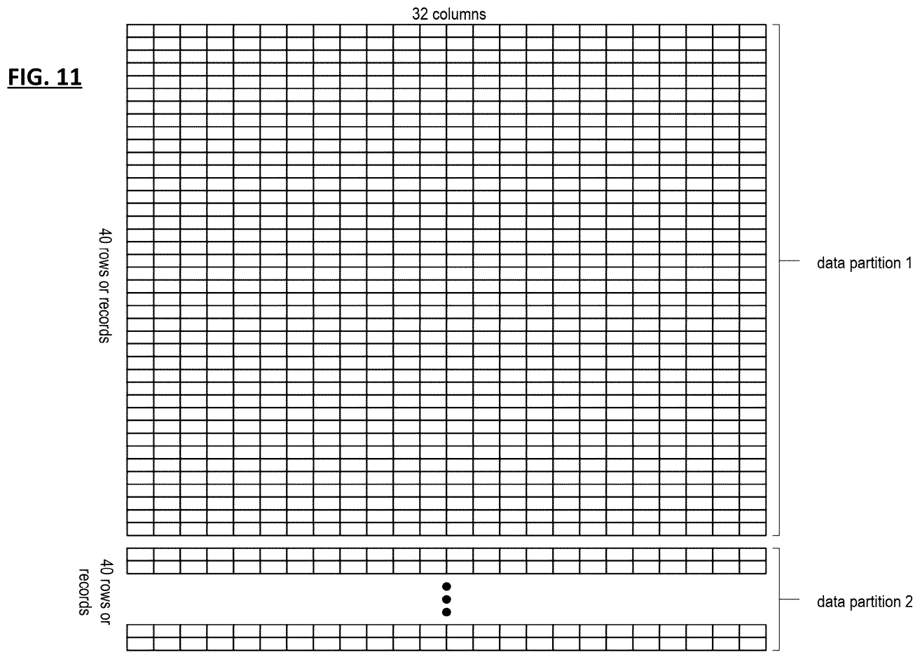

FIG. 11 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

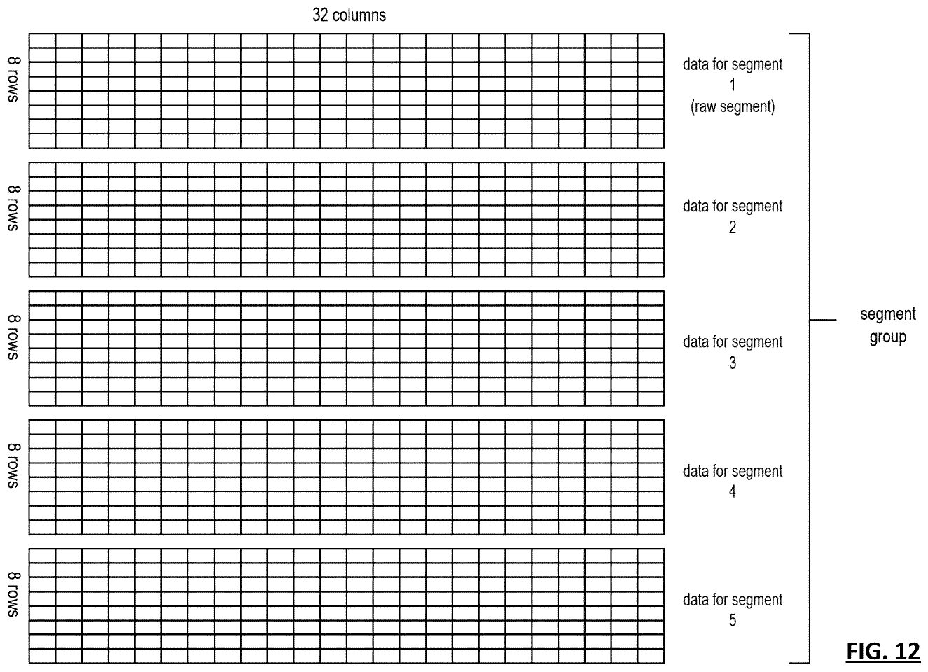

FIG. 12 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

FIG. 13 illustrates an example of data for segment 1 of the segments of FIG. 12. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 14 illustrates an example of the parallelized data input-subsystem dividing segment 1 of FIG. 13 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

FIG. 15 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

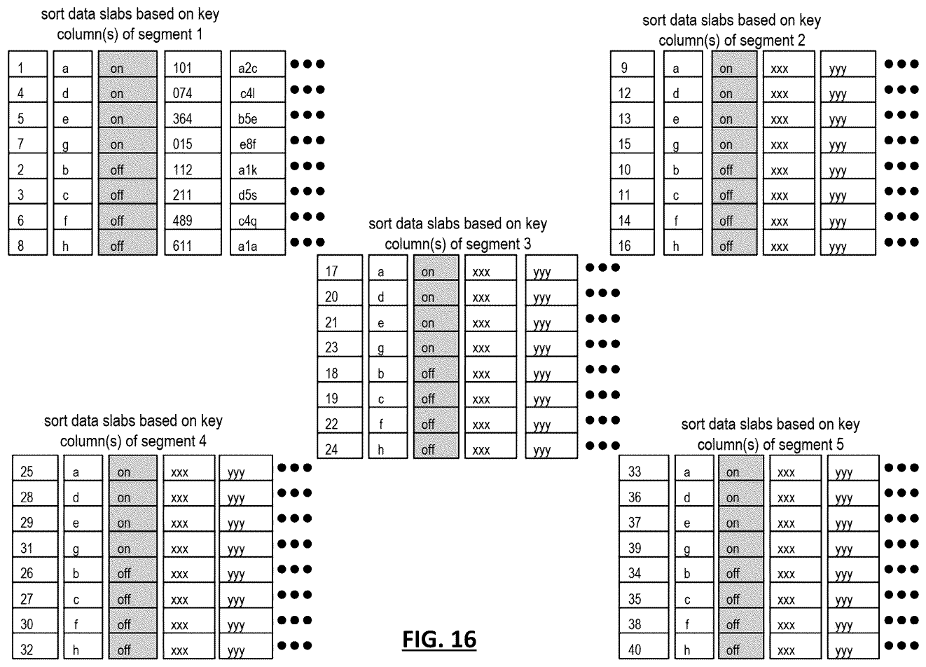

FIG. 16 illustrates an example of each segment of the segment group sorted into sorted data slabs. The similarity of data from segment to segment is for the convenience of illustration. Note that each segment has its own data, which may or may not be similar to the data in the other sections.

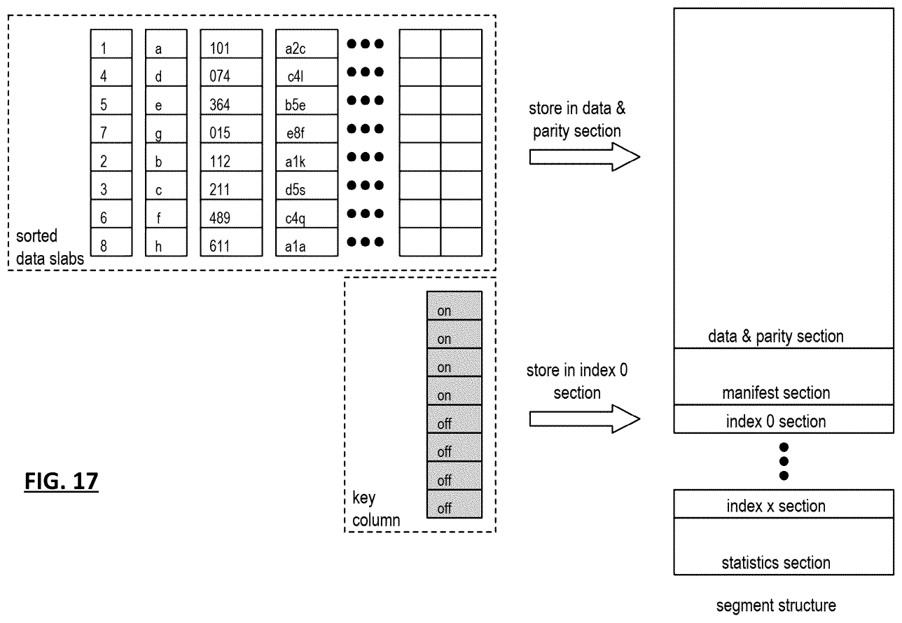

FIG. 17 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

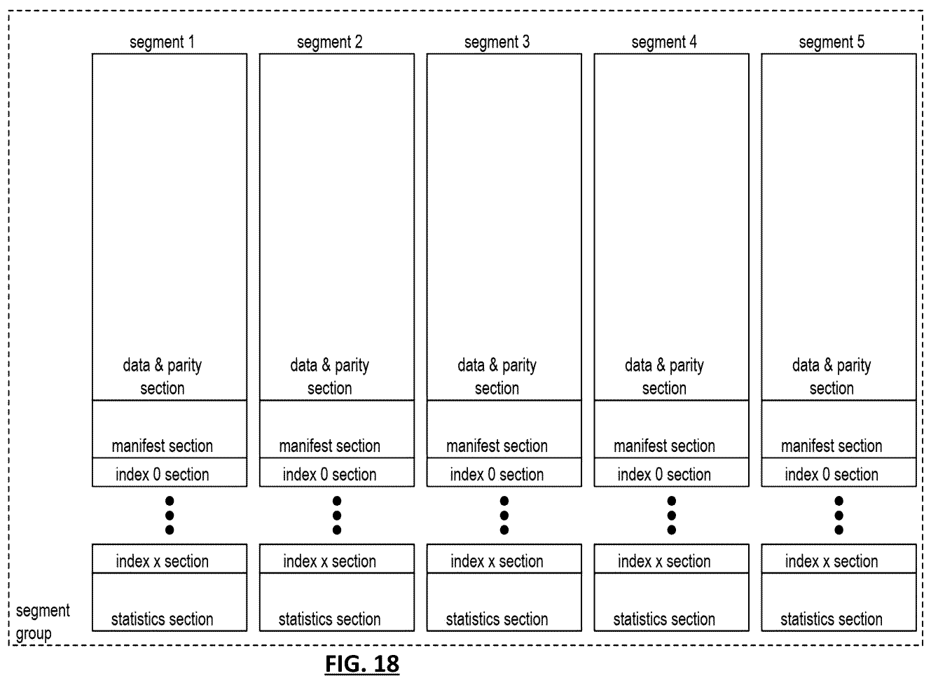

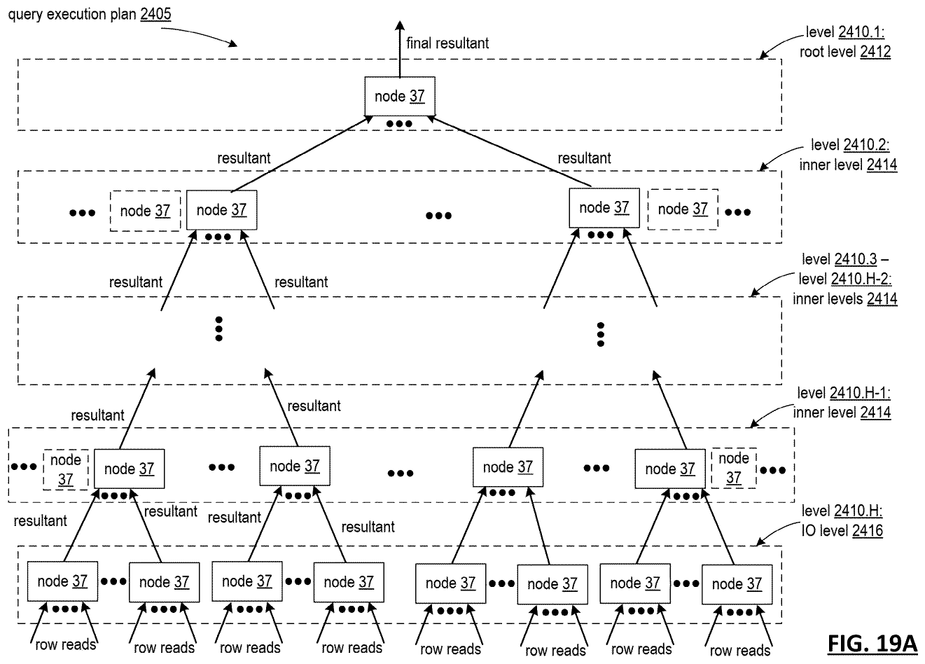

FIG. 18 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

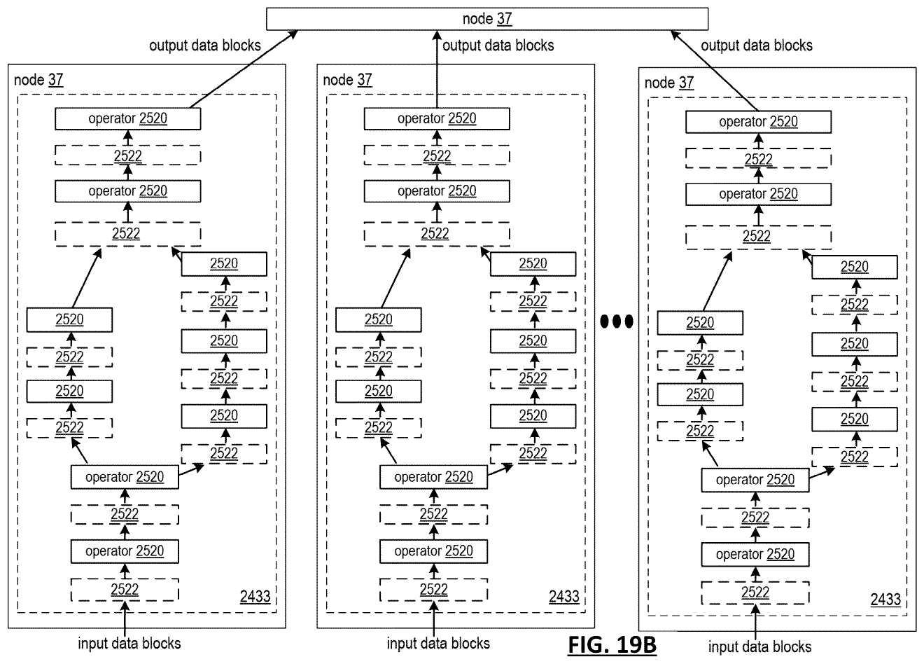

FIG. 19A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H-1, and there are no other inner levels 2410.3-2410.H-2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set 35. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H-1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 19A, resultants are sent by nodes upstream with respect to the tree structure of the query execution plan as they are generated, where the root node generates a final resultant of the query. While not depicted in FIG. 19A, nodes at a same level can share data and/or send resultants to each other, for example, in accordance with operators of the query at this same level dictating that data is sent between nodes.

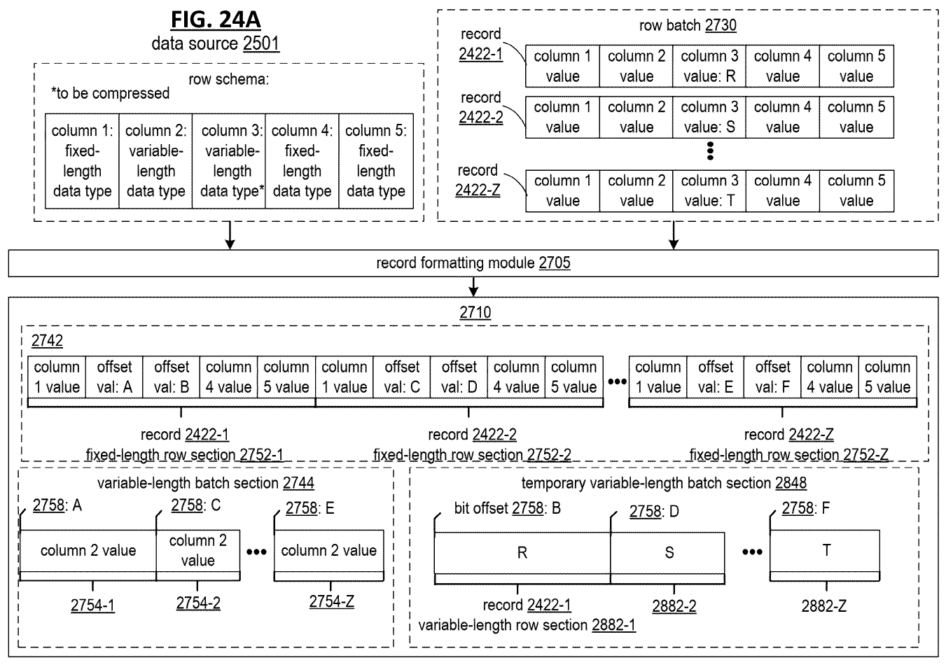

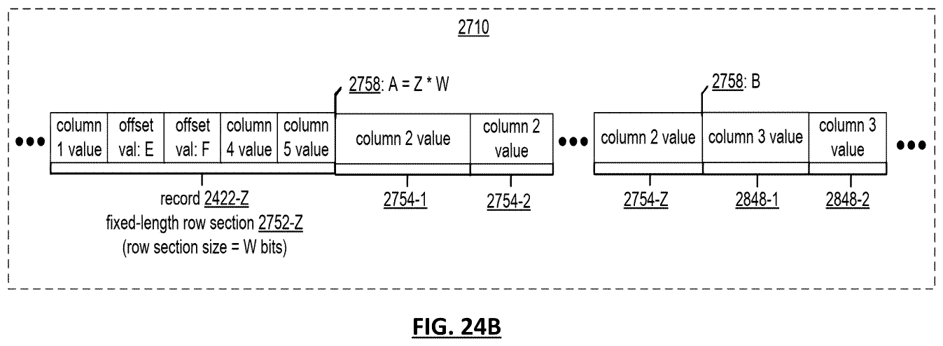

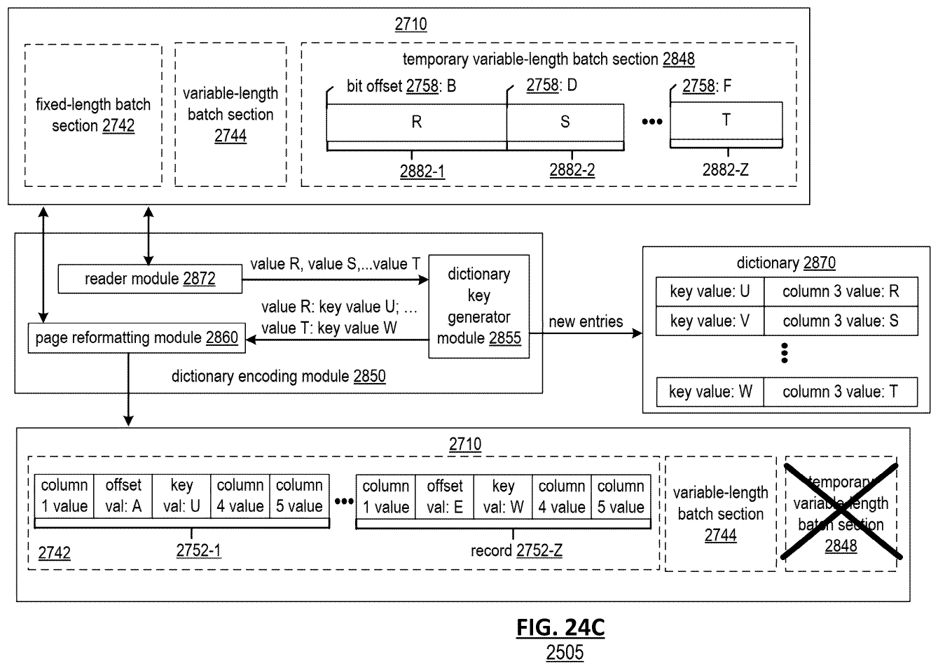

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H-1 includes at least one node from the IO level 2416 in the possible set of nodes. In such cases, while each selected node in level 2410.H-1 is depicted to process resultants sent from other nodes 37 in FIG. 24A, each selected node in level 2410.H-1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

FIG. 19B illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405. This query operator execution flow 2433 utilized by the multiple nodes can be the full query operator execution flow 2517 generated by the operator flow generator module 2514. This query operator execution flow 2433 can alternatively include a sequential proper subset of operators from the query operator execution flow 2517 generated by the operator flow generator module 2514, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433. This can include performing an operator execution upon input data sets 2522 of a corresponding operator 2520, where the output of the operator execution is added to an input data set 2522 of a sequentially next operator 2520 in the operator execution flow where the operators 2520 of the query operator execution flow 2433 are implemented as operators 2520. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

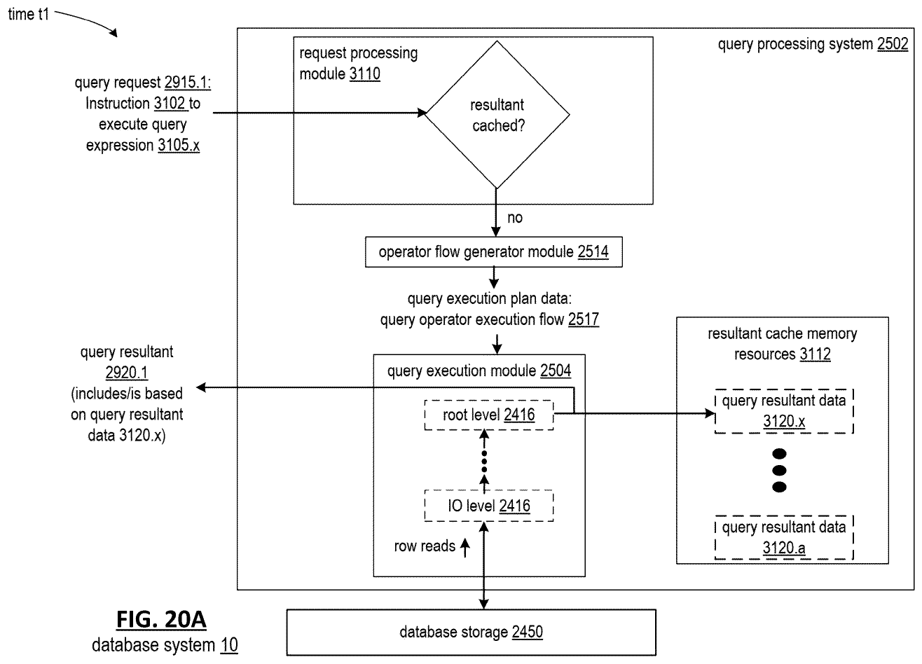

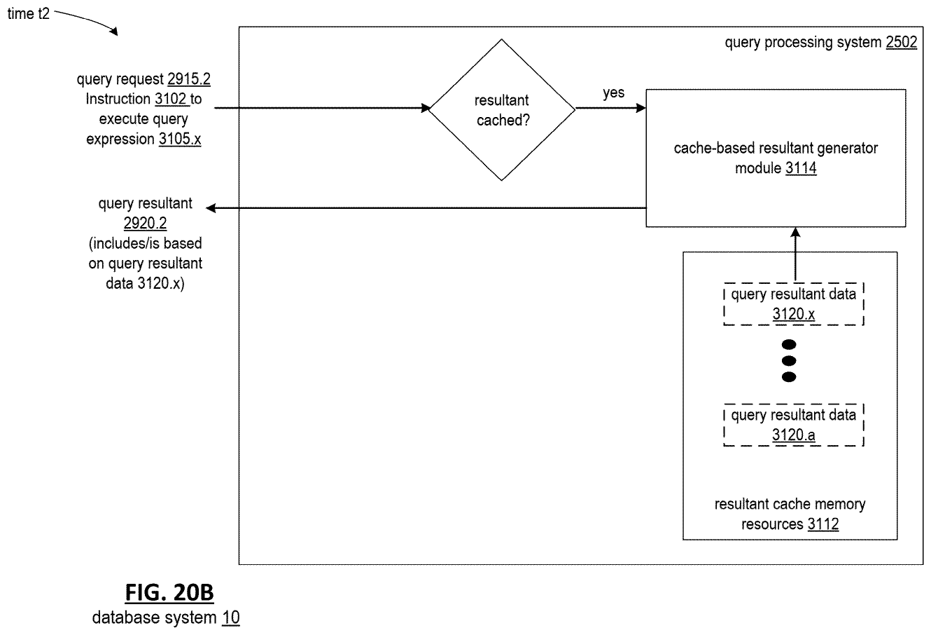

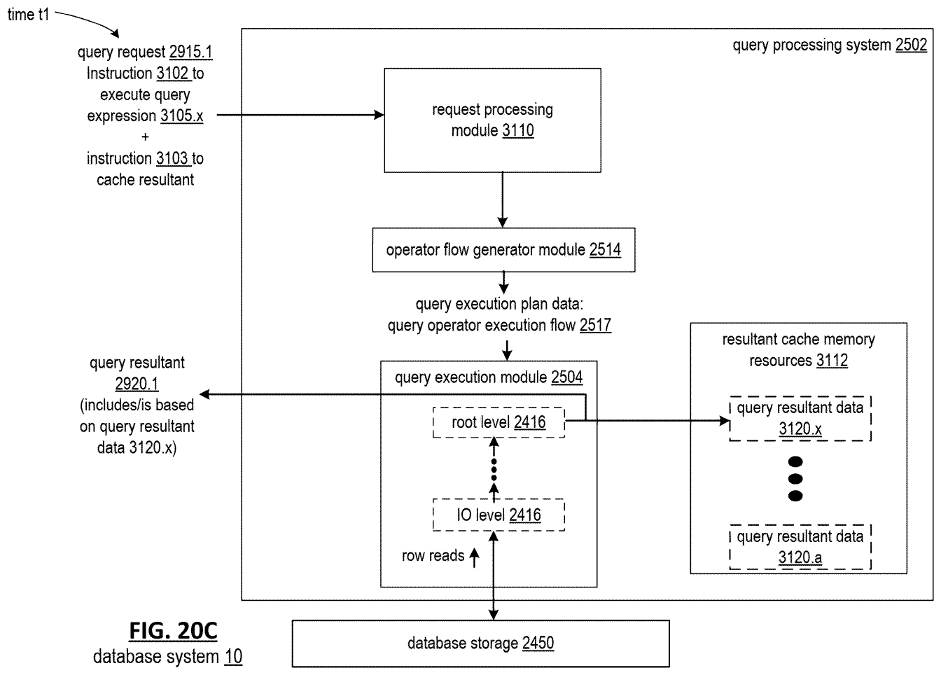

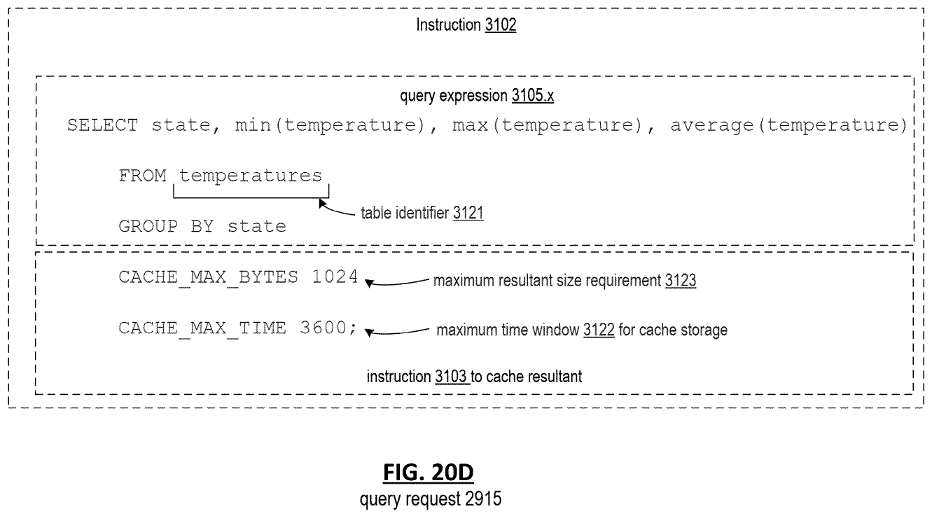

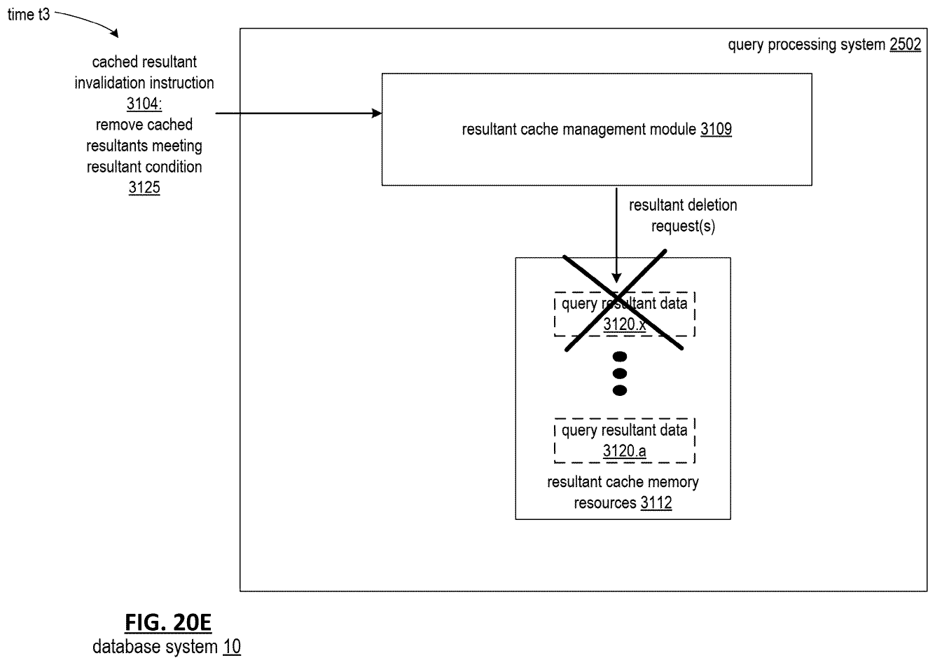

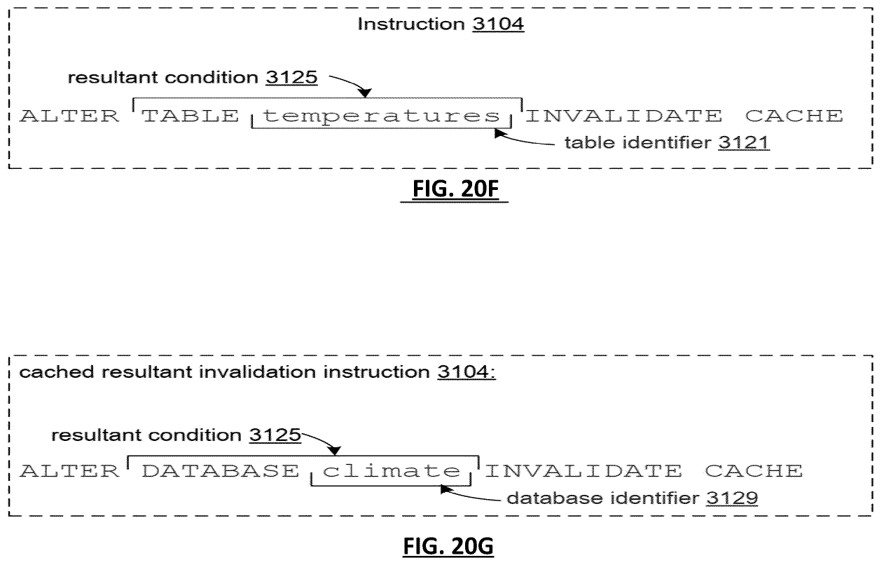

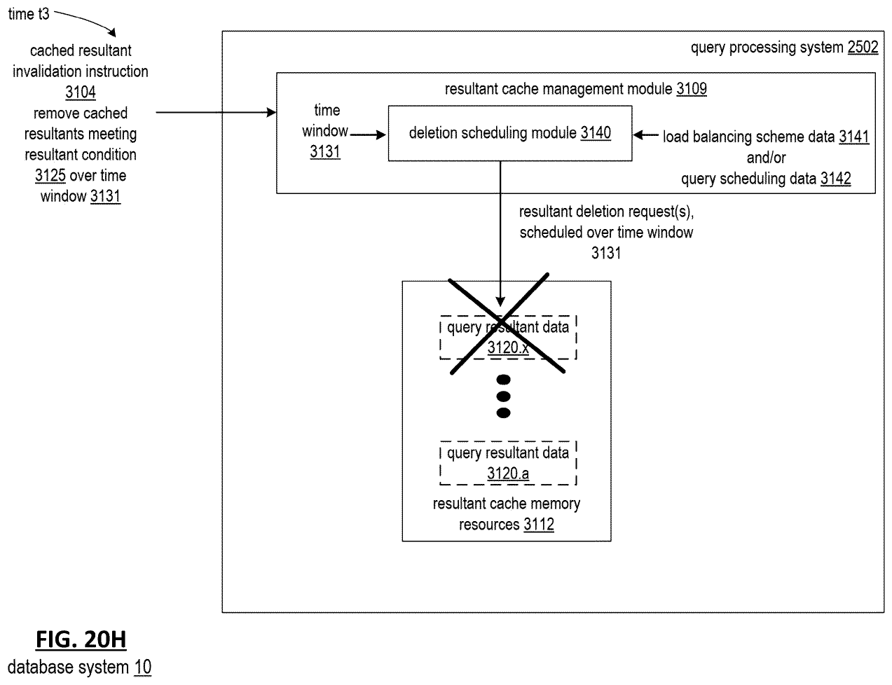

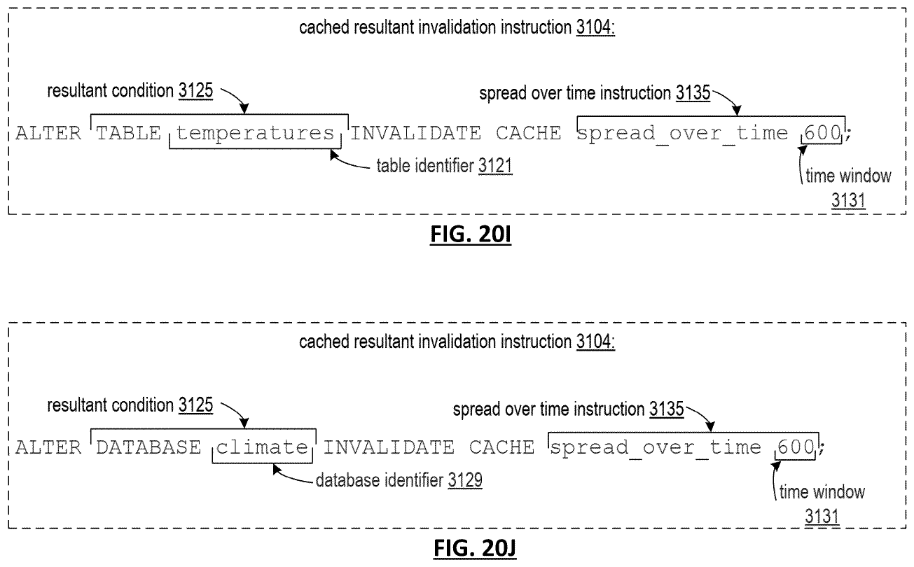

FIGS. 20A-20J illustrate embodiments of a database system 10 operable to cache query resultants 2920 generated via executions of query requests 2915 in cache memory resources 3112 for use in future query executions, and further operable to invalidate cached query resultants from use in future query executions (e.g. remove these resultants from cache memory resources) based on processing corresponding cached resultant invalidation instructions 2504. Some or all features and/or functionality of database system 10 of FIGS. 20A-20J can implement any embodiment of database system 10 described herein.

In some embodiments, database system 10 implements resultant caching which enables query results to be cached and returned if the same query is re-executed. This caching can include caching of the final query resultant and/or of one or more intermediate resultants (e.g. output of one or more operators 2520/one or more nodes 27, prior to the query being completed), where query resultant data for a query resultant 2915 that is cached optionally includes final query resultant and/or of one or more intermediate resultants. Corresponding query resultant data for a query resultant 2915 that is cached optionally includes a set of rows meeting filtering conditions of a query, one or more aggregated value generated via corresponding aggregations in query execution, and/or any other type of final query resultant/partial query resultant. In some embodiments, this resultant caching includes caching resultants for some time window (e.g., cache the resultant for a predetermined period of time, and then delete the resultant from the cache/otherwise make the resultant unavailable for use in query executions). This caching of query resultants can improve the technology of database systems based on reducing/eliminating the need to re-execute some or all queries (e.g. that are known/expected to be executed often, that are known/expected to be executed on static data and/or unchanging data for the time the resultant is cached, and/or that are known/expected to be particularly expensive to execute from a processing/memory consumption perspective).

FIGS. 20A-20C illustrate embodiments of a database system 10 that implements such functionality of caching resultants. Some or all query resultants described herein can be cached and/or utilized in query execution via implementing some or all features and/or functionality of FIGS. 20A-20C.

As illustrated in FIG. 20A, at a first time t1, a given query request 2915.1 indicates a given query expression 3105.x for execution. For example, the query request 2915.1 and/or corresponding query expression 3105.x is received from external requesting entity 2912, is configured via user input, is generated automatically via an automated process, is accessed in memory resources, is determined based on being scheduled for execution, and/or is otherwise determined by a query processing module 2502 of database system 10. The query expression 3105.x can indicate a corresponding query for execution, for example, in accordance with SQL and/or another query language.

A request processing module 3110 can process the request and initiate execution of the corresponding query indicated by query expression 3105.x, for example, via generation of a query operator execution flow 2517 for corresponding execution via a query execution module 2504 via accessing database storage 2450, for example, via some or all functionality of performing query execution described herein. This can include accessing rows stored in one or more segments 2424, accessing and processing corresponding index data, or otherwise performing IO via some or all functionality described herein. This initiating of execution of the query can be based on determining that query resultant data 3120.x for this query expression 3105.x is not currently cached in resultant cache memory resources 3112 and/or is not currently available for use in executing subsequent queries.

In this example, other query resultant data 3120 is stored at time t1 for one or more other query expressions 3105, including another query resultant data 3120.a for a corresponding query expression 3105.a that is different from (e.g., syntactically different and/or further semantically different) from query expression 3105.x.

Query resultant data 3120.x for the given query resultant 2920.1 generated via execution of the query expression 3105.x indicated by query request 2915.1 (e.g. the final resultant, one or more intermediate resultants, other information regarding the query resultant 2920) can be stored in resultant cache memory resources 3112, for example, alternatively or in addition to being sent to a corresponding requesting entity as the query resultant 2920 (e.g. for display/storage/additional processing/other use by the database system 10, by the external requesting entity 2912 that requested the corresponding query be executed, and/or any other processing system/computing device to which the query resultant is determined to be routed for storage/display/processing/other use). The query resultant data 3120.x of the given query expression 3105.x can be cached in resultant cache memory resources 3112 based on an instruction to store the query resultant, for example as discussed in conjunction with FIG. 20C, and/or cached in resultant cache memory resources 3112 based on some other determination. The database system 10 can be operable to cache all resultants generated via query executions (e.g. for same or different periods of time) and/or can be operable to only cache some resultants and not others (e.g. based on for which queries corresponding instructions are received, based on automatically determining which query resultants to cache, for example, based on known/expected frequency of re-execution, how often the corresponding data is updated, how expensive the query is to execute, etc.)

The resultant cache memory resources 3112 can be implemented via any memory resources of database system 10 (e.g., one or more memory devices/memory modules across one or more nodes, via system state data/system metadata mediated via a corresponding consensus protocol across a plurality of nodes, etc.). The resultant cache memory resources 3112 can be distinct from other storage resources (e.g. database storage 2450) utilized to store one or more corresponding datasets, such as relational database rows of one or more corresponding relational database tables that is accessed in query execution (e.g. corresponding segments stored via memory drives 2425 of nodes 37).

As illustrated in FIG. 20B, at a second time t2 that is after time t1, a second query request 2915.2 indicates the given query expression 3105.x for execution. For example, the query request 2915.2 and/or corresponding query expression 3105.x is received from a same or different external requesting entity 2912 that sent the query request 2915.1, is configured via user input, is generated automatically via an automated process, is accessed in memory resources, is determined based on being scheduled for execution, and/or is otherwise determined by a query processing module 2502 of database system 10.

The query expression 3105.x can indicate a corresponding query for execution, for example, in accordance with SQL and/or another query language. The query expression 3105.x of query request 2915.2 can indicate a same as the query expression 3105.x as query request 2915.1 based on query expression 3105.x of query request 2915.2 being syntactically equivalent with the query expression 3105.x of query request 2915.2. Alternatively or in addition, the query expression 3105.x of query request 2915.2 can indicate a same as the query expression 3105.x as query request 2915.1 based on query expression 3105.x of query request 2915.2 being semantically equivalent with the query expression 3105.x of query request 2915.2, even if syntactically different (e.g. the query processing module determines the expressions are syntactically equivalent). Alternatively or in addition, the query expression 3105.x of query request 2915.2 can indicate a same as the query expression 3105.x as query request 2915.1 based on query expression 3105.x of query request 2915.2 indicating generation of a same intermediate resultant (e.g. particular result set of rows, particular aggregation upon a particular result set of rows) as the query expression 3105.x of query request 2915.2, even if they ultimately generate different final resultants (e.g. the query processing module determines the expressions generate same intermediate resultants due to corresponding portions of the query expression being syntactically equivalent, where the cached query resultant data 3120.x is applied in generating the final resultant via query execution module 2504 rather than the final resultant being generated from scratch).

The request processing module 3110 can process the request and, rather than initiating execution of the corresponding query indicated by query expression 3105.x via generation of a query operator execution flow 2517 for corresponding execution via a query execution module 2504, can access and apply the corresponding query resultant data 3120.x cached from execution of the query expression 3105.x at time t1. This can include setting the query resultant 2920.2 as the query resultant data 3120.x, or can include further processing the query resultant data 3120.x (e.g., a corresponding intermediate resultant) via one or more corresponding operators 2520 of a corresponding operator execution flow 2517 to render the query resultant 2920.2.

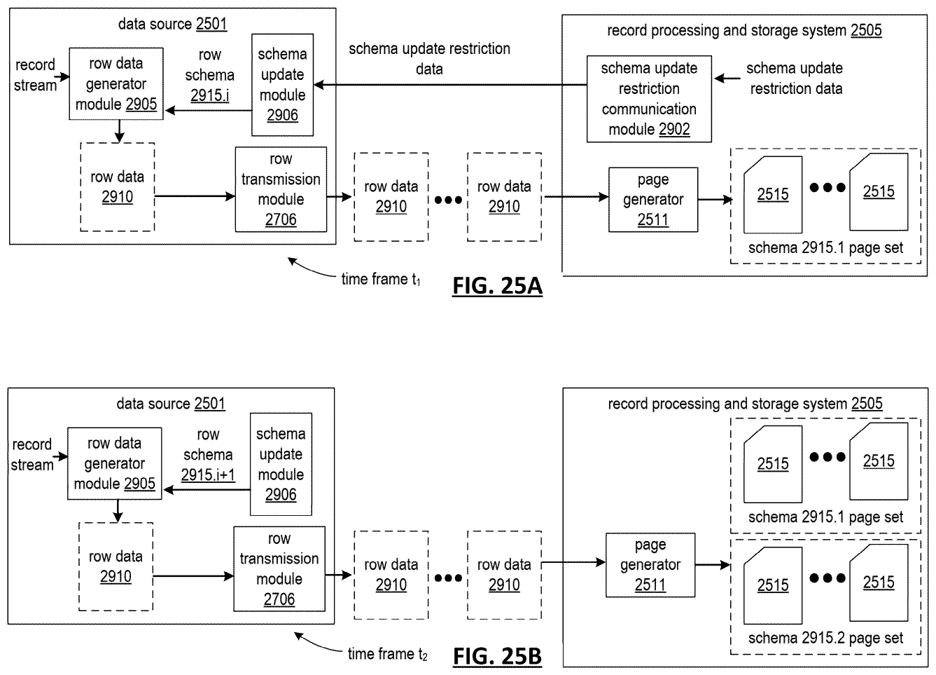

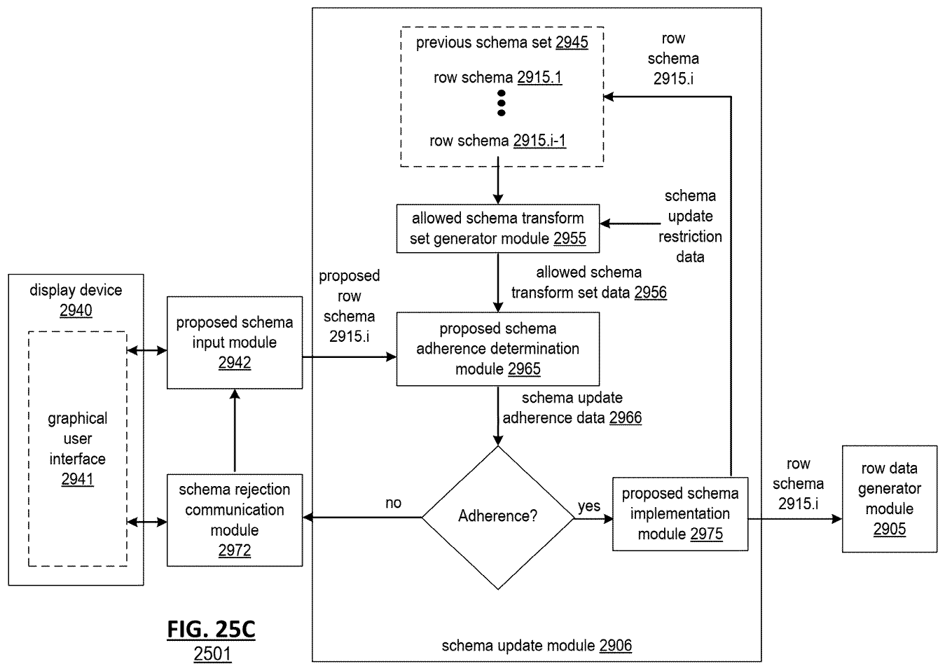

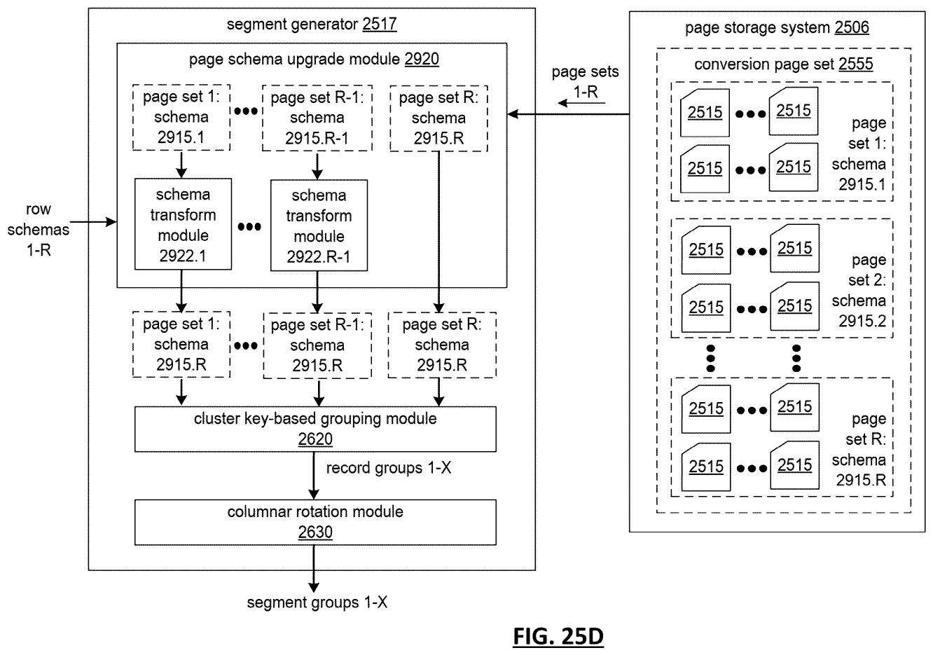

FIG. 20C illustrates an example of a query processing system 2502 caching query resultant data 3120.x generated via executing a given query expression 3105.x in resultant cache memory resources 3112 based on processing an instruction 3103 to store the query resultant. In particular, the instruction 3103 to store the query resultant can be included in/indicated by a corresponding query request 2915.1. Such processing of instruction 3103 to render caching query resultant data 3120.x generated via executing a given query expression 3105.x in resultant cache memory resources 3112 can cause the caching query resultant data 3120.x generated via executing a given query expression 3105.x in resultant cache memory resources 3112 of FIG. 25A, for example, based on the query request 2915.1 of FIG. 25A including the instruction 3103.

FIG. 20D illustrates a particular example embodiment of a query request 2915 that indicates an example query expression 3105 as well as a corresponding instruction 3103 to cache corresponding query resultant data 2920 generated via execution of the query expression 3105.

In this example, query expression 3105 indicates calculation of the minimum, average, and maximum temperatures by state from a “temperatures” table of a dataset, denoted via a corresponding table identifier 3121. For example, this “temperatures” table is a relational database table 2712 stored via database storage 2450, for example, across one or more segments 2424 stored across one or more nodes 37.

In particular, in this example, min( ) average( ), and max( ) can indicate calls to corresponding aggregation operators operable to compute minimum, average, and maximum, respectively, where a GROUP BY clause indicates grouping of each aggregation by state (e.g. a corresponding state column of the temperatures table indicating column values for state, where groups of rows for having each given column value of the state column are grouped and have the corresponding aggregations performed accordingly, rendering generation of a plurality of aggregation values (e.g. a plurality of minimums, maximums, and averages) based on each such aggregation being generated from temperature values (e.g. of a temperature column of the temperatures table) for only rows in a corresponding row group (e.g. having a corresponding column values of a plurality of column values of the state column).

FIGS. 20E-20J illustrate examples of database system 10 enabling such functionality via processing of cached resultant invalidation instructions 3104, where corresponding resultant cached data 3120 is removed from cache memory resources 3112 (e.g., deleted from memory, or otherwise flagged/invalidated from use in processing corresponding query expressions). Some or all features and/or functionality of the processing of cached resultant invalidation instructions 3104 of FIGS. 20E-20J can be implemented in conjunction with the adding and accessing of corresponding cached resultant data 3120 discussed in conjunction with FIGS. 20A-20D, and/or can be implemented in conjunction with any embodiment of database system 10 described herein.

As illustrated in FIG. 20E, query processing system 2502 (and/or other processing resources of database system 10) can receive and process a cached resultant invalidation instruction 3104 at a time t3, for example, that is after times t1 and t2 of FIGS. 20A-20C. The cached resultant invalidation instruction 3104 can be processed by implementing a resultant cache management module 3109 to remove one or more cached resultants accordingly (e.g., via resultant deletion requests sent to/processed by resultant cache memory resources 3112). This can include processing a resultant condition 3125 indicated in the cached resultant invalidation instructions 3104, and removing all query resultant data 3120, and only query resultant data 3120 meeting the resultant condition 3125. In this example, query resultant data 3120.x is removed based on meeting the resultant condition 3125, while resultant data 3120.a is not removed based on not meeting the resultant condition 3125. The resultant cache management module 3109 can be implemented via any processing and/or memory resources of database system 10.

In particular, the resultant condition 3125 can indicate a condition that applies to multiple query resultant data 3120, where multiple query resultant data 3120 are removed accordingly via processing this single instruction 3104. For example, despite each query resultant data 3120 being cached via multiple different instructions (e.g., based on an instruction 3103 included in each corresponding query request 2915), a single instruction 3104 indicates removal of all of these separately generated resultants from the cache based on all meeting resultant condition 3125.

The cached resultant invalidation instruction 3104 can be generated by and/or received by a same or different requesting entity that sent query requests 2915 that rendered generation of and/or access of the cached resultants (e.g. same or different external requesting entity 2912 or same or different processing entity of database system 10 that generated and/or sent the query requests 2915 processed to generate the corresponding query resultant data that is cached, for example, based on including the corresponding instruction 3103, and/or the same or different external requesting entity 2912 or same or different processing entity of database system 10 that further generated and/or sent subsequent query requests 2915 that are processed via accessing the corresponding query resultant data that was previously cached). The resultant condition 3125 can be configured in the cached resultant invalidation instruction 3104 by the requesting entity in conjunction with generating and/or sending the cached resultant invalidation instruction 3104, for example, via user input and/or an automated selection of resultant condition 3125.

Such invalidation of cached resultants via cached resultant invalidation instruction 3104 can improve the technology of database systems, for example, by enabling more granular configuration of caching of resultants for use in subsequent query execution. For example, by making these invalidation commands explicit (rather than, say, automatically invalidating cache entries when any update is made to a table) a corresponding user and/or corresponding automated system can incorporate this function into the appropriate phase of their workflows.

FIGS. 20F-20G illustrates example embodiments of cached resultant invalidation instruction 3104. Some or all features and/or functionality of the cached resultant invalidation instruction 3104 of FIG. 20F and/or 20G can implement the cached resultant invalidation instruction 3104 of FIG. 20E and/or any embodiment of the cached resultant invalidation instruction 3104 described herein.

FIG. 20F illustrates a particular example embodiment of a cached resultant invalidation instruction 3104 that indicates removal of query resultant data associated with a table (e.g. relational database table such as a SQL table) denoted via a corresponding table identifier 3121 (in this case a “temperatures” table, such as the example temperatures table discussed in conjunction with the example of FIG. 20C). The cached resultant invalidation instruction 3104 can be indicated to invalidate caches meeting the specified resultant condition 3125 based on a keyword such as INVALIDATE CACHE, for example, in a corresponding ALTER TABLE instruction. In this example, processing the cached resultant invalidation instruction 3104 renders invalidation of all cached resultant data 3120 generated from table “temperatures” (e.g. based on “temperatures” being indicated in a FROM clause of a SELECT statement of the corresponding query expression 3105, for example, where a cached resultant generated via execution of the example query expression 3105 of FIG. 20D is removed via processing this cached resultant invalidation instruction 3104, in addition to other cached resultants generated via access to the “temperatures” table, but not other cached resultants generated via access to other tables of a corresponding climate database (e.g. a “climate” database) and/or not other tables of other databases.

FIG. 20G illustrates a similar particular example embodiment of a cached resultant invalidation instruction 3104 that indicates removal of query resultant data associated with a database (e.g. relational database such as a SQL database that optionally includes multiple tables) denoted via a corresponding database identifier 3129 (in this case a “climate” database, such as a database that includes the example temperatures table discussed in conjunction with the example of FIG. 20C and/or one or more corresponding tables). The cached resultant invalidation instruction 3104 can be indicated to invalidate caches meeting the specified resultant condition 3125 based on a keyword such as INVALIDATE CACHE, for example, in a corresponding ALTER DATABASE instruction. In this example, processing the cached resultant invalidation instruction 3104 renders invalidation of all cached resultant data 3120 generated from dataset “climate” (e.g. including queries executed for query expressions indicating the database “climate” and/or any of the tables of the climate database, such as “temperatures”, being indicated in a FROM clause of a SELECT statement of the corresponding query expression 3105, for example, where a cached resultant generated via execution of the example query expression 3105 of FIG. 20D is removed via processing this cached resultant invalidation instruction 3104, in addition to other cached resultants generated via access to the “temperatures” table and/or other tables of the climate database, but not other cached resultants generated via access to other tables of a other corresponding databases.

FIG. 20H illustrates an example of a resultant cache management module 3109 of database system 10 processing a cached resultant invalidation instruction 3104 based on implementing a deletion scheduling module 3140 to issue corresponding deletion requests (or other flagging/invalidation of corresponding cached resultants) based on scheduling the deletion requests over a time period dictated by a time window 3131. In particular, the time window 3131 can be included in/indicated by the corresponding indicated by the cached resultant invalidation instruction 3104. Such processing of time window 3131 in conjunction with processing cached resultant invalidation instruction 3104 can implement the processing of cached resultant invalidation instruction 3104 of FIG. 20E, for example, based on the cached resultant invalidation instruction 3104 of FIG. 20E indicating the time window 3131.

The deletion scheduling module 3140 can schedule invalidation of cached resultants meeting the resultant condition 3125 in conjunction with applying load balancing scheme data 3141 and/or in conjunction with processing query scheduling data 3142.

The load balancing scheme data 3141 can indicate an algorithm and/or conditions by which cache entries are deleted from the cache over the time window 3131, for example, to best balance resources involved in the deletions and also involved in query execution. The query scheduling data 3142 can indicate queries currently being executed and/or scheduled for upcoming execution (e.g. scheduled to start or complete within the time window 3131), which can be applied in determining how to best balance processing and/or memory load, considering the impact of how re-execution of many currently executing queries/soon-to-execute queries across one or more tables being removed could impact system performance.

In particular, is if all queries associated with a given table (e.g. temperatures) are invalidated at the same time, the system will then have to re-execute a large number of potentially expensive queries at the same time, which can result in a load spike on the system. By employing load balancing scheme data 3141 to process the cached resultant invalidation instruction 3104 over the course of time window 3131, the load can be balanced appropriately over time, allowing some or all queries to finish performing and reduce this load spike, for example, based on applying the query scheduling data 3142 in scheduling the removal of cached resultants. For example, the cached entries are instead gradually invalidated over the time window of time, which can cause the execution of the expensive, cached, queries to occur within this time of time, spreading the load over a longer time period.

FIG. 20I illustrates a particular example embodiment of a cached resultant invalidation instruction 3104 that indicates removal of query resultant data associated with a table (e.g. relational database table such as a SQL table) denoted via a corresponding table identifier 3121 (in this case the example “temperatures” table), in a same or similar fashion as illustrated in the example of FIG. 20F. The cached resultant invalidation instruction 3104 can further indicate time window 3131, for example, based on a keyword such as “spread_over_time”, for example, in a corresponding ALTER TABLE instruction. In this example, the corresponding time window indicates a value of 600, for example, denoting 600 seconds (i.e., 10 minutes). Processing of this example cached resultant invalidation instruction 3104 renders gradual invalidation of all cached resultant data 3120 generated from table “temperatures” over a 10 minute time period (e.g. starting from the time the instruction 3104 is received), for example, based on applying load balancing scheme data 3141 and/or query scheduling data 3142 to optimize how processing/memory load be balanced over the 10 minute period.

FIG. 20J illustrates a particular example embodiment of a cached resultant invalidation instruction 3104 that indicates removal of query resultant data associated with a dataset (e.g. relational database such as a SQL database) denoted via a corresponding database identifier 3129 (in this case the example “climate” database), in a same or similar fashion as illustrated in the example of FIG. 20G. The cached resultant invalidation instruction 3104 can further indicate time window 3131, for example, based on a keyword such as “spread_over_time”, for example, in a corresponding ALTER DATABASE instruction. In this example, the corresponding time window indicates a value of 600, for example, denoting 600 seconds (i.e., 10 minutes). Processing of this example cached resultant invalidation instruction 3104 renders gradual invalidation of all cached resultant data 3120 generated from tables of database “climate” over a 10 minute time period (e.g. starting from the time the instruction 3104 is received), for example, based on applying load balancing scheme data 3141 and/or query scheduling data 3142 to optimize how processing/memory load be balanced over the 10 minute period.

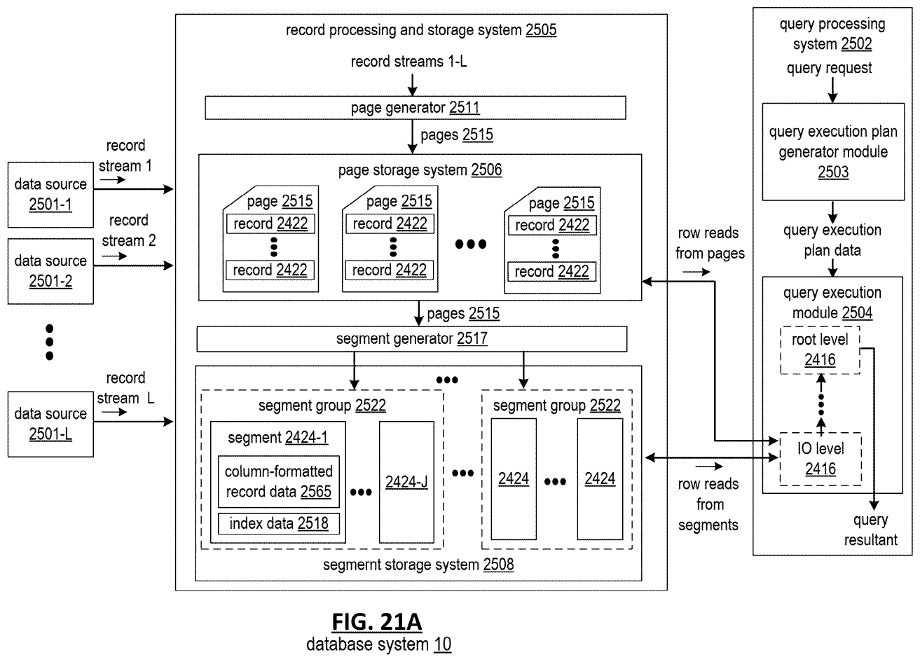

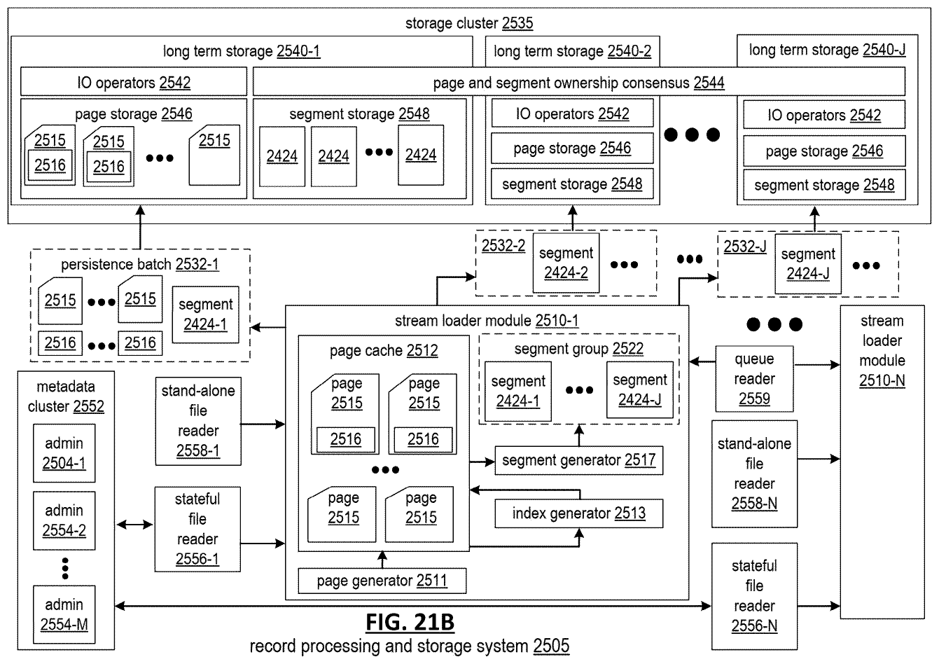

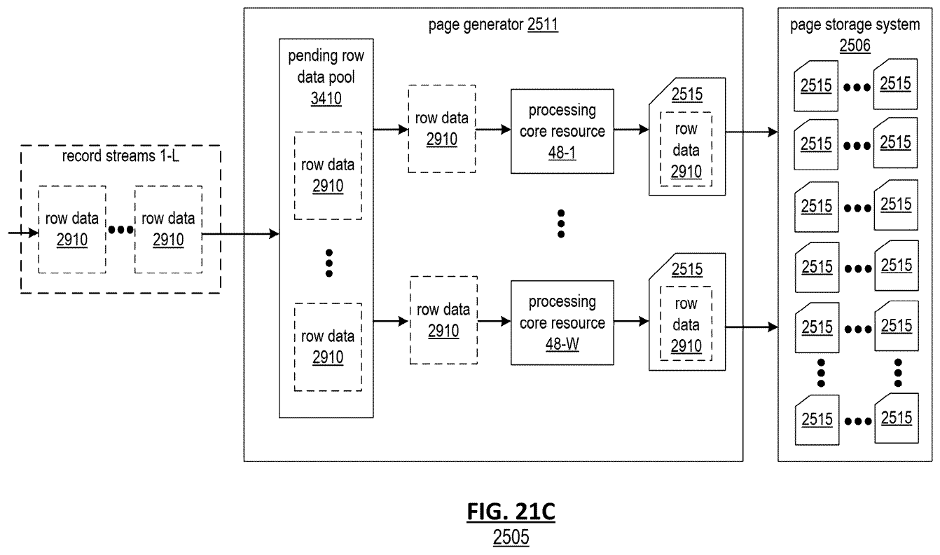

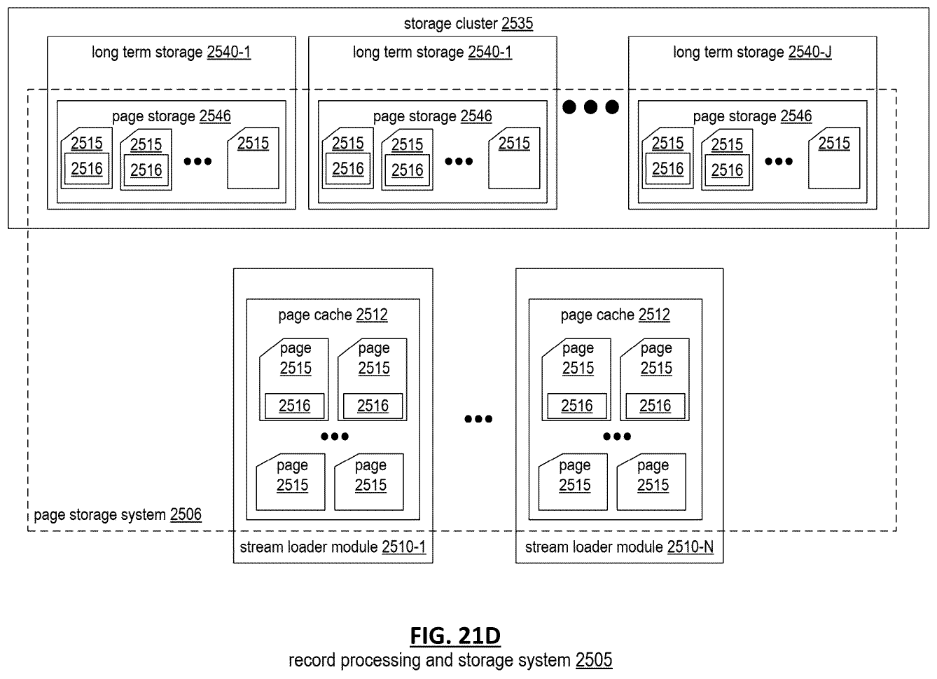

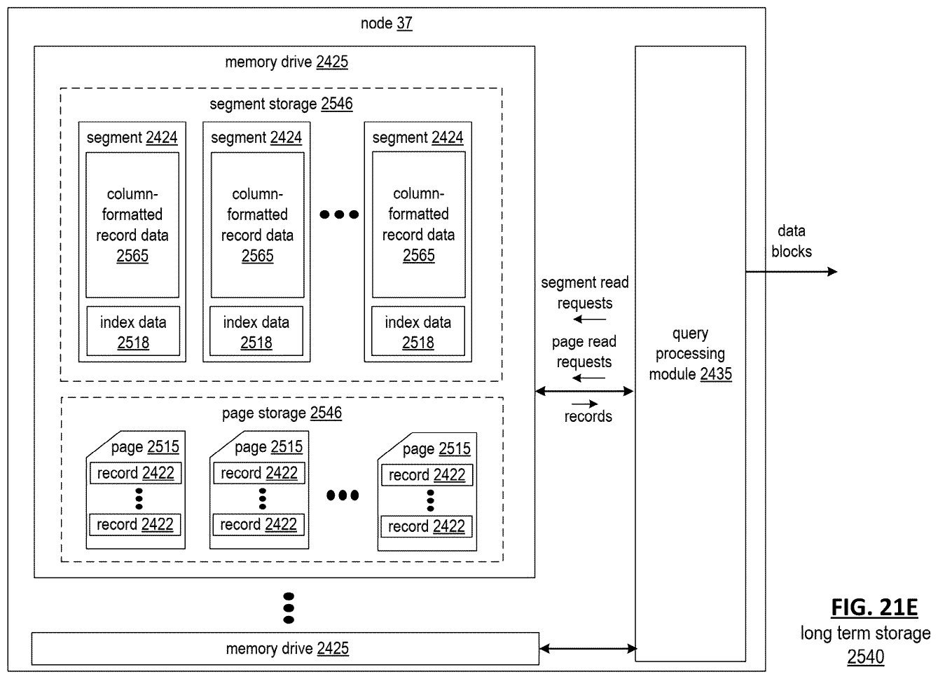

FIG. 21A illustrates an embodiment of a database system 10 that implements a record processing and storage system 2505. The record processing and storage system 2505 can be operable to generate and store the segments 2424 discussed previously by utilizing a segment generator 2517 to convert sets of row-formatted records 2422 into column-formatted record data 2565. These row-formatted records 2422 can correspond to rows of a database table with populated column values of the table, for example, where each record 2422 corresponds to a single row as illustrated in FIG. 10. For example, the segment generator 2517 can generate the segments 2424 in accordance with the process discussed in conjunction with FIGS. 10-18. The segments 2424 can be generated to include index data 2518, which can include a plurality of index sections such as the index sections 0-X illustrated in FIG. 18. The segments 2424 can optionally be generated to include other metadata, such as the manifest section and/or statistics section illustrated in FIG. 18.

The generated segments 2424 can be stored in a segment storage system 2508 for access in query executions. For example, the records 2422 can be extracted from generated segments 2424 in various query executions performed by via a query processing system 2502 of the database system 10, for example, as discussed in FIGS. 21A-21D. In particular, the segment storage system 2508 can be implemented by utilizing the memory drives 2425 of a plurality of IO level nodes 27 that are operable to store segments. As discussed previously, nodes 37 at the IO level 2416 can store segments 2424 in their memory drives 2425. These nodes can perform IO operations in accordance with query executions by reading rows from these segments 2424 and/or by recovering segments based on receiving segments from other nodes. The records 2422 can be extracted from the column-formatted record data 2565 for these IO operations of query executions by utilizing the index data 2518 of the corresponding segment 2424.

To enhance the performance of query executions via access to segments 2424 to read records 2422 in this fashion, the sets of rows included in each segment are ideally clustered well. In the ideal case, rows sharing the same cluster key are stored together in the same segment or same group of segments. For example, rows having matching values of key columns(s) of FIG. 18 utilized to sort the rows into groups for conversion into segments are ideally stored in the same segments. As used herein, a cluster key can be implemented as any one or more columns, such as key columns(s) of FIG. 13, that are utilized to cluster records into segment groups for segment generation. As used herein, more favorable levels of clustering correspond to more rows with same or similar cluster keys being stored in the same segments, while less favorable levels of clustering correspond to less rows with same or similar cluster keys being stored in the same segments. More favorable levels of clustering can achieve more efficient query performance. In particular, query filtering parameters of a given query can specify particular sets of records with particular cluster keys be accessed, and if these records are stored together, fewer segments, memory drives, and/or nodes need to be accessed and/or utilized for the given query.

These favorable levels of clustering can be hard to achieve when relying upon the incoming ordering of records in record streams 1-L from a set of data sources 2501-1-2501-L. No assumptions can necessarily be made about the clustering, with respect to the cluster key, of rows presented by external sources as they are received in the data stream. For example, the cluster key value of a given row received at a first time t1 gives no information about the cluster key value of a row received at a second time t2 after t1. It would therefore be unideal to frequently generate segments by performing a clustering process to group the most recently received records by cluster key. In particular, because records received within a given time frame from a particular data source may not be related and have many different cluster key values, the resulting record groups utilized to generate segments would render unfavorable levels of clustering.

To achieve more favorable levels of clustering, the record processing and storage system 2505 implements a page generator 2511 and a page storage system 2506 to store a plurality of pages 2515. The page generator 2511 is operable to generate pages 2515 from incoming records 2422 of record streams 1-L, for example, as is discussed in further detail in conjunction with FIG. 21C. Each page 2515 generated by the page generator 2511 can include a set of records, for example, in their original row format and/or in a data format as received from data sources 2502-1-2501-L. Once generated, the pages 2515 can be stored in a page storage system 2506, which can be implemented via memory drives and/or cache memory of one or more computing devices 18, such as some or all of the same or different nodes 37 storing segments 2424 as part of the segment storage system 2508.

This generation and storage of pages 2515 stored by can serve as temporary storage of the incoming records as they await conversion into segments 2424. Pages 2515 can be generated and stored over lengthy periods of time, such as hours or days. During this length time frame, pages 2515 can continue to be accumulated as one or more record streams of incoming records 1-L continue to supply additional records for storage by the database system.

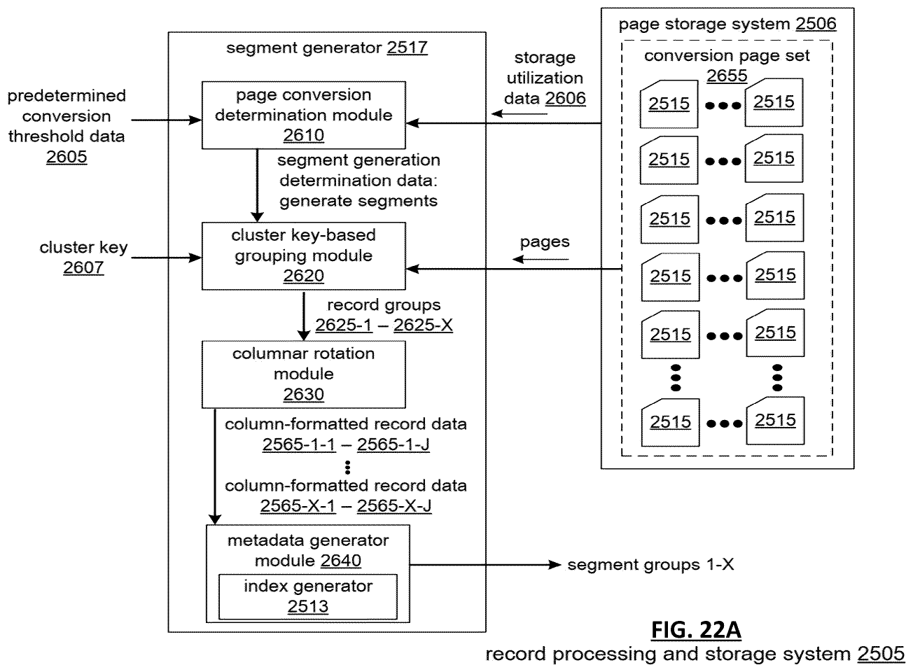

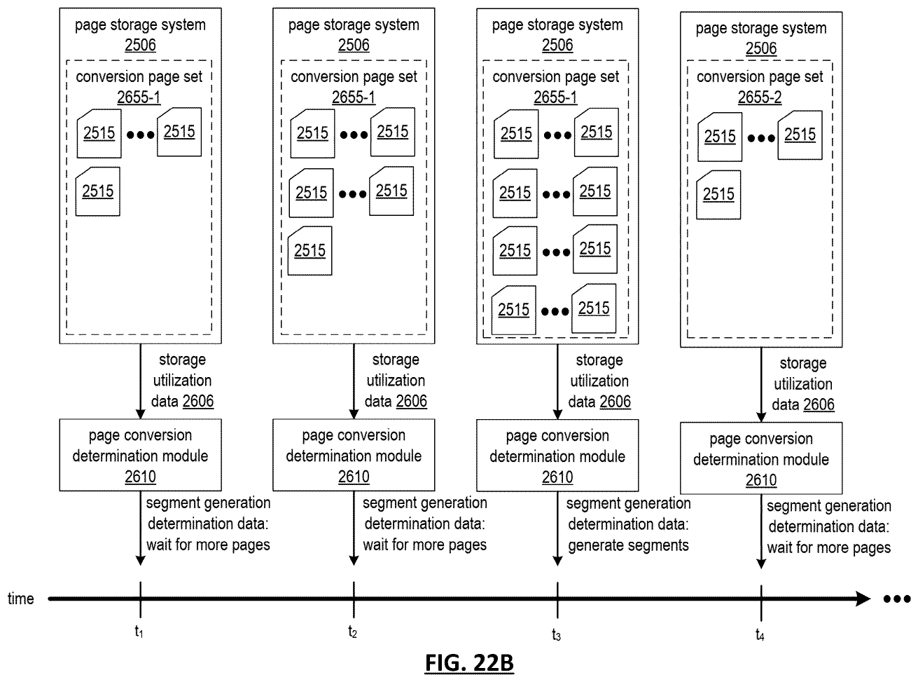

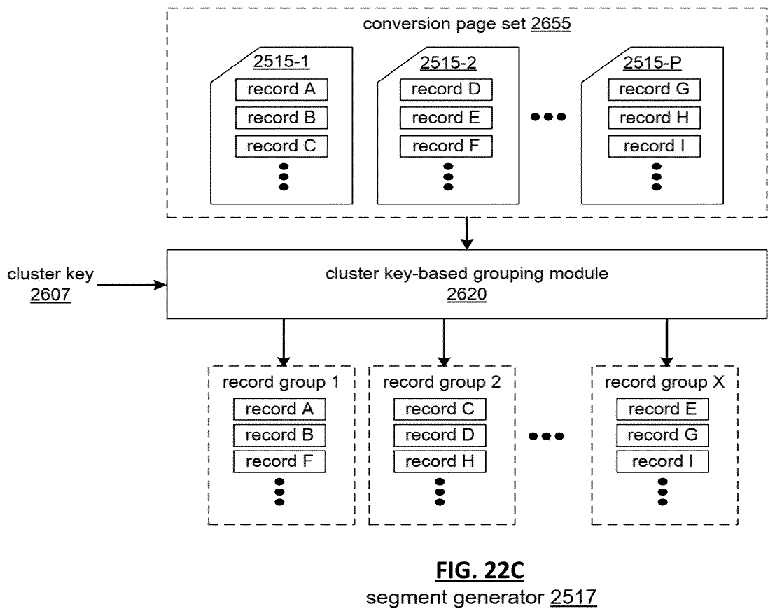

The plurality of pages generated and stored over this period of time can be converted into segments, for example once a sufficient amount of records have been received and stored as pages, and/or once the page storage system 2506 runs out of memory resources to store any additional pages. It can be advantageous to accumulate and store as many records as possible in pages 2515 prior to conversion to achieve more favorable levels of clustering. In particular, performing a clustering process upon a greater numbers of records, such as the greatest number of records possible can achieve more favorable levels of clustering, For example, greater numbers of records with common cluster keys are expected to be included in the total set of pages 2515 of the page storage system 2506 when the page storage system 2506 accumulates pages over longer periods of time to include a greater number of pages. In other words. delaying the grouping of rows into segments as long as possible increases the chances of having sufficient numbers of records with same and/or similar cluster keys to group together in segments. Determining when to generate segments such that the conversion from pages into segments is delayed as long as possible, and/or such that a sufficient amount of records are converted all at once to induce more favorable levels of cluster, is discussed in further detail in conjunction with FIGS. 22A-22D. Alternatively, the conversion of pages into segments can occur at any frequency, for example, where pages are converted into segments more frequently and/or in accordance with any schedule or determination in other embodiments of the record processing and storage system 2505.

This mechanism of improving clustering levels in segment generation by delaying the clustering process required for segment generation as long as possible can be further leveraged to reduce resource utilization of the record processing and storage system 2505. As the record processing and storage system 2505 is responsible for receiving records streams from data sources for storage, for example, in the scale of terabyte per second load rates, this process of generating pages from the record streams should therefore be as efficient as possible. The page generator 2511 can be further implemented to reduce resource consumption of the record processing and storage system 2505 in page generation and storage by minimizing the processing of, movement of, and/or access to records 2422 of pages 2515 once generated as they await conversion into segments.

To reduce the processing induced upon the record processing and storage system 2505 during this data ingress, sets of incoming records 2422 can be included in a corresponding page 2515 without performing any clustering or sorting. For example, as clustering assumptions cannot be made for incoming data, incoming rows can be placed into pages based on the order that they are received and/or based on any order that best conserves resources. In some embodiments, the entire clustering process is performed by the segment generator 2417 upon all stored pages all at once, where the page generator 2511 does not perform any stages of the clustering process.

While delaying segment generation in this fashion improves clustering and further improves ingress efficiency, it can be unideal to wait for records to be processed into segments before they appear in query results, particularly because the most recent data may be of the most interest to end users requesting queries. The record processing and storage system 2505 can resolve this problem by being further operable to facilitate page reads in addition to segment reads in facilitating query executions.

As illustrated in FIG. 21A, a query processing system 2502 can implement a query execution plan generator module 2503 to generate query execution plan data based on a received query request. The query execution plan data can be relayed to nodes participating in the corresponding query execution plan 2405 indicated by the query execution plan data. A query execution module 2504 can be implemented via a plurality of nodes participating in the query execution plan 2405, for example, where data blocks are propagated upwards from nodes at IO level 2416 to a root node at root level 2412 to generate a query resultant. The nodes at IO level 2416 can perform row reads to read records 2422 from segments 2424. The nodes at IO level 2416 can further perform row reads to read records 2422 from pages 2515. For example, once records 2422 are durably stored by being stored in a page 2515, and/or by being duplicated and stored in multiple pages 2515, the record 2422 can be available to service queries, and will be accessed by nodes 37 at IO level 2416 in executing queries accordingly. This enables the availability of records 2422 for query executions more quickly, where the records need not be processed for storage in their final storage format as segments 2424 to be accessed in query requests. Execution of a given query can include utilizing a set of records stored in a combination of pages 2515 and segments 2424. An embodiment of an IO level node that stores and accesses both segments and pages is illustrated in FIG. 21E.

The record processing and storage system 2505 can be implemented utilizing the parallelized data input sub-system 11 and/or the parallelized ingress sub-system 24 of FIG. 4. The record processing and storage system 2505 can alternatively or additionally be implemented utilizing the parallelized data store, retrieve, and/or process sub-system 12 of FIG. 6. The record processing and storage system 2505 can alternatively or additionally be implemented by utilizing one or more computing devices 18 and/or by utilizing one or more nodes 37.

The record processing and storage system 2505 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the page generator 2511 and/or of the segment generator 2517 discussed herein. In some cases, one or more individual nodes 37 and/or one or more individual processing core resources 48 can be operable to perform some or all of the functionality of the record processing and storage system 2505, such as some or all of the functionality of the page generator 2511 and/or of the segment generator 2517, independently or in tandem by utilizing their own processing resources and/or memory resources.

The query processing system 2502 can be alternatively or additionally implemented utilizing the parallelized query and results sub-system 13 of FIG. 5. The query processing system 2502 can be alternatively or additionally implemented utilizing the parallelized data store, retrieve, and/or process sub-system 12 of FIG. 6. The query processing system 2502 can alternatively or additionally be implemented by utilizing one or more computing devices 18 and/or by utilizing one or more nodes 37.

The query processing system 2502 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the query execution plan generator module 2503 and/or of the query execution module 2504 discussed herein. In some cases, one or more individual nodes 37 and/or one or more individual processing core resources 48 can be operable to perform some or all of the functionality of the query processing system 2502, such as some or all of the functionality of query execution plan generator module 2503 and/or of the query execution module 2504, independently or in tandem by utilizing their own processing resources and/or memory resources.

FIG. 21B illustrates an example embodiment of the record processing and storage system 2505 of FIG. 21A. Some or all of the features illustrated and discussed in conjunction with the record processing and storage system 2505 FIG. 21B can be utilized to implement the record processing and storage system 2505 and/or any other embodiment of the record processing and storage system 2505 described herein.

The record processing and storage system 2505 can include a plurality of stream loader modules 2501-1-2510-N. Each stream loader module 2510 can be implemented via its own processing and/or memory resources. For example, each stream loader module 2510 can be implemented via its own computing device 18, via its own node 37, and/or via its own processing core resource 48. The plurality of stream loader modules 2501-1-2510-N can be implemented to perform some or all of the functionality of the record processing and storage system 2505 in a parallelized fashion.

The record processing and storage system 2505 can include queue reader 2559, a plurality of stateful file readers 2556-1-2556-N, and/or stand-alone file readers 2558-1-2558-N. For example, the queue reader 2559, a plurality of stateful file readers 2556-1-2556-N, and/or stand-alone file readers 2558-1-2558-N are utilized to enable each stream loader modules 2510 to receive one or more of the record streams 1-L received from the data sources 2502-1-2501-L as illustrated in FIG. 25A. For example, each stream loader module 2510 receives a distinct subset of the entire set of records received by the record processing and storage system 2505 at a given time.

Each stream loader module 2510 can receive records 2422 in one or more record streams via its own stateful file reader 2556 and/or stand-alone file reader 2558. Each stream loader module 2510 can optionally receive records 2422 and/or otherwise communicate with a common queue reader 2559. Each stateful file reader 2556 can communicate with a metadata cluster 2552 that includes data supplied by and/or corresponding to a plurality of administrators 2554-1-2554-M. The metadata cluster 2552 can be implemented by utilizing the administrative processing sub-system 15 and/or the configuration sub-system 16. The queue reader 2559, each stateful file reader 2556, and/or each stand-alone file reader 2558 can be implemented utilizing the parallelized ingress sub-system 24 and/or the parallelized data input sub-system 11. The metadata cluster 2552, the queue reader 2559, each stateful file reader 2556, and/or each stand-alone file reader 2558 can be implemented utilizing at least one computing device 18 and/or at least one node 37. In cases where a given stream loader module 2510 is implemented via its own computing device 18 and/or node 37, the same computing device 18 and/or node 37 can optionally be utilized to implement the stateful file reader 2556, and/or each stand-alone file reader 2558 communicating with the given stream loader module 2510.

Each stream loader module 2510 can implement its own page generator 2511, its own index generator 2513, and/or its own segment generator 2517, for example, by utilizing its own processing and/or memory resources such as the processing and/or memory resources of a corresponding computing device 18. For example, the page generator 2511 of FIG. 21A can be implemented as a plurality of page generators 2511 of a corresponding plurality of stream loader modules 2510 as illustrated in FIG. 21B. Each page generator 2511 of FIG. 21B can process its own incoming records 2422 to generate its own corresponding pages 2515.

As pages 2515 are generated by the page generator 2511 of a stream loader module 2510, they can be stored in a page cache 2512. The page cache 2512 can be implemented utilizing memory resources of the stream loader module 2510, such as memory resources of the corresponding computing device 18. For example, the page cache 2512 of each stream loader module 2010-1-2010-N can individually or collectively implement some or all of the page storage system 2506 of FIG. 21A.

The segment generator 2517 of FIG. 25A can similarly be implemented as a plurality of segment generators 2517 of a corresponding plurality of stream loader modules 2510 as illustrated in FIG. 25B. Each segment generator 2517 of FIG. 21B can generate its own set of segments 2424-1-2424-J included in one or more segment groups 2522. The segment group 2522 can be implemented as the segment group of FIG. 18, for example, where J is equal to five or another number of segments configured to be included in a segment group. In particular, J can be based on the redundancy storage encoding scheme utilized to generate the set of segments and/or to generate the corresponding parity data 2426.

The segment generator 2517 of a stream loader module 2510 can access the page cache 2512 of the stream loader module 2510 to convert the pages 2515 previously generated by the page generator 2511 into segments. In some cases, each segment generator 2517 requires access to all pages 2515 generated by the segment generator 2517 since the last conversion process of pages into segments. The page cache 2512 can optionally store all pages generated by the page generator 2511 since the last conversion process, where the segment generator 2517 accesses all of these pages generated since the last conversion process to cluster records into groups and generate segments. For example, the page cache 2512 is implemented as a write-through cache to enable all previously generated pages since the last conversion process to be accessed by the segment generator 2517 once the conversion process commences.

An index generator 2513 can optionally be implemented by some or all stream loader modules 2510 to generate index data 2516 for some or all pages 2515 prior to their conversion into segments. The index data 2516 generated for a given page 2515 can be appended to the given page, can be stored as metadata of the given page 2515, and/or can otherwise be mapped to the given page 2515. The index data 2516 for a given page 2515 correspond to page metadata, for example, indexing records included in the corresponding page. As a particular example, the index data 2516 can include some or all of the data of index data 2518 generated for segments 2424 as discussed previously, such as index sections 0-x of FIG. 18. As another example, the index data 2516 can include indexing information utilized to determine the memory location of particular records and/or particular columns within the corresponding page 2515.

As illustrated in FIG. 21B, each stream loader modules 2510 can generate and send pages 2515, corresponding index data 2516, and/or segments 2424 to long term storage 2540-1-2540-J of a particular storage cluster 2535. For example, system communication resources 14 can be utilized to facilitate sending of data from stream loader modules 2510 to storage cluster 2535 and/or to facilitate sending of data from storage cluster 2535 to stream loader modules 2510.

The storage cluster 2535 can be implemented by utilizing a storage cluster 35 of FIG. 6, where each long term storage 2540-1-2540-J is implemented by a corresponding computing device 18-1-18-J and/or by a corresponding node 37-1-37-J. In some cases, each storage cluster 35-1-35-z of FIG. 6 can receive pages 2515, corresponding index data 2516, and/or segments 2424 from its own set of stream loader modules 2501-1-2510-N, where the record processing and storage system 2505 of FIG. 25B can include z sets of stream loader modules 2501-1-2510-N that each generate pages 2515, segments 2524, and/or index data 2516 for storage in its own corresponding storage cluster 35.

The processing and/or memory resources utilized to implement each long term storage 2540 can be distinct from the processing and/or memory resources utilized to implement the stream loader modules 2510. Alternatively, some stream loader modules can optionally share processing and/or memory resources long term storage 2540, for example, where a same computing device 18 and/or a same node 37 implements a particular long term storage 2540 and also implements a particular stream loader modules 2510.

Each stream loader module 2510 can generate and send the segments 2424 to long term storage 2540-1-2540-J in a set of persistence batches 2532-1-2532-J sent to the set of long term storage 2540-1-2540-J as illustrated in FIG. 25B. For example, upon generating a segment group 2522 of J segments 2424, a stream loader module 2510 can send each of the J segments in the same segment group to a different one of the set of long term storage 2540-1-2540-J in the storage cluster 2535. For example, a particular long term storage 2540 can generate recovered segments as necessary for processing queries and/or for rebuilding missing segments due to drive failure.

As illustrated in FIG. 21B, each persistence batch 2532-1-2532-J can optionally or additionally include pages 2515 and/or their corresponding index data 2516 generated via index generator 2513. Some or all pages 2515 that are generated via a stream loader module 2510's page generator 2511 can be sent to one or more long term storage 2540-1-2540-J. For example, a particular page 2515 can be included in some or all persistence batches 2532-1-2532-J sent to multiple ones of the set of long term storage 2540-1-2540-J for redundancy storage as replicated pages stored in multiple locations for the purpose of fault tolerance. Some or all pages 2515 can be sent to storage cluster 2535 for storage prior to being converted into segments 2424 via segment generator 2517. Some or all pages 2515 can be stored by storage cluster 2535 until corresponding segments 2424 are generated, where storage cluster 2535 facilitates deletion of these pages from storage in one or more long term storage 2540-1-2540-J once these pages are converted and/or have their records 2422 successfully stored by storage cluster 2535 in segments 2424.

Each long term storage 2540 can include its own page storage 2546 that stores received pages 2515 generated by and received from one or more stream loader modules 2010-1-2010-N, implemented utilizing memory resources of the long term storage 2540. For example, the page storage 2546 of each long term storage 2540-1-2540-J can individually or collectively implement some or all of the page storage system 2506 of FIG. 21A. The page storage 2546 can optionally store index data 2516 mapped to and/or included as metadata of its pages 2515. Each long term storage 2540 can alternatively or additionally include its own segment storage 2548 that stores segments generated by and received from one or more stream loader modules 2010-1-2010-N. For example, the segment storage 2548 of each long term storage 2540-1-2540-J can individually or collectively implement some or all of the segment storage system 2508 of FIG. 25A.

The pages 2515 stored in page storage 2546 of long term storage 2540 and/or the segments 2424 stored in segment storage 2548 of long term storage 2540 can be accessed to facilitate execution of queries. As illustrated in FIG. 21B, each long term storage 2540-1-2540-J can perform IO operators 2542 to facilitate reads of records in pages 2515 stored in their page storage 2546 and/or to facilitate reads of records in segments 2424 stored in their segment storage 2548. For example, some or all long term storage 2540-1-2540-J can be implemented as nodes 37 at the IO level 2416 of one or more query execution plans 2405. In particular, the some or all long term storage 2540-1-2540-J can be utilized to implement the query processing system 2502 by facilitating reads to stored records via IO operators 2542 in conjunction with query executions.

Note that at a given time, a given page 2515 may be stored in the page cache 2512 of the stream loader module 2510 that generated the given page 2515, and may alternatively or additionally be stored in one or more long term storage 2540 of the storage cluster 2535 based on being sent to the in one or more long term storage 2540. Furthermore, at a given time, a given record may be stored in a particular page 2515 in a page cache 2512 of a stream loader module 2510, may be stored the particular page 2515 in page storage 2546 of one or more long term storage 2540, and/or may be stored in exactly one particular segment 2424 in segment storage 2548 of one long term storage 2540.

Because records can be stored in multiple locations of storage cluster 2535, the long term storage 2540 of storage cluster 2535 can be operable to collectively store page and segment ownership consensus 2544. This can be useful in dictating which long term storage 2540 is responsible for accessing each given record stored by the storage cluster 2535 via IO operators 2542 in conjunction with query execution. In particular, as a query resultant is only guaranteed to be correct if each required record is accessed exactly once, records reads to a particular record stored in multiple locations could render a query resultant as incorrect. The page and segment ownership consensus 2544 can include one or more versions of ownership data, for example, that is generated via execution of a consensus protocol mediated via the set of long term storage 2540-1-2540-J. The page and segment ownership consensus 2544 can dictate that every record is owned by exactly one long term storage 2540 via access to either a page 2515 storing the record or a segment 2424 storing the record, but not both. The page and segment ownership consensus 2544 can indicate, for each long term storage 2540 in the storage cluster 2535, whether some or all of its pages 2515 or some or all of its segments 2424 are to be accessed in query executions, where each long term storage 2540 only accesses the pages 2515 and segments 2424 indicated in page and segment ownership consensus 2544.

In such cases, all record access for query executions performed by query execution module 2504 via nodes 37 at IO level 2416 can optionally be performed via IO operators 2542 accessing page storage 2546 and/or segment storage 2548 of long term storage 2540, as this access can guarantee reading of records exactly once via the page and segment ownership consensus 2544. For example, the long term storage 2540 can be solely responsible for durably storing the records utilized in query executions. In such embodiments, the cached and/or temporary storage of pages and/or segments of stream loader modules 2510, such as pages 2515 in page caches 2512, are not read for query executions via accesses to storage resources of stream loader modules 2510.

FIG. 21C illustrates an example embodiment of a page generator 2511. The page generator 2511 of FIG. 21C can be utilized to implement the page generator 2511 of FIG. 21A, can be utilized to implement each page generator 2511 of each stream loader module 2510 of FIG. 21B, and/or can be utilized to implement any embodiments of page generator 2511 described herein.

A single incoming record stream, or multiple incoming record streams 1-L, can include the incoming records 2422 as a stream of row data 2910. Each row data 2910 can be transmitted as an individual packet and/or a set of packets by the corresponding data source 2501 to include a single record 2422, such as a single row of a database table. Alternatively, each row data 2910 can be transmitted by the corresponding data source 2501 as an individual packet and/or a set of packets to include a batched set of multiple records 2422, such as multiple rows of a database table. Row data 2910 received from the same or different data source over time can each include a same number of rows or a different number of rows, and can be sent in accordance with a particular format. Row data 2910 received from the same or different data source over time can include records with the same or different numbers of columns, with the same or different types and/or sizes of data populating its columns, and/or with the same or different row schemas. In some cases, row data 2910 is received in a stream over time for processing by a stream loader module 2510 via a stateful file reader 2556 and/or via a stand-alone file reader 2558.

Incoming rows can be stored in a pending row data pool 3410 while they await conversion into pages 2515. The pending row data pool 3410 can be implemented as an ordered queue or an unordered set. The pending row data pool 3410 can be implemented by utilizing storage resources of the record processing and storage system. For example, each stream loader module 2510 can have its own pending row data pool 3410. Alternatively, multiple stream loader modules 2510 can access the same row data pool 3410 that stores all incoming row data 2910, for example, by utilizing queue reader 2559.

The page generator 2511 can facilitate parallelized page generation via a plurality of processing core resources 48-1-48-W. For example, each stream loader module 2510 has its own plurality of processing core resources 48-1-48-W, where the processing core resources 48-1-48-W of a given stream loader module 2510 is implemented via the set of processing core resources 48 of one or more nodes 37 utilized to implement the given stream loader module 2510. As another example, the plurality of processing core resources 48-1-48-W are each implemented by a corresponding one of the set of each stream loader module 2501-1-2510-N, for example, where each stream loader module 2501-1-2510-N is implemented via its own processing core resources 48-1-48-W.

Over time, each processing core resource 48 can retrieve and/or can be assigned pending row data 2910 in the pending row data pool 3410. For example, when a given processing core resource 48 has finished another job, such as completed processing of another row data 2910, the processing core resource 48 can fetch a new row data 2910 for processing into a page 2515. For example, the processing core resource 48 retrieves a first ordered row data 2910 from a queue of the pending row data pool 3410, retrieves a highest priority row data 2910 from the pending row data pool 3410, retrieves an oldest row data 2910 from the pending row data pool 3410, and/or retrieves a random row data 2910 from the pending row data pool 3410. Once one processing core resource 48 retrieves and/or otherwise utilizes a particular row data 2910 for processing into a page, the particular row data 2910 is removed from the pending row data pool 3410 and/or is otherwise not available for processing by other processing core resources 48.

Each processing core resource 48 can generate pages 2515 from the row data received over time. As illustrated in FIG. 21C, the pages 2515 are depicted to include only one row data, such as a single row or multiple rows batched together in the row data 2910. For example, each page is generated directly from corresponding row data 2910. Alternatively, a page 2515 can include multiple row data 2910, for example, in sequence and/or concatenated in the page 2515. The page can include multiple row data 2910 from a single data source 2501 and/or can include multiple row data 2910 from multiple different data sources 2501. For example, the processing core resource 48 can retrieve one row data 2910 from the pending row data pool 3410 at a time, and can append each row data 2910 to a given page until the page 2515 is complete, where the processing core resource 48 appends subsequently retrieved row data 2910 to a new page. Alternatively, the processing core resource 48 can retrieve multiple row data 2910 at once, and can generate a corresponding page 2515 to include this set of multiple row data 2910.

Once a page 2515 is complete, the corresponding processing core resource 48 can facilitate storage of the page in page storage system 2506. This can include adding the page 2515 to the page cache 2512 of the corresponding stream loader module 2510. This can include facilitating sending of the page 2515 to one or more long term storage 2540 for storage in corresponding page storage 2546. Different processing core resources 48 can each facilitate storage of the page via common resources, or via designated resources specific to each processing core resources 48, of the page storage system 2506.

FIG. 21D illustrates an example embodiment of the page storage system 2505. As used herein, the page storage system 2505 can include page cache 2512 of a single stream loader module 2510; can include page caches 2512 of some or all stream loader module 2501-1-2510-N; can include page storage 2546 of a single long term storage 2540 of a storage cluster 2535; can include page storage 2546 of some or all long term storage 2540-1-2540-J of a single storage cluster 2535; can include page storage 2546 of some or all long term storage 2540-1-2540-J of multiple different storage clusters, such as some or all storage clusters 35-1-35-z; and/or can include any other memory resources of database system 10 that are utilized to temporarily and/or durably store pages.

FIG. 21E illustrates an example embodiment of a node 37 utilized to implement a given long term storage 2540 of FIG. 21B. The node 37 of FIG. 21E can be utilized to implement the node 37 of FIG. 21B, FIG. 21C, 21D, some or all nodes 37 at the IO level 2416 of a query execution plan 2405, and/or any other embodiments of node 37 described herein. As illustrated a given node 37 can have its own segment storage 2548 and/or its own page storage 2546 by utilizing one or more of its own memory drives 2425. Note that while the segment storage 2548 and page storage 2546 are segregated in the depiction of a memory drives 2425, any resources of a given memory drive or set of memory drives can be allocated for and/or otherwise utilized to store either pages 2515 or segments 2424. Optionally, some particular memory drives 2425 and/or particular memory locations within a particular memory drive can be designated for storage of pages 2515, while other particular memory drives 2425 and/or other particular memory locations within a particular memory drive can be designated for storage of segments 2424.

The node 37 can utilize its query processing module 2435 to access pages and/or records in conjunction with its role in a query execution plan 2405, for example, at the IO level 2416. For example, the query processing module 2435 generates and sends segment read requests to access records stored in segments of segment storage 2548, and/or generates and sends page read requests to access records stored in pages 2515 of page storage 2546. In some cases, in executing a given query, the node 37 reads some records from segments 2424 and reads other records from pages 2515, for example, based on assignment data indicated in the page and segment ownership consensus 2544. The query processing module 2435 can generate its data blocks to include the raw row data of the read records and/or can perform other query operators to generate its output data blocks as discussed previously. The data blocks can be sent to another node 37 in the query execution plan 2405 for processing as discussed previously, such as a parent node and/or a node in a shuffle node set within the same level 2410.

FIG. 22A illustrates an example embodiment of a segment generator 2517. The segment generator 2517 of FIG. 22A can be utilized to implement the segment generator 2517 of FIG. 21A, can be utilized to implement each segment generator 2517 of each stream loader module 2510 of FIG. 21B, and/or can be utilized to implement any embodiments of segment generator 2517 described herein.

As discussed previously, the record processing and storage system 2505 can be operable to delay the conversion of pages into segments. Rather than frequently clustering rows and converting rows into column format, movement and/or processing of rows can be minimized by delaying the clustering and conversion process required to generate segments 2424, for example, as long as possible. This delaying of the conversion process “as long as possible” can be bounded by resource availability, such as disk and/or memory capacity of the record processing and storage system 2505. In particular, the conversion process can be delayed to enable the accumulating of as many pages in the page storage system 2506 that page storage system 2506 is capable of storing.

Maximizing the delay until pages are processed as enabled by storage resources of the record processing and storage system 2505 improves the technology of database systems by improving query efficiency. In particular, delaying the decision of which rows to group together into segments as long as possible increased the chances of having many records with common cluster keys to group together, as cluster key-based groups are formed from a largest possible set of records. These more favorable levels of clustering enable queries to be performed more efficiently as discussed previously. For example, rows that need to be accessed in a given query as dictated by filtering parameters of the query are more likely to be stored together, and fewer segments and/or memory locations need to be accessed.

Maximizing the delay until pages are processed as enabled by storage resources of the record processing and storage system 2505 improves the technology of database systems by improving data ingress efficiency. By placing rows directly into pages without regard for clustering as they are received, this delayed approach minimizes the number of times a row “moves” through the system, such as from disk, to memory, and/or through the processor. In particular, by delaying all clustering until segment generation for the received rows all at once, the rows are moved exactly once, to their final resting place as a segment 2424. This conserves resources of the record processing and storage system 2505, enabling higher rates of records to be received and processed for storage via data sources 2501 and thus enabling a richer, denser database to be generated over time. For example, this can enable the record processing and storage system 2505 to effectively process incoming records at a scale of terabits per second.

This delay can be accomplished via a page conversion determination module 2610 implemented by the segment generator 2517 and/or implemented via other processing resources of the record processing and storage system 2505. The page conversion determination module 2610 can be utilized to generate segment generation determination data indicating whether the conversion process of pages into segments should be commenced at a given time. For example, the page conversion determination module 2610 generates an interrupt or notification that includes the generate segment generation determination data indicating it is time to generate segments based on determining to generate segments at the given time. The page conversion determination module 2610 can otherwise trigger the commencement of converting pages into segments once it deems the conversion process appropriate, for example, based on delaying as long as possible. The segment generator 2517 can commence the conversion process accordingly in response to the segment generation determination data indicating it is time to generate segments, for example, via a cluster key-based grouping module 2620, a columnar rotation module 2630, and/or a metadata generator module 2640. The delay of converting pages into segments via the page conversion determination module 2610 and the repeating of this process over time is discussed in further detail in conjunction with the example timeline of FIG. 22B.

The page conversion determination module 2610 can generate segment generation determination data: in predetermined intervals; in accordance with a schedule; in response to determining a new page has been generated and stored in page storage system 2506; in response determining at least a threshold number of new pages have been generated and stored in page storage system 2506; in response to determining the storage space and/or memory utilization of page storage system 2506 has changed; in response to determining the total storage capacity of page storage system 2506 has changed; in response to determining at least one memory drive of the page storage system 2506 has failed or gone offline; in response to receiving storage utilization data from page storage system 2506; based on instruction supplied via user input, for example, via administration sub-system 15 and/or configuration sub-system 16; based on receiving a request; and/or based on another determination.

The page conversion determination module 2610 can generate its segment generation determination data based on comparing storage utilization data 2606 to predetermined conversion threshold data 2605. The storage utilization data can optionally be generated by the page storage system 2506. The record processing and storage system 2505 can indicate and/or be based on one or more storage utilization metrics indicating: an amount and/or percentage of storage resources of the page storage system 2506 that are currently being utilized to store pages 2515; an amount and/or percentage of available resources of the page storage system 2506 that are not currently being utilized to store pages 2515; a number of pages 2515 currently stored by the page storage system 2506; a data size, such as a number of bytes, of the set of pages 2515 currently stored by the page storage system 2506; an expected amount of time until storage resources of the page storage system 2506 are expected to become fully utilized for page storage based on current and/or historical data rates of record streams 1-L; current health data and/or failure data of storage resources of the page storage system 2506; an amount of time since the last conversion process was initiated and/or was completed; and/or other information regarding the storage utilization of the page storage system 2506.

The storage utilization data 2606 can be sent to and/or requested by the segment generator 2517: in predefined intervals; in accordance with scheduling data; based on the page conversion determination module 2610 determining to generate the segment generation determination data; based on a determination, notification, and/or instruction that the page conversion determination module 2610 should generate the segment generation determination data; and/or based on another determination. In some cases, some or all of the page conversion determination module 2610 is implemented via processing resources and/or memory resources of the page storage system 2506, for example, to enable the page conversion determination module 2610 to monitor and/or measure the storage utilization data 2606 of its own resources included in page storage system 2506.

The predetermined conversion threshold data 2605 can indicate one or more threshold metrics or other threshold conditions that, when met by one or more corresponding metrics of the storage utilization data 2606 at a given time, trigger the commencement of the conversion process. In particular, the page conversion determination module generates the segment generation determination data indicating that segments be generated when the at least one metric of the storage utilization data 2606 meets the threshold metrics and/or conditions of the predetermined conversion threshold data 2605 and/or otherwise compares favorably to a condition for page conversion indicated by the predetermined conversion threshold data 2605. If the none of the metrics of the storage utilization data 2606 compare favorably to corresponding threshold metrics of predetermined conversion threshold data 2605, the page conversion determination module generates the segment generation determination data indicating that segments not be generated at this time, or otherwise does not generate the segment generation determination data in this case as no instruction to commence conversion need be communicated.

As used herein, the storage utilization data 2606 compares favorably to the predetermined conversion threshold data 2605 when the conditions indicated in the predetermined conversion threshold data 2605 that dictate the conversion process be initiated are met by corresponding metrics of the storage utilization data 2606. As used herein, the storage utilization data 2606 compares unfavorably to the predetermined conversion threshold data 2605 when the conditions indicated in the predetermined conversion threshold data 2605 that dictate the conversion process be initiated are not met by corresponding metrics of the storage utilization data 2606. In some embodiments, the page conversion determination module 2610 generates the segment generation determination data indicating that segments be generated and/or otherwise indicating that the conversion process be initiated only when the storage utilization data 2606 compares favorably to the predetermined conversion threshold data 2605.

The predetermined conversion threshold data 2605 can indicate one or more conditions that trigger the conversion process such as: a total memory capacity of page storage system 2506; a threshold maximum amount and/or percentage of storage resources of the page storage system 2506 that can be utilized to store pages 2515; a threshold minimum amount and/or percentage of resources page storage system that must remain available; a threshold minimum number of pages 2515 that must be included in the set of pages for conversion; a threshold maximum number of pages 2515 that can be converted in a single conversion process; a threshold maximum and/or threshold a data size of the set of pages that can be converted in a single conversion process; a threshold minimum amount of time that storage resources of the page storage system can be expected to become fully utilized for page storage based on current and/or historical data rates of record streams 1-L; threshold requirements for health data and/or failure data of storage resources of the page storage system 2506; a threshold minimum and/or threshold maximum amount of time at which a new conversion process must commence since the last conversion process was initiated and/or was completed; and/or other information regarding the requirements and/or conditions for initiation of the conversion process.

The predetermined conversion threshold data 2605 can be received and/or configured based on user input, for example, via administrative sub-system 15 and/or via configuration sub-system 16. The predetermined conversion threshold data 2605 can alternatively or additionally be determined automatically by the record processing and storage system 2505. For example, the predetermined conversion threshold data 2605 can be determined automatically to indicate and/or be based on determining a threshold memory capacity of the page storage system 2506; based on determining a threshold amount of bytes worth of pages 2515 the page storage system 2506 can store; and/or based on determining a threshold expected and/or average amount of time that pages can be generated and stored in the page storage system 2506 by the page generator 2511 until the page storage system 2506 becomes full. Note that these thresholds can be automatically buffered to account for a threshold percentage of drive failures, a historical expected rate of drive failures, a threshold amount of additional pages data that may be stored in communication lag since the storage utilization data 2606 was sent, a threshold amount of additional pages data that may be stored in processing lag to perform some or all of the conversion process, and/or other buffering to ensure that segment generation is completed before page storage system 2506 reaches its capacity.

As another example, the predetermined conversion threshold data 2605 can be determined automatically based on determining a sufficient number of records 2422 and/or a sufficient number of pages 2515 that can achieve sufficiently favorable levels of clustering. For example, this can be based on tracking and/or measuring clustering metrics for records in previous iterations of the conversion process and/or based on analysis of the measuring clustering metrics for records in previous iterations of the process to determine and/or estimate these thresholds. The storage utilization data 2606 can also be measured and/or tracked for each of this plurality of previous conversion processes to determine average and/or estimated storage utilization metrics that rendered conversion processes with favorable levels of clustering based on the corresponding clustering metrics measured for these previous conversion processes.

The clustering metrics can be based on a total or average number and/or proportion of records in each segment that: match cluster key of at least a threshold proportion of other records in the segment, are within a threshold vector distance and/or other similarity measure from at least a threshold number of other records in the segment. The clustering metrics can alternatively or additionally be based on an average and/or total number of segments whose records have a variance and/or standard deviation of their cluster key values that compare favorably to a threshold. The clustering metrics can alternatively or additionally be determined in accordance with any other similarity metrics and/or clustering algorithms.

Once the page conversion determination module 2610 generates segment generation determination data indicating that segments be generated via the conversion process, the segment generator 2517 can initiate the process of generating stored pages into segments. This can include identifying the pages for conversion in the conversion process. For example, all pages currently stored by the page storage system 2506 and awaiting their conversion into segments 2424 at the time when segment generation determination data is generated to indicate that the conversion process commence are identified for conversion. This set of pages can constitute a conversion page set 2655, where only the set of pages identified for conversion in the conversion page set 2655 are processed by segment generator 2517 for a given conversion process. For example, the record processing and storage system 2505 may continue to receive records from data sources 2501, and rather than buffering all of these records until after this conversion process is completed, additional pages can be generated at this time for storage in page storage system 2506. However, as processing of pages into segments has already commenced, these pages may not be clustered and converted during this conversion process, and can await their conversion in the next iteration of the conversion process. As another example, the page storage system 2506 may still be storing some other pages that were previously converted into segments but were not yet deleted. These pages are similarly not included in the conversion page set 2655 because their records are already included in segments via the prior conversion.

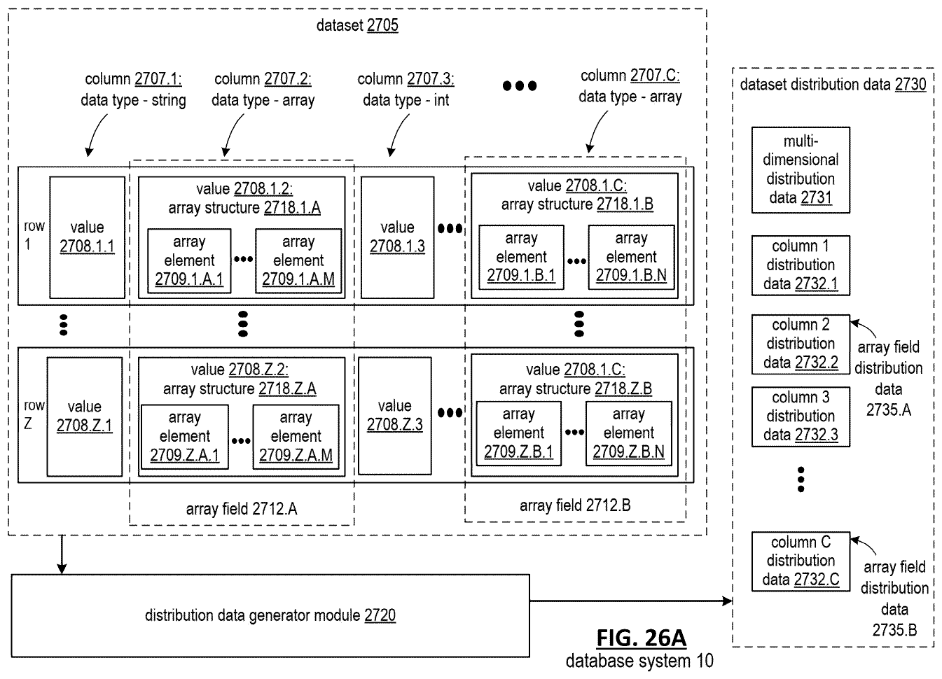

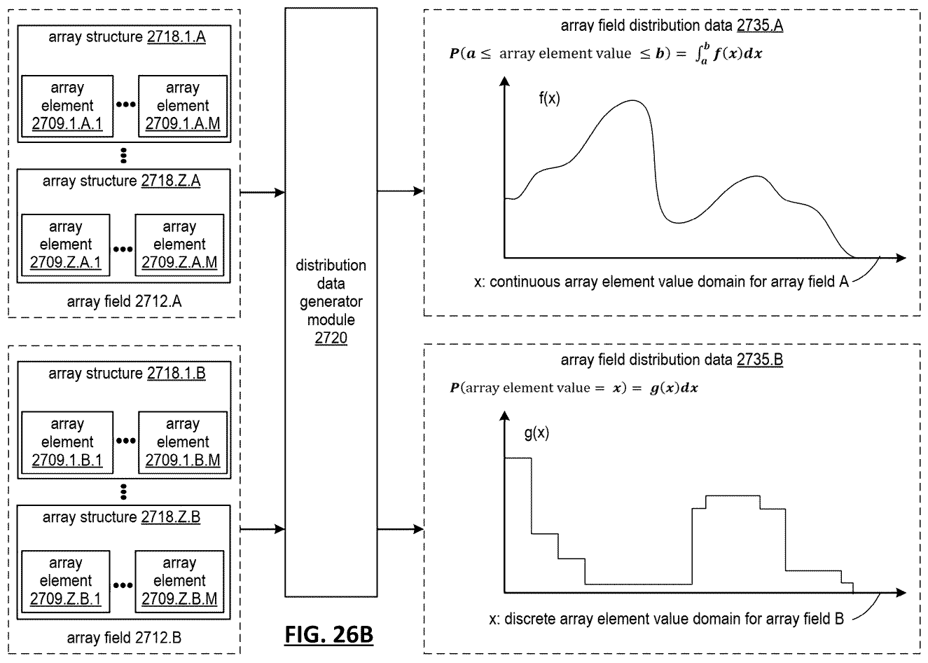

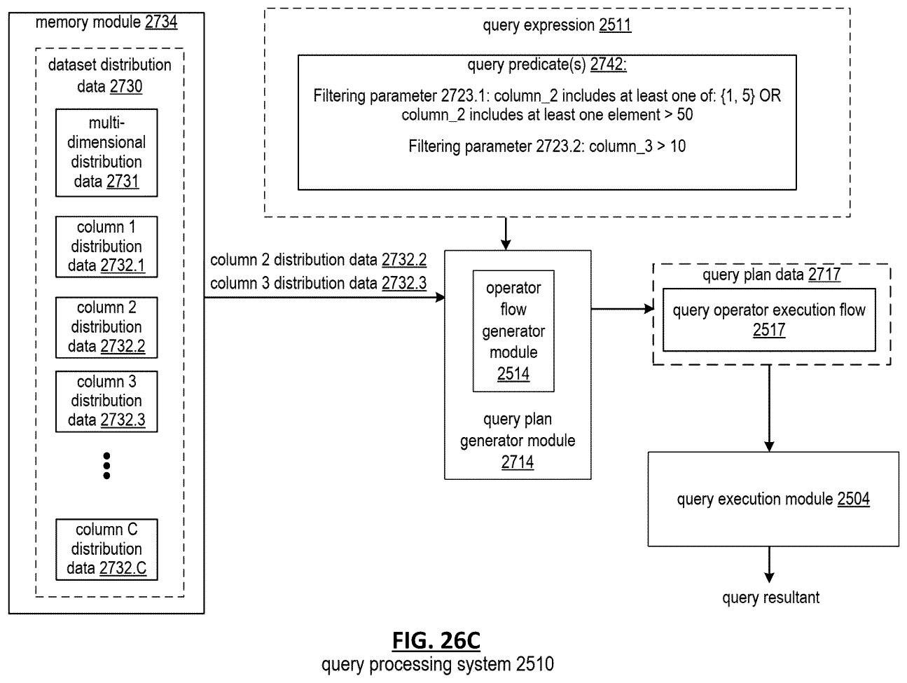

The segment generator can implement a cluster key-based grouping module 2620 to generate a plurality of record groups 2625-1-2625-X from the plurality of records 2422 included in the conversion page set 2655. The cluster key-based grouping module 2620 can receive and/or determine a cluster key 2607, which can be automatically determined by the cluster key-based grouping module 2620, can be stored in memory, can be received from another computing device, and/or can be configured via user input. The cluster key can indicate one or more columns, such as the key column(s) of FIGS. 13-17, by which the records are to be sorted and segregated into the record groups. For example, the plurality of records 2422 included in the conversion page set 2655 are sorted and/or grouped by cluster key, where records 2422 with matching cluster keys and/or similar cluster keys are grouped together in the resulting record groups 2625-1-2625-X. The record groups 2625-1-2625-X can be a fixed size, or can be dynamic in size, for example, based on including only records that have matching and/or similar cluster keys. An example of generating the record groups 2625-1-2625-X via the cluster key-based grouping module 2620 is illustrated in FIG. 26C.

The records 2422 of each record group in the set of record groups 2625-1-2625-X generated by the cluster key-based grouping module 2620 are ultimately included in one segment 2424 of a corresponding segment group in the set of segment groups 1-X generated by the segment generator 1-X. For example, segment group 1 includes a set of segments 2424-1-2424-J that include the records 2422 from record groups 2625-1, segment group 2 includes another set of segments 2424-1-2424-J that include the records 2422 from record groups 2625-2, and so on. The identified record groups 2625-1-2625-X can be converted into segments in a same or similar fashion as discussed in conjunction with FIGS. 13-17.

The record groups are processed into segments via a columnar rotation module 2630 of the segment generator 2517. Once the plurality of record groups 2625-1-2625-X are formed, the columnar rotation module 2630 can be implemented to generate column-formatted record data 2565 for each record group 2625. For example, the records 2422 of each record group are extracted from pages 2515 as row-formatted data. In particular, the records 2422 can be received from data sources 2501 as row-formatted data and/or can be stored in pages 2515 as row-formatted data. All records 2422 in the same record group 2625 are converted into column-formatted row data 2565 in accordance with a column-based format, for example, by performing a columnar rotation of the row-formatted data of the records 2422 in the given record group 2625. The column-formatted row data 2565 generated for a given record group 2625 can be divided into a set of column-formatted row data 2565-1-2565-J, for example, where the column-formatted row data 2565 is redundancy storage error encoded by the segment generator 2517 as discussed previously, and where each column-formatted row data 2565-1-2565-J is included in a corresponding segment of a set of J segments 2424 of a segment group 2522.

The final segments can be formed from the column-formatted row data 2565 to include metadata generated via a metadata generator module 2640. The metadata generator module 2640 can be operable to generate the manifest section, statistics section, and/or the set of index sections 0-x for each segment as illustrated in FIG. 18. The metadata generator module 2640 can generate the index data 2518 for each segment 2424 by utilizing the same or different index generator 2513 of FIG. 25B, where index data 2518 generated for segments 2424 via the metadata generator module 2640 is the same as or similar to the index data 2516 generated for pages as discussed in conjunction with FIG. 21B. The column-formatted row data 2565 and its metadata generated via metadata generator module 2640 can be combined to form a final corresponding segment 2424.

FIG. 22B depicts an example timeline illustrating when the conversion process is determined to be conducted and how this process is iterated over time. The page conversion determination module 2610, and/or the determinations to delay conversion versus initiate conversion over time as illustrated in FIG. 22B, can be utilized to implement the segment generator 2517 of FIG. 22A and/or any other embodiment of the segment generator 2517 discussed herein.

First, a first conversion page set 2655-1 accumulates pages 2515 over time until the page conversion determination module 2610 determines a conversion page set 2655-1 is ready for conversion. At time t1, the conversion page set 2655-1 includes a small number of pages 2515, where the storage resources of page storage system 2506 are not yet fully utilized. This small number of pages relative to the page storage capacity of page storage system 2506 renders the storage utilization data 2606 at time t1 to compare unfavorably to the predetermined conversion threshold data. The segment generation determination data generated by the page conversion determination module 2610 at time t1 therefore delays the conversion process, indicating to wait for more pages 2515 rather than generating segments from the current conversion page set 2655-1 at time t1.

At time t2, more pages 2515 have been accumulated since time t1 based on additional pages having been generated by the page generator 2511 from incoming records of one or more record streams. However, the storage resources of page storage system 2506 are still not yet fully utilized at this time, causing the storage utilization data 2606 at time t2 to again compare unfavorably to the predetermined conversion threshold data. The segment generation determination data generated by the page conversion determination module 2610 at time t2 again delays the conversion process, indicating to wait for more pages 2515 rather than generating segments from the current conversion page set 2655-1 at time t2.

At time t3, even more pages 2515 have been accumulated since time t2, and storage resources of page storage system 2506 are fully utilized and/or sufficiently utilized as dictated by the predetermined conversion threshold data. Thus, enough pages have been accumulated to cause storage utilization data 2606 at time t3 to compare favorably to the predetermined conversion threshold data. The segment generation determination data generated by the page conversion determination module 2610 at time t3 initiates the conversion process by indicating that segments be generated from the current conversion page set 2655-1 at time t3.

After time t3, the pages of the conversion page set 2655-1 can be flushed to other storage and/or can be removed from page storage system 2506. For example, once the segments are successfully generated from conversion page set 2655-1, the pages of conversion page set 2655-1 are deleted from page storage system 2506. The storage utilization data 2606 can indicate that more pages be accumulated for the next conversion page set 2655-2, for example, due to the storage resources of page storage system 2506 again becoming available for storing new pages once the pages of conversion page set 2655-1 are removed.

At time t4, after some or all of the pages of conversion page set 2655-1 have been removed from storage by page storage system 2506, new pages have been generated and stored in page storage system 2506 for conversion in the next conversion page set 2655-2. For example, the next conversion page set 2655-2 can include some pages that were generated while the conversion process of conversion page set 2655-2 was in progress and/or while the resulting segments were being stored into segment storage system 2508. At this time, the storage resources of page storage system 2506 are not yet fully utilized at this time, causing the storage utilization data 2606 at time t4 to compare unfavorably to the predetermined conversion threshold data.

At some later time after t4, enough pages are accumulated in this next conversion page set 2655-2 to cause the storage utilization data 2606 at time t4 to compare favorably to the predetermined conversion threshold data and to initiate another conversion process of converting the conversion page set 2655-2 into segments. This process can continue accumulating and converting subsequent conversion page sets 2655 over time.

Note that the predetermined conversion threshold data can change over time, for example, based on different user configurations, based on changes to storage capacity of the page storage system 2506, based on adding or removal of memory devices of page storage system 2506, based on failures of page storage system 2506, based on trends in clustering levels that can be attained by different numbers of pages at different times, based on changes in amount of different data stored by the resources of the page storage system 2506, based on resource assignment changes in the record processing and storage system 2505, and/or based on other determinations made over time causing the predetermined conversion threshold data to be adjusted accordingly. For example, the predetermined conversion threshold data that triggers initiation of the conversion process for conversion page set 2655-1 at time t3 can be the same as or different from the predetermined conversion threshold data that eventually triggers initiation of the conversion process for conversion page set 2655-2 at some later time after t4.

FIG. 22C illustrates an example embodiment of a cluster key-based grouping module 2620 implemented by segment generator 2517. This example serves to illustrate that the grouping of sets of records in pages does not necessarily correlate with the sets of records in the record groups generated by the cluster key-based grouping module 2620. In particular, in embodiments where the pages can be generated directly from sets of incoming records as they arrive without any initial clustering, the grouping of sets of records in pages may have no bearing on the record groups generated by the cluster key-based grouping module 2620 due to the timestamp and/or receipt time of various records not necessarily having a correlation with cluster key. The embodiment of cluster key-based grouping module 2620 of FIG. 22C can be utilized to implement the segment generator 2517 of FIG. 22A and/or any other embodiment of the segment generator 2517 discussed herein.

In this example, a plurality of P pages 2515-1-2515-P of conversion page set 2655 include records received from one or more sources over time up until the page conversion determination module 2610 dictated that conversion of this conversion page set 2655 commence. The plurality of records in pages 2515-1-2515-P can be considered an unordered set of pages to be clustered into record groups. Regardless of which pages these records may belong to, records are grouped into their record groups in accordance with cluster key. In this example, records of page 2515-1 are dispersed across at least record groups 1 and 2; records of page 2515-2 are dispersed across at least record groups 1, 2, and X, and records of page 2515-P are dispersed across at least record groups 2 and X.

The value of X can be: predetermined prior to clustering, can be the same or different for different conversion page sets 2655; can be determined based on a predetermined minimum and/or maximum number of records that are included per record group; can be determined based on a predetermined minimum and/or maximum data size per record group; can be determined based on each record group having a predetermined level of clustering, for example, in accordance with at least one clustering metric, and/or can be determined based on other information. In some cases, different record groups of the set of record groups 1-X can include different numbers of records, for example, based on maximizing a clustering metric across each record group.

For example, all records with a matching cluster key, such as having one or more columns corresponding to the cluster key with matching values, can be included in a same record group. As another example, a set of records having similar cluster keys can all be included in a same record group. As another example, if the value of the cluster key can be represented as a continuous variable, numeric variable, or other variable with an inherent ordering with respect to a cluster key domain, the cluster key domain can be subdivided into a plurality of discrete intervals. In such cases, a given record group, or a given set of record groups, can include records with cluster keys having values in the same discrete interval of the cluster key domain. As another example, a record group has cluster key values that are within a predefined distance from, or otherwise compare favorably to, an average cluster key value of cluster keys within the record group. In such cases, a Euclidian distance metric, another vector distance metric, and/or any other similarity and/or distance metric can be utilized to measure distance between cluster key values of the record group. In some cases, a clustering algorithm and/or an unsupervised machine learning model can be utilized to form record groups 1-X.

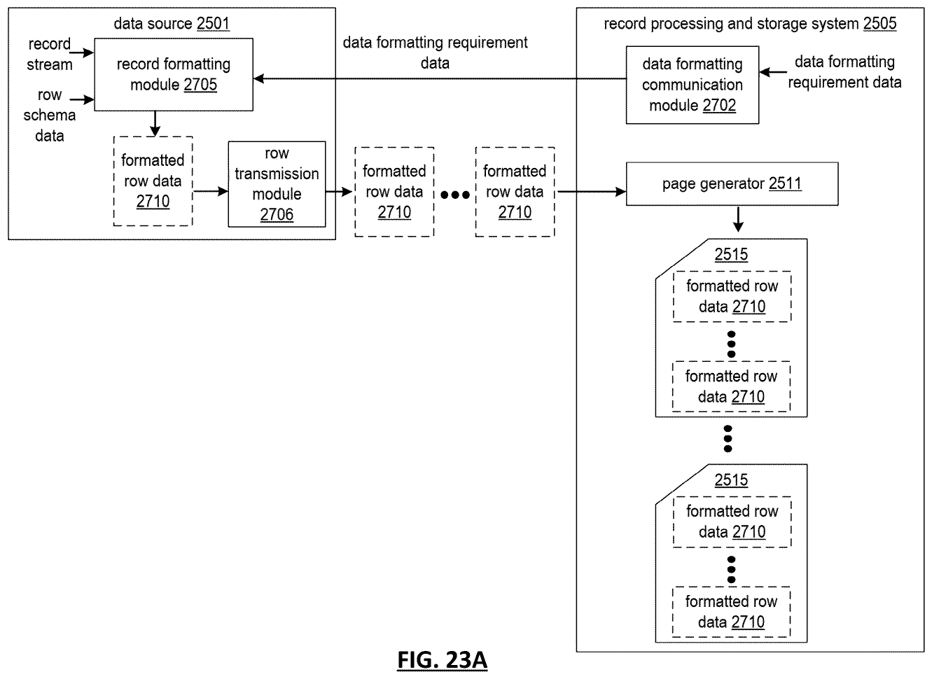

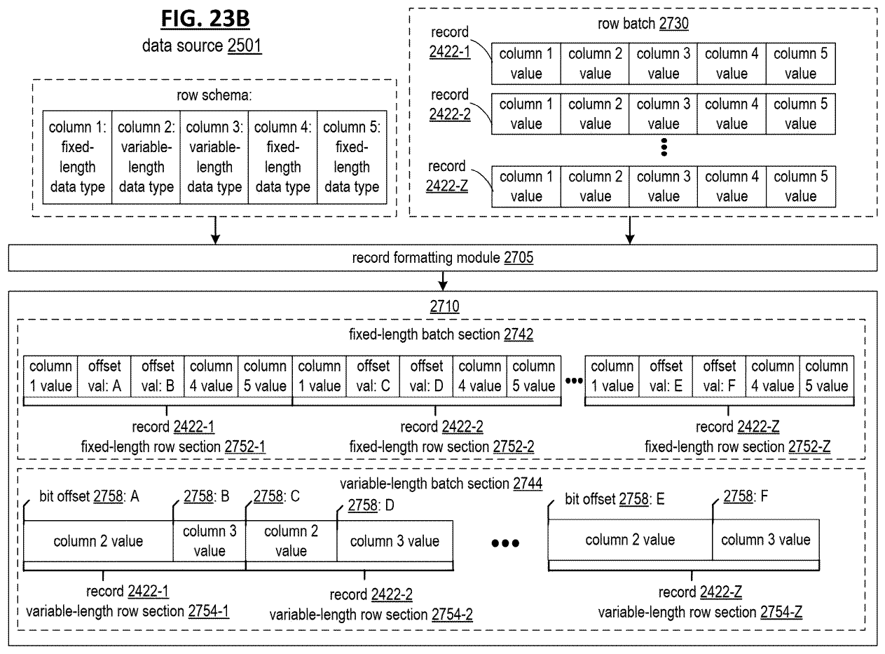

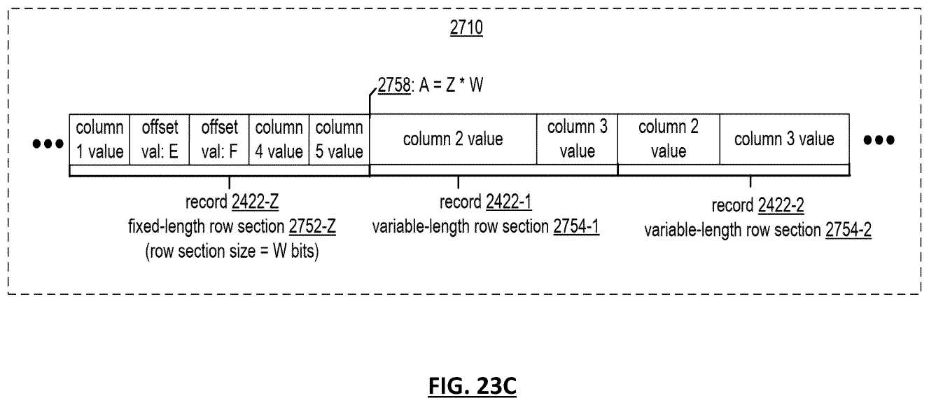

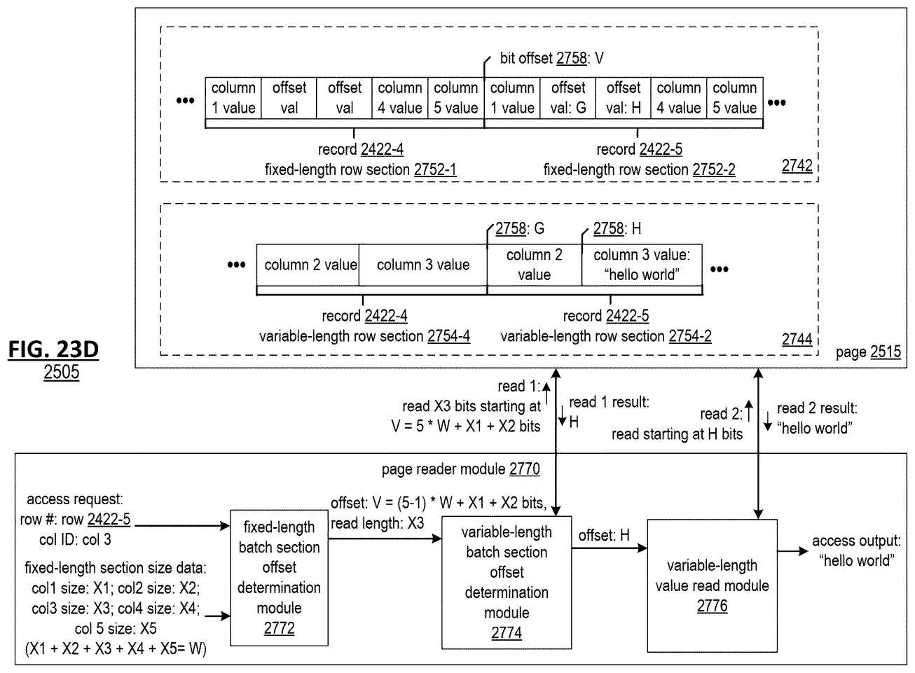

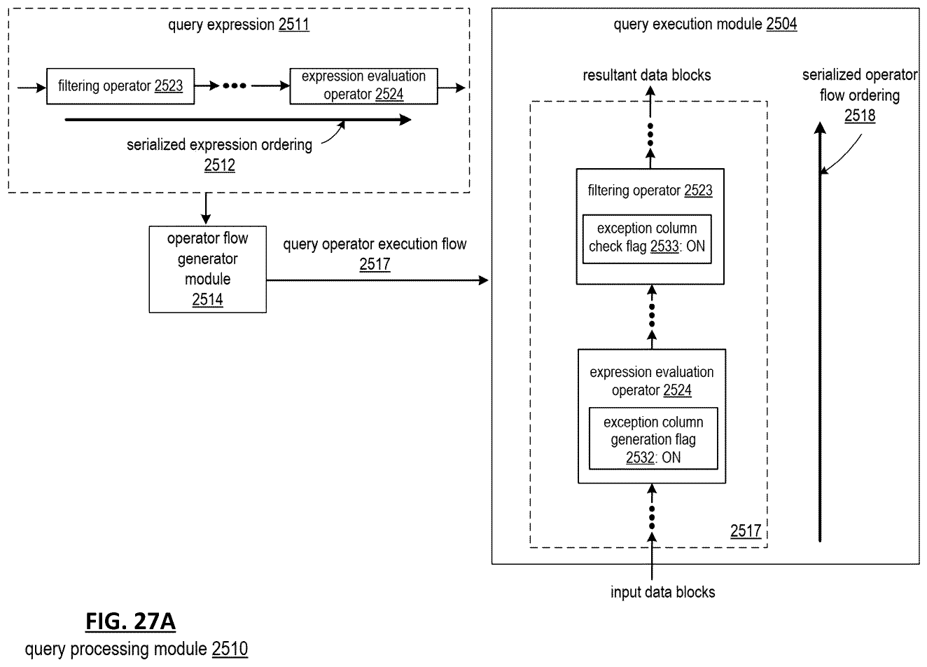

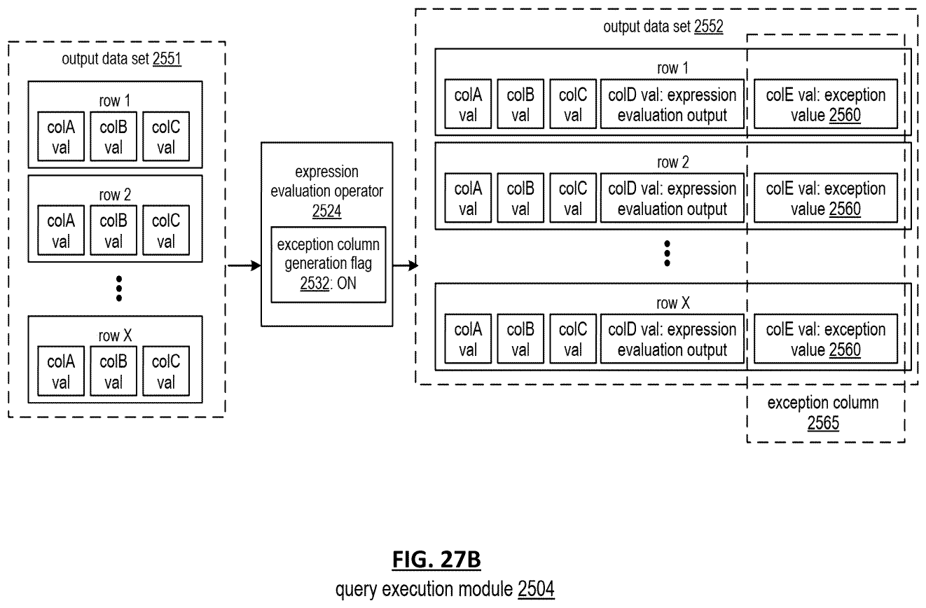

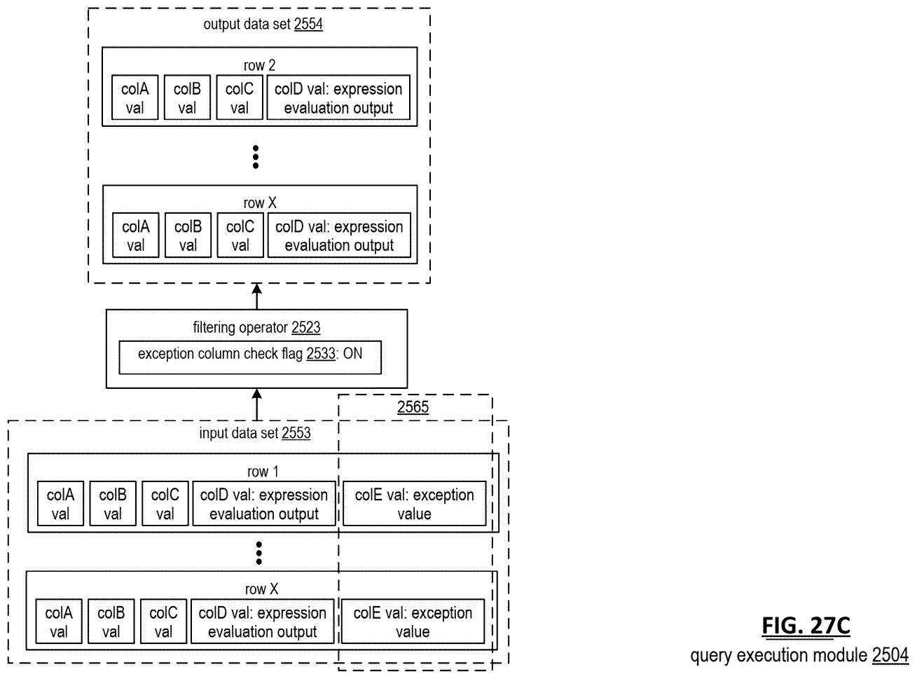

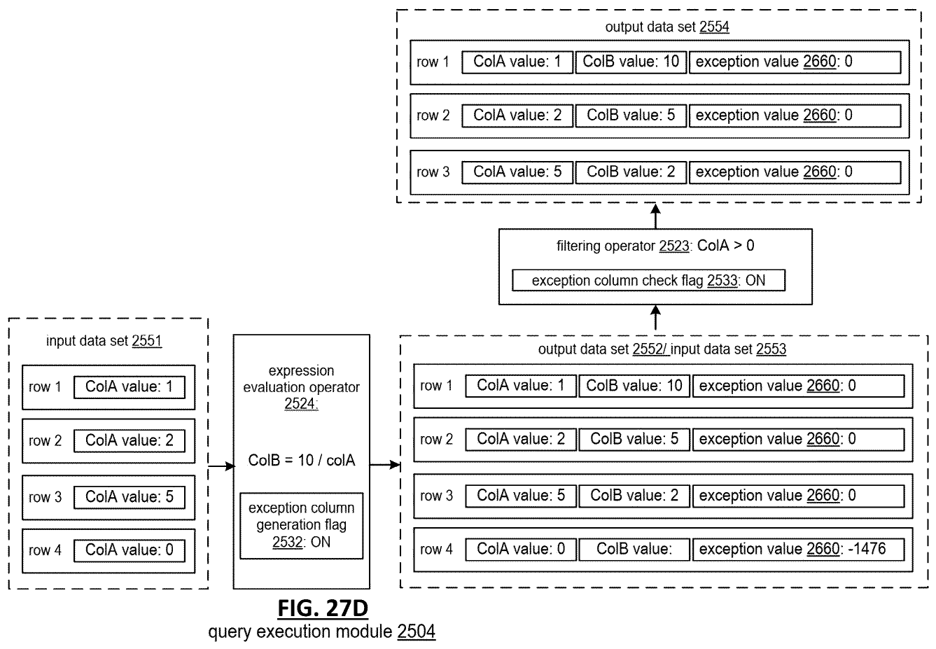

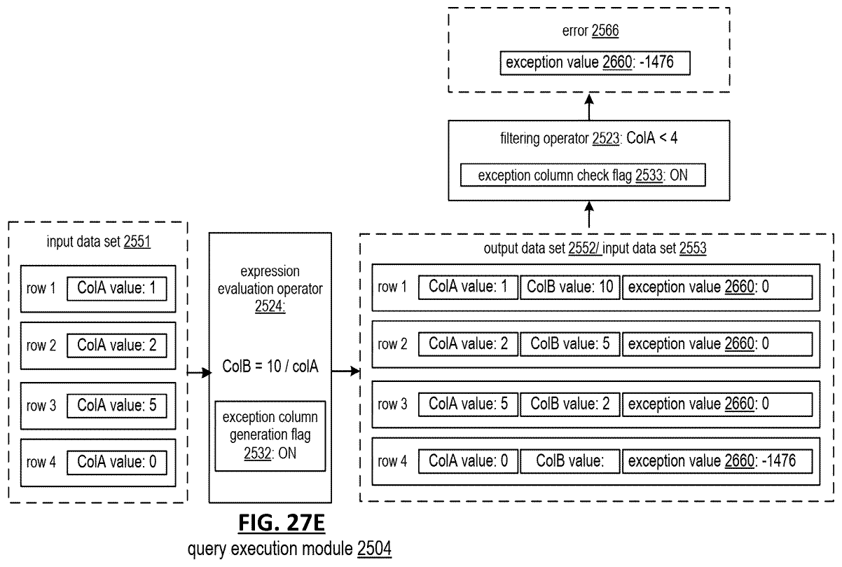

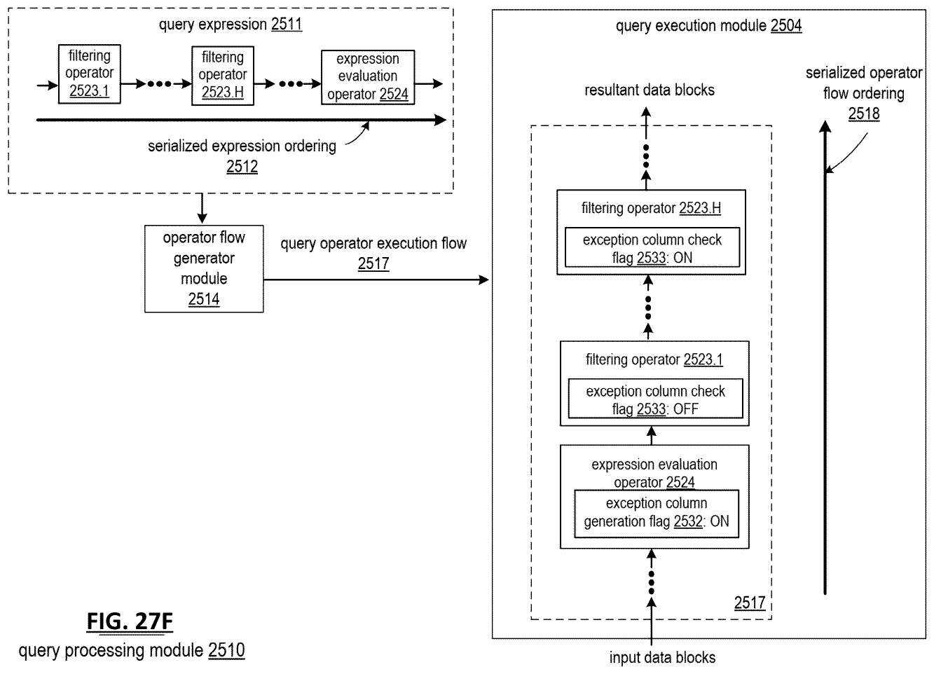

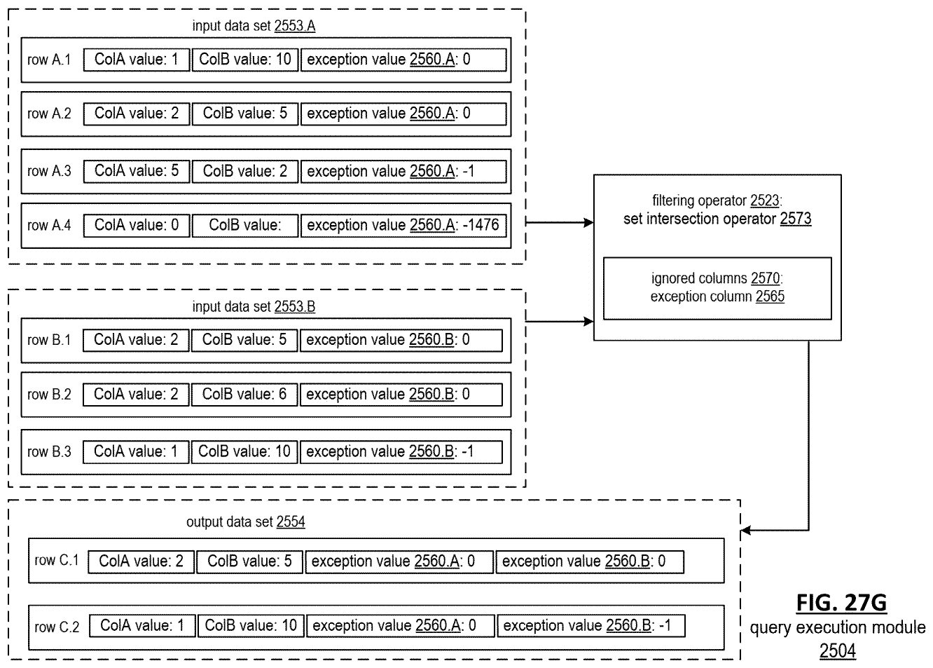

FIGS. 23A-23D illustrate embodiments of a record processing and storage system 2505 that stores pages 2515 in accordance with a row-based format that accounts for variable-length fields of its rows. The record processing and storage system 2505 discussed in conjunction with FIGS. 27A-27D can be utilized to implement the record processing and storage system 2505 of FIG. 25A and/or any of the embodiments of the record processing and storage system 2505 discussed herein.

As discussed previously in conjunction with FIGS. 20A-20B, data movement for bytes received from the data sources 2501 is ideally minimized for performance and efficiency reasons. To further reduce processing of incoming records in generating pages 2515, data sources can be required to send their records a format that closely matches how the records be stored in pages 2515. In particular, as row traversals are more easily executed on fixed-size rows to reduce the complexity of advancing row by row and/or jumping to a particular row, the pages 2515 ideally store rows as fixed-length row data. However, as incoming rows can include one or more fields with variable-length data types, such as variable-length strings, the formatted row data in pages must account for this variable-length data while maintaining traversal across rows in a fixed-length fashion.

FIGS. 23A-23D present a solution to this problem via receipt and storage of formatted row data 2710 that has a fixed length section and a variable length section. In the fixed length section, aligned with where the variable length field values for each row would be included, a fixed-length offset value into the associated variable length section, such as a 32 bit offset, is instead included. In particular, the variable-length data of several rows can be separated entirely from the fixed-length data of these rows in the formatted row data 2710. On offset value indicating the location of a given row's variable-length data can be included as an additional fixed-length field within the fixed-length data for the row in the formatted row data 2710. Storing pages as this formatted row data 2710 enables easy traversals between rows, even when the rows include variable-length data, as traversal requires simple multiplication or addition as a function of fixed row length and/or fixed field length.

This improves the technology of database systems by increasing efficiency of row reads for rows stored in pages. This increased efficiency of row reads further enables the improvements to the technology of database systems presented the delay of the conversion process discussed in FIGS. 22A-22D, as simpler row reads for rows in pages enables query execution upon rows pending conversion into segments to be performed efficiently. This increased efficiency of row reads also improves the efficiency of the conversion process itself, as rows can more easily be accessed and clustered into record groups for conversion into segment groups by segment generator 2517 via these more efficient reads of the rows.

Furthermore, rather than requiring that incoming rows be reformatted in this manner after being received from a source, data sources can be required to pre-format their batches of rows as formatted row data 2710. The record processing and storage system 2505 can receive the record streams 1-L as from data sources 1-L as batches of formatted row data 2710 in accordance with the formatting discussed above, and can utilize page generator 2511 to place this formatted row data 2710 directly into pages 2515. Receiving the row data from data sources as the formatted row data 2710 to be included in pages 2515 improvements to the technology of database systems by reducing the processing and data movement required to generate pages from incoming records, enabling resources to be preserved for other functionality of the record processing and storage system 2505 and/or enabling higher data rates of incoming records to be received and processed for storage.

FIG. 23A illustrates an embodiment of such a record processing and storage system 2505 that receives records from a particular sources as a stream of formatted row data 2710 received over time. The formatted row data 2710 can be utilized to implement the row data 2910 of FIG. 21C and/or can include the row data 2910 of FIG. 21C in accordance with a particular format. Each formatted row data 2710 can include a plurality of records 2422 in accordance with this particular format. An embodiment of the particular format of formatted row data 2710 is discussed in further detail in conjunction with FIG. 23B.

The page generator 2511 can receive formatted row data 2710 from one or more data sources 2501, and can generate a given page 2515 directly from one or more formatted row data 2710 received from one or more data sources 2501. For example, the page generator 2511 can generate pages to include formatted row data 2710 as discussed in conjunction with FIG. 21C. In some cases, the formatted row data 2710 received from data sources 2501 is unaltered and/or is only slightly modified for its inclusion in a given page 2515.

To ensure incoming record streams are received as formatted row data 2710, the record processing and storage system 2505 can optionally implement a data formatting communication module 2702. The data formatting communication module 2702 can determine and send data formatting requirement data to one or more data sources 2501 that send record streams to the record processing and storage system 2505. The data formatting requirement data can indicate rules and/or instructions regarding how to generate the formatted row data 2710 from given records. The data formatting requirement data can be determined by the data formatting communication module 2702 via user input, via configuration of the database system 10, via retrieval from memory, and/or via another determination.

One or more data sources 2501 can implement a record formatting module 2705 to generate formatted row data 2710 from a corresponding record stream to be sent to the record processing and storage system 2505 based on the data formatting requirement data. For example, the record formatting module 2705 utilizes the data formatting requirement data received from the record processing and storage system 2505 as illustrated in FIG. 23A. In some cases, the data formatting requirement data can include application data corresponding to the record formatting module 2705 for download and/or installation by one or more data sources 2501. When the application data is executed by at least one processing module of a data source 2501, it can cause the data source 2501 to implement some or all of the functionality of the record formatting module 2705 described herein. Alternatively, the data sources 2501 can otherwise receive and/or determine the data formatting requirement data via other communication with the database system 10, via downloading the data formatting requirement data from a server associated with the database system 10, via accessing the data formatting requirement data from its own memory and/or from other memory, and/or via another determination.

The record formatting module 2705 can optionally generate formatted row data 2710 further based on row schema data that indicates the schema of the records in its record stream. The row schema data can indicate a set and/or ordering of fields of each record, for example, in accordance with a plurality of columns of a corresponding relational database table. The row schema data can indicate a data type and/or data length of each field. The row schema data can indicate whether each field includes fixed-length data and/or variable-length data.

The data source can generate formatted row data 2710 over time from sets of rows in the record stream in accordance with the data formatting requirement data and/or the row schema data. As formatted row data 2710 is generated, it can be transmitted by the data source to the record processing and storage system 2505 for storage via a row transmission module 2706 of the data source 2501. The row transmission module 2706 can be implemented as a communication interface and/or transmitter operable to send the formatted row data, for example, one at a time, to the record processing and storage system 2505 via a wired and/or wireless communication network.

FIG. 23B illustrates an example embodiment of generating formatted row data 2710 via record formatting module 2705 from a given set of rows of the record stream based on data formatting requirement data and/or the row schema data. The record formatting module 2705 and formatted row data 2710 of FIG. 23B can be utilized to implement the record formatting module 2705 and formatted row data 2710 of FIG. 23A, and/or to implement any embodiments of the record formatting module 2705 and/or formatted row data 2710 discussed herein.

As illustrated in FIG. 23B, a given set of records 2422-1-2422-Z to be included in a particular formatted row data 2710 generated by the record formatting module 2705 can be included in a row batch 2730. For example, the row batch 2730 is a set of sequential records of the record stream. In some cases, different formatted row data 2710 can include a same number or different number of rows. In some cases, all row batches utilized to generate all formatted row data 2710 include the same number of records.

In this example, as indicated by the row schema illustrated in FIG. 23B, each record 2422 includes five fields, corresponding to five columns of a database table. Column 1 is of a particular fixed-length data type, column 2 is of a particular variable-length data type, column 3 is of a particular variable-length data type, column 4 is of a particular fixed-length data type, and column 5 is of a particular variable-length data type. Note that because column 2 and column 3 have variable length values, the records 2422-1-2422-Z can have varying lengths. Note that other embodiments can have any row schema with any number of columns that include any combination of fixed-length and variable-length data types.

The record formatting module 2705 generates formatted row data 2710 from the row batch 2730 to include a fixed-length batch section 2742 and a variable-length batch section 2744. The fixed-length batch section 2742 can be separate from the variable-length batch section 2744. For example, the entire variable-length batch section 2744 can be appended and/or concatenated after the entire fixed-length batch section 2742 in the formatted row data 2710.

The fixed-length batch section includes a plurality of fixed-length row sections 2752-1-2752-Z, where each fixed-length row section 2752 corresponds to one of the records 2422 of the row batch 2730. The fixed-length row sections 2752-1-2752-Z can be appended and/or concatenated, for example, one at a time in the fixed-length batch section 2742. The variable-length batch section 2744 can include a plurality of variable-length row sections 2754-1-2754-Z, where each variable-length row section 2754 corresponds to one of the records 2422 of the row batch 2730. The variable-length row sections 2754-1-2754-Z can be appended and/or concatenated, for example, one at a time in the variable-length batch section 2744.

Each fixed-length row sections 2752 can include fixed-length values for each of the set of columns of the record, in accordance with row schema. The original values of a given record 2422's columns with fixed-length data are included in the corresponding fixed-length row section 2752. However, rather than including original values of a record 2422's columns with variable-length data, fixed-length offset values are instead generated and included in the corresponding fixed-length row section 2752. Note that different fixed-length data values of different fixed-length fields of a given record can have the same or different fixed-lengths. However, a given fixed-length field has corresponding data values of the same, known length in any record 2422. Therefore, the data length of each fixed-length row section 2752-1-2752-Z is identical and known, despite the corresponding records 2422-1-2422-Z having different data lengths due to also having variable-length variables.

Each of the variable-length row sections 2754 store the original values of any variable-length columns the corresponding record 2422. Note that because the variable-length row sections 2754-1-2754-Z can be of differing, unknown lengths due to including the variable-length values of variable length fields of the records 2422 in row batch 2730 that may have different lengths for different records.

The fixed-length offset value for a given column of a fixed-length row section 2752 of a given record 2422 can indicate a location of the corresponding, original value of the given column in the variable-length batch section 2744. As depicted in FIG. 23B, fixed-length offset value for a particular column in fixed-length row section 2752 for a given record 2422 includes the value of a corresponding bit offset 2758 of the original value for the particular column for the given record 2422. Each offset values can indicate and/or be implemented as a bit offset, a pointer value, other fixed-length information indicating the location of the original value of the corresponding column of the corresponding record 2422 in the variable-length batch section 2744. For example, the variable-length batch section 2744 can be generated first from the variable-length fields of the records 2422 in row batch 2730, and each offset values can be tracked as a corresponding original value is appended to the variable-length batch section 2744. These offset values are then utilized to populate the corresponding fixed-length value of the corresponding columns for each corresponding fixed-length row section 2752.

In this example, fixed-length values are included in each fixed-length row section 2752 for each of the five columns of the rows of row batch 2730. The original values of columns 1, 2, and 5 of a given record 2422 are included in the corresponding fixed-length row section 2752 because they are fixed-length data types. Fixed-length offset values are generated and included for columns 2 and 3, for example, serving as fixed-length placeholders for the original values of columns 2 and 3 and further indicating the locations of the original values columns 2 and 3 in the variable-length batch section 2744. The original values of columns 2 and 3 of a given record 2422 are thus included in the corresponding variable-length row section 2754. As illustrated, the fixed-length batch section includes: a fixed-length offset value of A for column 2 of record 2422-1; a fixed-length offset value of B for column 3 of record 2422-1; a fixed-length offset value of C for column 2 of record 2422-2; a fixed-length offset value of D for column 3 of record 2422-2; a fixed-length offset value of E for column 2 of record 2422-Z, and a fixed-length offset value of F for column 2 of record 2422-Z. These fixed-length offset values A, B, C, D, E, and F are the values of corresponding bit offsets 2758 to the location of the respective original values in the variable length batch section 2744.

The offset values A, B, C, D, E, and F of FIG. 23B are strictly increasing in value, at varying distances apart. In some cases, the offset values denote bit offsets with respect to the entire formatted row data 2710, where offset value A is a non-zero bit offset to the start of the variable-length batch section 2744 within the formatted row data 2710. In some cases, as the start of the variable-length batch section 2744 is deterministic, for example, based on the number of rows Z and based on the fixed-length of each value for each column stored in fixed-length row section 2752, the offset values instead can denote bit offsets with respect to only variable-length batch section 2744, for example, where value of offset value A is zero. In some cases, the offset values can alternatively or additionally indicate a length of the original data and/or can otherwise denoting both the start and the end of the original data in the variable-length batch section 2744.

The record formatting module 2705 is implemented by a data source 2501 for generating formatted row data 2710 that is transmitted to the record processing and storage system 2505 in some embodiments, as depicted in FIG. 23A. In other embodiments, the record formatting module 2705 of FIG. 23B can be implemented by the record processing and storage system 2505. For example, the record processing and storage system 2505 can receive row data 2910 from one or more data sources 2501 in accordance with a different format, and the page generator 2511 can implement its own record formatting module 2705 to first generate the formatted row data 2710 from the incoming row data 2910. The page generator 2511 can then generate pages 2515 to include this formatted row data 2710 as discussed previously.

FIG. 23C illustrates how the entire variable-length batch section 2744 can be appended after the entire fixed-length batch section 2742 in the formatted row data 2710. In particular, the first variable-length row section 2754-1 can be appended after the last fixed-length row section 2752-Z. As illustrated, the first offset value A, denoting the location of the first variable-length value for a first record 2422 in the variable-length batch section 2744, can denote the start of the variable-length batch section 2744, and can be stored in the corresponding fixed-length row section 2752 for the corresponding record 2422 in the fixed-length batch section 2742. In cases where the offset values denote offsets with respect to the entire formatted row data 2710, the value of A is equal to or based on product of a row section size W, denoting the length of each fixed-length row section 2752, and the total number of records Z. Each next subsequent offset value is based on the length of each prior original value, for example, where B is equal to or based on the sum of A and the length of the original value of column 2 of record 2422-1, where C is equal to or based on the sum of B and the length of the original value of column 3 of record 2422-1, and so on.

FIG. 23D illustrates an embodiment of a record processing and storage system 2505 that implements a page reader module 2770. The page reader module 2770 can be implemented to leverage the known length of fixed-length row sections 2752 to iterate over and/or jump to particular fixed-length row sections 2752. This enables page reader module 2770 to easily read one or more original column values of any given records.

The page reader module 2770 can be implemented to enable any reading of records and/or particular record fields as necessary by the database system. For example, the page reader module 2770 can be implemented when pages are read for query executions by query processing system 2502, such as by a particular node accessing its page storage 2546 in conjunction with its execution of a query at IO level 2416 as illustrated in FIG. 25E. As another example, the page reader module 2770 can be implemented when pages are read by cluster key-based grouping module 2620 to generate record groups during the conversion process performed by segment generator 2517 as illustrated in FIG. 26A.

The original values of a fixed-length field of a given record is read directly from the fixed-length row section 2752 of the given record. The original values of a variable-length field of a given record is read by first reading the offset value stored as a fixed-length placeholder for the variable-length field in the fixed-length row section 2752 of the given record, and by second reading the original value of the variable-length field from the variable-length section, starting from the offset value read from the fixed-length row section 2752 of the given record.

In the example illustrated in FIG. 23D, the page reader module 2770 determines to access column 3 of a particular record 2422-5 in the formatted row data 2710 of the given page 2515. This can be determined based on receiving an access request denoting the row number, such as a number in accordance with the ordering of rows, and/or denoting the column identifier for the column to be read.

The page reader module 2770 can further determine fixed-length section size data denoting the size of each column. In this example, the sizes of the columns 1-5 in each fixed-length row data are X1, X2, X3, X4, and X5, respectively. The total length of each fixed-length row data is equal to a value W, which is equal to or based on the sum of these fixed-length column sizes X1, X2, X3, X4, and X5. In some cases, this is determined based on receiving and/or determining the row schema data of FIG. 26C from a corresponding data source 2501, based on known length of offset values stored in fixed-length row data in accordance with the data formatting requirement data, and/or based on other predetermined information.

A fixed-length batch section offset determination module 2772 can determine the location of the requested column in the fixed-length batch section 2742 based on the requested row number and column identifier, and/or further based on the determine fixed-length section size data. In this example, the fixed-length batch section offset determination module determines to read from a bit offset 2758 with value V, where V is equal to or based on computing (5−1)*W+X1+X2. In particular, (5−1)*W jumps to the beginning of the fifth row's fixed-length row section 2572-5 in the fixed-length batch section 2472, and further adding X1+X2 jumps to the third column value of the fixed-length row section 2572-5. A read length of X3 can be utilized to read only the fixed-length value of column 3 of fixed-length row section 2572-5 based on the known length of column 3's placeholder offset value.

These read parameters determined by fixed-length batch section offset determination module 2772 can be utilized by a variable-length batch section offset determination module 2774 performed as a first read to the page 2515, denoted read 1. In this example, the offset value stored for column 3 of fixed-length row section 2572-5 is the value H, and thus read 1 returns the value H based on reading the data starting at bit offset V for length X3. In cases where the value being read corresponds to a fixed-length field, the read by page reader module 2770 can end here, as the corresponding reads to column values of particular fixed-length row section 2752 renders the original value for fixed-length fields of the corresponding record. However, as this example illustrates reading the value of a variable-length field, the page reader module 2770 must next read the original value from the variable-length batch section 2744.

In particular, a variable-length value read module 2776 can utilize the offset value read in read 1 to facilitate a second read, denoted read 2, to the page 2515. In this example, the variable-length data type of column 3 is a variable-length string, and the particular string value for column 3 of record 2422-5 is “hello world.” The value “hello world” is thus returned by performing read 2 based on reading the data starting at bit offset H. In some cases, the read length of read 2 is determined based on reading the value H in read 1, where the offset values in the fixed-length row section 2752 include read length data in addition to the bit offset value. In other cases, the variable-length row section can include header data or other known data pattern indicating the start and/or end of a given value to segregate the given values and denote ends to reads of given values, where read 2 is ended once reaching the known data pattern denoting the start of the next value. The read length can otherwise be determined from the bit offset value read from the fixed-length row section 2752 and/or from other information included in formatted row data 2710. The value “hello world” returned by read 2 can be utilized as access output of the requested read of column 3 of record 2422-5.

FIGS. 24A-24C illustrate a particular embodiment of the formatted row data 2710 of FIGS. 23A-23C that handles variable-length data that is compressed for storage by record storage and processing system 2505. In particular, the formatted row data 2710 can be implemented to accommodate data fields that will be compressed, such as variable length strings that will be dictionary encoded.

Consider a case where a row scheme includes some variable-length fields that will be compressed and other variable-length fields that will not be compressed. If the formatted row data 2710 as presented in FIGS. 23A-23C was converted into pages 2515 in its given form, the compression of data in variable-length fields would be unideal. In particular, if record processing and storage system 2505 re-wrote the variable length batch section 2744 to remove the full values that were compressed. This would involve a high level of data shifting, which would involve more data movement than ideal and would consume processing resources of the record storage and processing system 2505. If this data movement were to be avoided to enable directly placing the formatted row data 2710 into pages 2515 as discussed previously, the record processing and storage system 2505 would thus need to continue storing the full values, rendering the compression of these values redundant.

The embodiment of record formatting module 2705 and corresponding formatted row data 2710 present a solution to this problem. Rather than including the values of variable-length fields that will be compressed in the variable-length batch section, this data can be included in a separate, temporary variable-length batch section. Once these values are compressed, the entire temporary variable-length batch section can be simply pruned off after compression, where no rewrites are required and where all offsets are preserved. This further improves the technology of database systems by enabling compression of variable-length fields, while minimizing data movement required to generate pages from incoming formatted row data.

This mechanism of generating formatted row data 2710 is illustrated in FIG. 24A. The record formatting module 2705 can apply some or all of the functionality discussed in conjunction with FIG. 23B to generate the formatted row data 2710. However, the record formatting module 2705 of FIG. 24A is further operable to separately store variable-length data that will be compressed, such as variable length strings that will be dictionary encoded. For example, the data formatting requirement data utilized by the record formatting module 2705 can indicate types of data and/or particular fields that will be compressed, and can indicate types of data and/or particular fields that will not be compressed. For example, this information regarding fields to be compressed can be determined and sent to the data source that implements the record formatting module 2705 as illustrated in FIG. 23A.

In this example, the row schema again indicates that columns 1, 4, and 5 are fixed-length data types, and that columns 2 and 3 are variable-length data types. The row schema additionally indicates that column 3 is denoted as a variable-length field that will be compressed by the record processing and storage system 2505, while column 2 is denoted as a variable-length field that will not be compressed by the record processing and storage system 2505. Note that a different number of columns that include different numbers of variable-length field that will be compressed and/or variable-length field that will not be compressed can be utilized for row schemas of other embodiments.

The formatted row data 2710 again includes a same or similar fixed-length row section 2742 as described in conjunction with FIG. 27B, and/or includes a same or similar variable-length row section 2744 as described in conjunction with FIG. 23B. The formatted row data 2710 further includes a temporary variable-length batch section 2848 that stores values of variable length that will be compressed. In cases where all variable-length data is to be compressed, the formatted row data 2710 optionally does not include the variable-length batch section 2744, and only includes the fixed-length batch section 2742 and the temporary variable-length batch section 2848.

The variable-length batch section 2744 is generated in a same or similar fashion as described in conjunction with FIG. 27B. However, each variable-length row section 2754 only includes values for the corresponding record that correspond to one or more variable-length fields that will not be compressed. In this case, the variable-length batch section 2744 only includes values for column 2 of the records 2422-1-2422-Z based on column 2 being the only variable-length fields that will not be compressed. Note that multiple fields variable-length fields that will not be compressed can be included in each variable-length row section 2754, for example, as illustrated in FIG. 23B.

The temporary variable-length batch section 2848 can be generated in a same or similar fashion as the variable-length batch section 2744 to include a plurality of variable-length row sections 2882-1-2882-Z. However, each variable-length row section 2882 instead includes only values for the corresponding record that correspond to one or more variable-length fields that will be compressed. In this case, the variable-length batch section 2744 only includes values for column 3 of the records 2422-1-2422-Z based on column 3 being the only variable-length fields that will be compressed. In particular, the variable-length row section 2882-1 corresponds to record 2422-1 and includes the value R based on the column 3 value of record 2422-1 including the value R; the variable-length row section 2882-2 corresponds to record 2422-2 and includes the value S based on the column 3 value of record 2422-1 including the value S; and the variable-length row section 2882-1 corresponds to record 2422 and includes the value T based on the column 3 value of record 2422-1 including the value T. The depicted R, S, and T can represent any variable-length data value in accordance with the variable-length data type of column 3. For example, R, S, and T each represent different variable-length strings of the same or different length. Note that multiple fields variable-length fields that will be compressed can be included in each variable-length row section 2882, for example, in a same or similar fashion as the variable-length row sections 2754 of FIG. 23B.

The fixed-length batch section 2742 is generated in a same or similar fashion as described in conjunction with FIG. 23B. However, the offset values stored as the fixed-length values of column 3 in the fixed-length row sections 2752-1-2752-Z indicate a bit offset into the temporary variable-length batch section 2848. Note that the bit offsets B, D, and F are offsets into the temporary variable-length batch section 2848, which is appended after the variable-length batch section 2744. The bit offsets B, D, and F can therefore be strictly greater than the bit offsets A, C, and E. The values of bit offsets A, B, C, D, E, and F of FIGS. 24A-24C can otherwise have a different ordering than the values of bit offsets A, B, C, D, E, and F of FIGS. 23B-23C based on the separation of the temporary variable-length batch section 2848, which is appended after, or otherwise is separate from, the variable-length batch section 2744. The values of bit offsets A, B, C, D, E, and F of FIGS. 24A-24C can otherwise be different from the values of bit offsets A, B, C, D, E, and F of FIGS. 23B-23C.

FIG. 24B illustrates how the entire temporary variable-length batch section 2848 can be appended after the entire fixed-length batch section 2742 and the entire variable-length batch section 2744 in the formatted row data 2710. In particular, the first variable-length row section 2882-1 can be appended after the last variable-length row section 2754-Z. As illustrated, the offset value B, denoting the location of the first temporary variable-length value for a first record 2422 in the temporary variable-length batch section 2848, can denote the start of the temporary variable-length batch section 2848, and can be stored in the corresponding fixed-length row section 2752 for the corresponding record 2422 in the fixed-length batch section 2742. In cases where the offset values denote offsets with respect to the entire formatted row data 2710, the value of B is equal to or based on a total size of the entire fixed-length batch section 2742 plus a total size of the entire variable-length batch section 2744. Each next subsequent offset value is based on the length of each prior original value, for example, where D is equal to or based on the sum of B and the length of the original value of column 3 of record 2422-1.

FIG. 24C illustrates an embodiment of a record processing and storage system 2505 that implements a dictionary encoding module 2850 to facilitate compression of the values in the temporary variable-length batch section 2848 via dictionary encoding in a dictionary 2870. In some cases, the dictionary encoding module 2850 can be implemented by the page generator 2511 and/or can be applied to incoming formatted row data 2710 before being stored in a given page. In other cases, the dictionary encoding module 2850 can be implemented by the page generator 2511 and/or can be applied to formatted row data 2710 after being stored in a given page.

Dictionary 2870 can be implemented as a map data structure stored by one or more memory devices of record processing and storage system 2505, where each entry to dictionary 2870 stores a given full value of one or more variable-length fields, such as a variable-length string, mapped to a unique key value. The corresponding key value can be a fixed-length data type, and can be stored instead of the full value of one or more variable-length fields for the record while stored as a page 2515 and/or a segment 2424. The dictionary 2870 can be utilized to enable reading of the original full values of the compressed fields via the corresponding key. In particular, the corresponding key can be read from a given record via access to the corresponding page 2515 and/or segment 2424, and the full value can then be retrieved from the dictionary 2870 based on this key. In other embodiments, other compression mechanisms can be applied to the values in the temporary variable-length batch section 2848.

For a given formatted row data 2710, the dictionary encoding module 2850 can generate new entries to dictionary 2870 via a dictionary key generator module 2855. Each entry can have a key value assigned to the corresponding full value for compression. In this example, an entry is generated for value R to include a key value U; an entry is generated for value S to include a key value V, and an entry is generated for value T to include a key value W, and these entries are included in dictionary 2870 for use in subsequent reads of the records via reading these keys in record reads to pages 2515 and/or segments 2424.

The values to be compressed via these dictionary entries can be first read from the formatted row data 2710 by utilizing a reader module 2872, which can be implemented utilizing some or all of the functionality of page reader module 2770 of FIG. 27D, even if the formatted row data 2710 is not yet included in a page 2515. For example, value R is read by first determining a first offset to read third column of the first record 2422-1 via fixed-length batch section offset determination module 2772; by next determining a second offset to read the corresponding variable-length data via a first read to the formatted row data via variable-length batch section offset determination module 2774 based on the first offset, where the second offset is read as the value E; and/or by finally determining the original value of the third column of the first record 2422-1 via variable-length value read module 2776 by applying the value E that was returned via the first read to next read the value R from the temporary variable-length batch section 2848 via a second read. The same process can similarly be applied to read the other variable-length values of the temporary variable-length batch section 2848 including value S and value T.

Once the keys for the new dictionary entries are determined by dictionary encoding module 2850, a page reformatting module 2860 can be implemented to modify the formatted row data 2710. In particular, the offset values into the temporary variable-length batch section 2848 that are stored as the fixed-length values for the corresponding columns in the fixed-length row section 2752 can be replaced with the corresponding key values. In this example, the offset value of B included as the placeholder for column 3 in the fixed-length row section 2752-1 is replaced with the key value U based on U being denoted as the key value to the value R in the dictionary 2870 and based on the value R being the value for column 3 of the corresponding record 2422-1. The offset value of D included as the placeholder for column 3 in the fixed-length row section 2752-2 is similarly replaced with the key value V, and the offset value of F included as the placeholder for column 3 in the fixed-length row section 2752-2 is similarly replaced with the key value W.

When pages 2515 are later read, for example, by page reader module 2770, these compressed values can be recovered. For example, the fixed-length batch section offset determination module 2772 can be first utilized to determine the offset for the given column of the given record to be read. Next, the key value can be returned via a read to the page 2515 at this determined offset. Finally, this read key value can be utilized to retrieve the corresponding value from dictionary 2870.

The replacement of these offset values can be facilitated by simply overwriting the existing values with the key values. In particular, the offset values can be configured to have a same fixed-data length as the key values, for example, as dictated by the data formatting requirement data, to enable simple overwriting of these values without necessitating any shifting of the other data in formatted row data 2710. The offset where each overwrite occurs can be determined via the fixed-length batch section offset determination module 2772 by applying the given column of the given record to be overwritten, and the write from this offset can be facilitated via a write to the formatted row data accordingly. No additional data movement is required to facilitate these replacements, and all other offsets to the variable-length batch section 2744 are maintained and do not need to be updated. This can be advantageous if the formatted row data 2710 is already stored in a page 2515. and is accessed via reads to the page 2515.

The page reformatting module 2860 can further facilitate the removal of the temporary-length batch section 2848 once the new entries are generated and stored in dictionary 2870, as this information is no longer necessary to facilitate reads of the corresponding values. As these values are all appended in a same section, the section can be simply pruned-off, for example, where an end offset value of the formatted row data 2710 and/or of a corresponding page 2515 can be adjusted to indicate the end of this data as the end of variable-length batch section 2744. Other data, such as other formatted row data 2710 and/or other page 2515 can optionally be subsequently written to the location of the prior temporary variable-length batch section 2848.

FIGS. 25A-25D illustrate embodiments of a record processing and storage system 2505 that enables record schema updates to be applied by data sources 2501 over time, while ensuring the record schema updates are backwards compatible to enable compatibility with all previously received and stored records. The record processing and storage system 2505 of FIGS. 25A-25D can be utilized to implement the record processing and storage system 2505 of FIG. 21A and/or any other embodiment of the record processing and storage system 2505 described herein. The data source 2501 of FIGS. 25A-25D can be utilized to implement the one or more data sources 2501 of FIG. 21A and/or any other embodiment of data sources 2501 described herein.

Over time, end users, such as users associated with particular data sources 2501, may wish to change their row schema. For example, users may wish to update their schema relatively frequently as they find new features they want to extract and/or utilize, for example, in implementing data analytics and/or machine learning algorithms upon the data. As the conversion of pages into segments can be delayed for hours or days as discussed previously, these changes may be desired even when data being loaded and prior to being converted into segments for long term storage. Approaches such as flushing the pending data with the older schema is not ideal, as this approach can lead to the flushed records not being included in a conversion page set 2655, which can render segments with less-favorably clustering levels due to being generated with fewer records than they otherwise would be.

FIGS. 25A-25D present a solution to this problem by utilizing schema update restriction data to restrict the set of possible schema modifications to include only those that are backwards compatible. Over time, all schema updates that are received from data sources can adhere to these requirements, which can ensure that it is possible to upgrade a given page 2515 to a new schema in all cases. During segment generation, all pages 2515 of the conversion page set 2655 at all versions of the schema are included, enabling the clustering of records into record groups to be performed across multiple schemas. If necessary, it is upgraded to the most recent schema, where the generated set of segments include all records from all pages 2515 records in accordance with the most recent schema.

This improves database systems by improving the level of clustering that can be attained, as different records with different schema versions can be grouped in the same segment based on their cluster keys. As discussed previously, improved levels of clustering attain more efficient query executions. This further improves database systems by enabling more frequent updates to schema to enhance flexibility and customization by end users. Finally, as the schemas can be updated even if data of the previous schema has not yet been stored as segments in long term storage, this further improves database systems by ensuring the delayed conversion of pages into segments isn't interrupted by schema updates, which improves levels of clustering and reduces data movement, which both improve database efficiency as discussed previously.

As illustrated in FIGS. 25A and 25B, the page generator 2511 can receive row data 2910 from one or more data sources 2501, and can generate a given page 2515 directly from one or more formatted row data 2710 received from one or more data sources 2501. For example, the page generator 2511 can generate pages to include row data 2910 as discussed in conjunction with FIG. 21C. In some cases, the row data 2910 received from data sources 2501 is unaltered and/or is only slightly modified for its inclusion in a given page 2515. In some cases, the row data 2910 can be formatted in accordance with some or all of the features of formatted row data 2710 of FIGS. 23A-23D and/or FIGS. 24A-24C.

Different row data 2910 can be generated in accordance with different schemas over time, for example, for the same types of records and/or for records intended for the same database table. To ensure differing schemas of row data 2910 are backwards compatible, the record processing and storage system 2505 can optionally implement a schema update restriction communication module 2902. The schema update restriction communication module 2902 can determine and send schema update restriction data to one or more data sources 2501 that send record streams to the record processing and storage system 2505. The schema update restriction data can indicate rules and/or instructions regarding which schema updates are allowed and/or which schema updates are not allowed. The schema update restriction data can be determined by the schema update restriction communication module 2902 via user input, via configuration of the database system 10, via retrieval from memory, and/or via another determination.

As illustrated in FIGS. 25A-25B, a data source 2501 can send row data 2910 over time via row transmission module 2706. The data source 2501 can utilize a row data generator module 2905 to apply a given row schema 2915 to records 2422 to generate this row data 2910 in accordance with the given row schema 2915. The row data 2910 can be formatted in accordance with some or all of the features of formatted row data 2710 of FIGS. 23A-23D and/or FIGS. 24A-24C, for example, where the row data generator module 2905 is implemented utilizing the record formatting module 2705 of FIGS. 23A-23D and/or FIGS. 24A-24C. Alternatively, the row data generator module 2905 can generate row data 2910 in accordance with any other format, for example, where one or more records 2422 are included in row data 2910 in accordance with a row-based format. In particular, each record can include values for each of a set of columns dictated the row schema 2915. The value of each column can be in accordance with a particular data type dictated by the row schema. A given row schema 2915 can have some or all features of the embodiments of the row schema discussed in conjunction with FIGS. 23A-23D and/or FIGS. 24A-24C.

For example, a first row schema 2915.i is utilized to generate a first plurality of row data 2910 in a first time frame t1, as illustrated in FIG. 29A. The set of pages 2515 generated by page generator 2511 from this first plurality of row data 2910 therefore include records in accordance with this first row schema 2915.1, and is denoted as the schema 2915.1 page set. Note that row schema 2915.i can be an original row schema and/or an updated row schema from a previous row schema 2915.i−1.

A different row schema 2915.i+1 is utilized to generate a second plurality of row data 2910 in a second time frame t2 that is after time frame t1, as illustrated in FIG. 25B. The set of pages 2515 generated by page generator 2511 from this second plurality of row data 2910 therefore include records in accordance with this second row schema 2915.i+1, and is denoted as the schema 2915.2 page set. The second row schema 2915.i+1 can be guaranteed to be backwards compatible with the first row schema 2915.i based on the schema update module 2906 restricting use of new schemas that are not backwards compatible with the first row schema 2915.i.

The data source 2501 can facilitate changes of row schema 2915, such as the update from row schema 2915.i to row schema 2915.i+1 of FIGS. 25A-25B, by implementing a schema update module 2906. The schema update module 2906 can facilitate schema updates while ensuring that each updated row schema 2915 is in accordance with schema update restriction data. For example, the schema update module 2906 utilizes the schema update restriction data received from the record processing and storage system 2505 as illustrated in FIG. 25A. In some cases, the schema update restriction data can include application data corresponding to the schema update module 2906 for download and/or installation by one or more data sources 2501. When this application data is executed by at least one processing module of a data source 2501, it can cause the data source 2501 to implement some or all of the functionality of the schema update module 2906 described herein. Alternatively, the data sources 2501 can otherwise receive and/or determine the schema update restriction data via other communication with the database system 10, via downloading the schema update restriction data from a server associated with the database system 10, via accessing the schema update restriction data from its own memory and/or from other memory, and/or via another determination.

FIG. 25C illustrates an embodiment of the schema update module 2906 of FIGS. 25A and 25B. An allowed schema transform set generator module 2955 can generate allowed schema transform set data 2956 based on the schema update restriction data and/or based on one or more previous row schemas 2915.1-2515.i−1 of a previous schema set 2945, for example, stored by and retrieved from at least one memory of the schema update module 2906 and/or accessible by data source 2501. The allowed schema transform set data can indicate a set of possible transforms and/or types of updates to the most recent schema data 2915.i−1 that are backwards compatible with all of the previous row schema data 2515.1-2515.i−1, as required by the schema update restriction data.

For example, the set of possible transforms: can allow deletion of columns; can allow adding of new columns but require that any new columns have a designated a default value that can be applied to old schemas; can allow data modifications such as arithmetic transforms to values in particular columns, such as changes to the unit represented by the values, that do not change the data type of the columns; can disallow changes to data types of any columns; and/or allow any other backwards compatible schema transforms that can be applied to any records 2422 under any of the previous row schema data 2515.1-2515.i−1.

The previous row schemas 2915.1-2515.i−1 can indicate all previous row schemas for the incoming record stream and/or for a corresponding database table. In some cases, the previous row schemas 2915.1-2515.i−1 only indicates the previous row schemas since the last conversion process of pages into segments, where the schema update restriction data only enforces backwards compatibility for records stored in pages prior to conversion into segments, and resets with each conversion process by the record processing and storage system 2505. Instructions regarding which previous row schemas are utilized can be included in the schema update restriction data received from the record processing and storage system 2505. In some cases, the schema update restriction data is sent to the data source 2501 in response to performing each conversion process to indicate the previous row schemas 2915.1-2515.i−1 be reset by the data source 2501 to include only the row schema 2915.i−1 that is currently being utilized to generate rows.

A proposed schema input module 2942 can be configured to receive and/or generate proposed row schemas 2915 over time. For example, at least one computing device can implement the data source 2501, and can include a display device 2940 of the least one computing device can display a graphical user interface 2941 that prompts the user to enter a proposed schema update via user input by an end user. As another example, the proposed schema input module 2942 can utilize a communication interface to communicate with another computing device, such as at least one client device associated with at least one end user, via a wired and/or wireless communication connection. In such cases, an end user can enter their proposed schema update to their own computing device via user input, and this computing device can send the inputted proposed schema update to the schema update module 2906 for receipt via the communication interface of the proposed schema input module 2942.

A proposed schema adherence determination module 2965 can generate schema update adherence data 2966 by comparing the proposed row schema 2915.i received from or generated by the proposed schema input module 2942. The schema update adherence data 2966 can indicate the proposed row schema 2915.i adheres to the allowed schema transform set data 2956 when the proposed row schema 2915.i compares favorably to the allowed schema transform set data 2956. The schema update adherence data 2966 can indicate the proposed row schema 2915.i does not adhere to the allowed schema transform set data 2956 when the proposed row schema 2915.i compares unfavorably to the allowed schema transform set data 2956. For example, the proposed row schema 2915.i compares favorably to the allowed schema transform set data 2956 when the proposed row schema 2915.i including only updates indicated as allowed by the allowed schema transform set data 2956 and/or when the proposed row schema 2915.i does not include any updates indicated as disallowed by the allowed schema transform set data 2956.

When the schema update adherence data 2966 indicates adherence, a proposed schema implementation module 2975 can be utilized to facilitate implementation of the proposed row schema 2915.i as a new row schema 2915.i. For example, the row data generator module 2905 is currently generating row data 2910 from the record stream in accordance with the most recent row schema 2915.i−1. The proposed schema implementation module 2975 can send the new row schema 2915.i to the row data generator module 2905 and/or instructions to the row data generator module 2905 that cause the row data generator module 2905 to begin generating subsequent row data 2910 from the record stream in accordance with the new row schema 2915.i. The new row schema 2915.i can also be added to the previous schema set 2945, where any subsequently proposed schemas 2915 must be backwards compatible with the new row schema 2915.i in addition to the previous row schema 2915.1-2515.i−1.

When the schema update adherence data 2966 indicates non-adherence, the proposed row schema 2915.i is not implemented as a new row schema. A schema rejection communication module 2972 can generate a notification for display by the graphical user interface 2941 indicating the proposed row schema 2915.i does not adhere to the schema update restriction data based on the previous row schemas 2915.1-2515.i−1. The schema rejection communication module 2972 can further trigger the proposed schema input module 2942 to generate a new prompt for another proposed row schema for display by the graphical user interface 2941 to enable the end user to enter another proposed schema update.

This process depicted in FIG. 25C can continue for any proposed schema updates entered and/or received via the proposed schema input module 2942 over time, where accepted row schemas that adhere to the schema update restriction data based on the previous row schemas are implemented for generation of subsequent row data 2910 and included as additional previous row schemas.

Note that while the schema update module 2906 is illustrated as being implemented by one or more data sources 2501, the schema update module 2906 can alternatively or additionally be implemented by the record processing and storage system 2505. For example, as row data 2910 is received under a new schema, and/or as proposed schemas are received from data sources 2501, the schema update module 2906 can be applied in a similar fashion to enable the record processing and storage system 2505 to determine whether the new schema adheres to the allowed set of schema updates based on the previous schemas for this data. If the record processing and storage system 2505 generates schema update adherence data 2966 indicating that the received updated schema adheres, the record processing and storage system 2505 can accept and convert the corresponding new row data 2910 into pages and/or can send a notification to the corresponding data source 2501 indicating the new schema is accepted. If the record processing and storage system 2505 generates schema update adherence data 2966 indicating that the received updated schema does not adhere, the record processing and storage system 2505 can reject and/or not convert the corresponding new row data 2910 into pages and/or can send a notification to the indicating the new schema is rejected.

FIG. 25D illustrates an embodiment of a segment generator 2517 that implements a page schema upgrade module 2920 prior to converting the pages into segments. The segment generator 2517 of FIG. 25D can be utilized to implement the segment generator 2517 of FIG. 22A and/or to implement any other embodiments of the segment generator 2517 described herein.

The segment generator 2517 can implement the page schema upgrade module 2920 to update the schema in all pages 2515 of the conversion page set 2555 to the most recent schema prior to their conversion into segments. In particular, to minimize data movement, the page schema upgrade module 2920 can optionally be implemented only after the page conversion determination module 2610 determines to initiate the conversion process in the segment generation determination data as discussed previously. Once the set of pages 2515 are all upgraded to be in accordance with the most recent, their records 2422 can be converted into segments 2424 as discussed previously. In particular, the records of the upgraded pages can be clustered into record groups 1-X, which can be converted into segments groups via the columnar rotation module 2630 and optionally, while not depicted in FIG. 25D, the metadata generator module 2640.

In this example, a set of R different row schemas were applied to incoming pages of a particular record stream since the last conversion process. For example, to ensure the page schema upgrade module 2920 can appropriately upgrade all pages via backwards compatible transforms, each of the row schemas 2915.i in the set of row schemas row schemas 2915.2-2515.R were determined to be backwards compatible with the previous row schemas 2915.1-2515.i−1 by the schema upgrade module 2906 before being implemented by the row data generator module 2905 as discussed in conjunction with FIG. 25C. For example, the backwards compatible transforms applied to the pages can correspond to one or more transforms of the allowed schema transform set data 2956 that were included in corresponding updated row schema 2915.

The page schema upgrade module 2920 can be operable to implement a plurality of schema transform modules 2922.1-2922.R to enable conversion of each of a set of pages 1-R under each of a set of schemas 2915.1-2915.R to the most recent schema 2915.R. Applying a schema transform modules 2922 to a set of pages can include applying the backward compatible changes of each subsequent schema to the schema of the set of pages to ultimately render the set of pages as being upgraded to the most recent row schema 2915.R. Applying each schema transform modules 2922.i can include applying updates included in schemas 2915.i+1-R, such as adding one or more new columns with specified default values, removing one or more columns, and/or applying a data transform to the value of data in a given column, where the data type of the column is not changed. For example, schema transform module 2922.1 is applied to page set 1 to apply all of the backwards compatible changes of schemas 2-R to pages under schema 1, while schema transform module 2922.R-1 is applied to page set R-1 to apply only backwards compatible changes of schema R to pages under schema R-1. The page set R does not undergo any changes, as it is already under the most recent schema.

In some cases, the data source sends the backwards compatible transforms utilized to update each of their row schemas from a previous row schema to a next row schema, and the page schema upgrade module 2920 applies these backwards compatible transforms to pages under the previous row schema to upgrade these pages to the next row schema. In some cases the backwards compatible transforms of a particular update correspond to a particular subset of the possible transforms in the allowed schema transform set data 2956. The backwards compatible transforms can alternatively be determined by the schema upgrade module 2920 based on each of the row schemas 1-R, for example, where data dictating each of the row schemas 1-R are received from the data source 2501 and/or are determined from the row data 2910 of each row schema 1-R.

For example, applying schema transform module 2522.2 to page set 2 includes: first upgrading page set 2 from row schema 2915.2 to row schema 2915.3 based on the backwards compatible transforms of allowed schema transform set data 2956 that were included in updating row schema 2915.2 to row schema 2915.3; next upgrading page set 2 from row schema 2915.3 to row schema 2915.4 based on the backwards compatible transforms of allowed schema transform set data 2956 that were included in updating row schema 2915.3 to row schema 2915.4; and so on until finally upgrading page set 2 from row schema 2915.R-1 to row schema 2915.R based on the backwards compatible transforms of allowed schema transform set data 2956 that were included in updating row schema 2915.R-1 to row schema 2915.R. Alternatively, the process can be simplified where a set of backwards compatible transforms are determined and applied all at once.

FIG. 26A illustrates a distribution data generator module 2720 of a database system 10. The distribution data generator module 2720 can be operable to generate dataset distribution data 2730 for one or more datasets 2705 that are received for storage by the database system 10, that are currently stored by the database system 10, and/or that are accessed by the database system 10 for query executions.

A given dataset 2705 can include a plurality of rows 1-Z. For example, each row is implemented as a record 2422. The plurality of rows 1-Z can be received over time as a stream or rows and/or can be received as a bulk set of rows.

A given dataset 2705 can include some or all of a same database table and/or a same set of rows with a common schema and/or common set of fields and/or columns. In this example, the dataset 2705 includes C fields as columns 2707.1-2707.C of the dataset 2705. Each column can have a corresponding value 2708 for some or all of the set of rows 1-Z. The values 2708 for each given column can be in accordance with a particular data type of fixed and/or variable size, where different columns can be in accordance with different data types.

At least one of the columns of dataset 2705 can be designated to store array structures 2718 as its values 2708. In this example, at least two of the columns, column 2707.2 and column 2707.C, correspond to array fields 2712.A and 2712.B, and are designated to store array structures 2718. Some or all array structures 2718 can include a plurality of array elements 2709. For example, a given array element 2709 of an array structure 2718 has a corresponding value as a primitive data variable, a literal, a data object, a data structure, and/or other data, for example, that can be expressed as a singular value. Array structures 2718 can be implemented as arrays, matrices, and/or array constructs of any dimension. Array structures 2718 can be implemented as lists, sets, tuples, objects, and/or other data structures that store multiple elements. The set of array element 2709 of the array structure 2718 can be ordered and/or unordered. For example, the array structures 2718 can be implemented as an ordered list, where its array elements are accessed and/or denoted via a corresponding one of a set of indexes.

A given array fields 2712 can require that corresponding array structures be of a fixed size, and/or can include array structures of variable sizes. For example, a first array field 2712 requires that all of its array structures 2718.1-2718.Z include exactly 5 array elements, while a second array field 2712 allows different ones of its array structures 2718.1-2718.Z to include different numbers of array elements. In this example, all of the array structures 2718.1.A-2718.Z.A of array field 2712.A include exactly M array elements, and all of the array structures 2718.1.B-2718.Z.B of array field 2712.B include exactly N array elements, where N can be the same as or different from M.

A given array field 2712 can require that all array structures each include elements of a particular type and/or a same primitive type. For example, a first array field 2712 requires that all of its array structures 2718.1-2718.Z include a set of integer values, while a second array field 2712 requires all of its array structures 2718.1-2718.Z to include a set of string values.

Alternatively, the given array field 2712 can require a given array structure includes all array elements as a same type, but allows different array structures to include array elements of different types. For example, array field 2712 can include a first array structure 2718 that includes a set of float values as its set of array elements 2709, first array structure 2718 that includes a set of Boolean values as its set of array elements 2709. Alternatively, the given array field 2712 allow a given array structure to include different array elements of different types. For example, array field 2712 can include an array structure 2718 that includes one string value and one integer value.

Alternatively or in addition, the dataset 2705 corresponds to a set of rows stored in a single segment 2424, stored in a single node 37 of a single computing device 18. This segment can be generated from a subset of rows that are part of a larger dataset, for example, where the segment is generated in a same or similar fashion as discussed in conjunction with FIGS. 10-18. In such cases, the corresponding dataset distribution data 2730 reflects local distribution data for the segment 2424, where different segments of a same database table have different local distribution data. This dataset distribution data 2730 can be generated when the corresponding segment is generated from a corresponding plurality of rows 1-Z and/or can be generated based on accessing the segment in storage, such as in a memory drives 2425 of corresponding nodes 37.

The distribution data generator module 2720 can be operable to generate column distribution data 2732 for some or all columns 2707 of the dataset 2705. The column distribution data 2732 a given column 2707 can indicate an empirical and/or probabilistic distribution of values 2708 of the given column 2707, for example, based on the respective values 2708 of the column 2707 for some or all the set of rows 1-Z of the dataset 2705. The column distribution data 2732 can be generated via different distribution schemes based on whether the corresponding column stores a singular value, or an array of multiple values.

A first type of distribution scheme can be utilized to generate the column distribution data for some or all columns 2707 that store singular values as its values 2708, such as primitive data types, strings, and/or other data objects that can be expressed as a single value and/or that is best expressed as a single value. For example, column 1's distribution data 2732.1 and column 3's distribution data 2732.3 are generated via this first type of distribution scheme based on column 1 and column 3 having data types of string and int, respectively.

The column distribution data 2732 for columns 2707 that store array structures 2718 can be generated differently than column distribution data 2732 for rows that store array structures 2718. A second type of distribution scheme can be utilized to generate the column distribution data for some or all columns 2707 correspond to an array field 2712 and/or that otherwise store multiple elements and/or are best expressed as multiple, distinct values. For example, column 2 distribution data 2732.2 and column C distribution data 2732.C are generated via this second type of distribution scheme based on column 2 and column C being array fields 2712. The second type of distribution scheme can be different from the first distribution scheme.

Rather than applying the first type of distribution scheme, for example, where the column distribution data 2732 would indicate the probability that a given array structure is equal to a particular ordered and/or unordered set of array element values, applying the second type of distribution scheme can render column distribution data 2732 that simply indicates the probability that a given array element 2709 of a given array structure 2718 is equal to a particular value and/or falls within a particular range. While differences in distribution for different indices of the array structures is lost in utilizing the second type of distribution scheme, this differentiation is not necessarily important when the values of different indices are distributed in a similar fashion and/or when query predicates generally do not filter based on values for particular array indices. In particular, applying this second type of distribution scheme can be preferred in cases where common query predicates correspond to set-based query predicates for the array elements, where the array structure is treated as an unordered set of elements.

For example, this array field distribution data 2735. for a given array field 2712 generated via this second type of distribution scheme can indicate a probability mass function (PMF) and/or a probability density function (PDF) for values of array elements 2709 of the array structure 2718 of the given array field 2712. This can be determined, for example, based on a proportion of all array elements across the array structures 2718 of all rows 1-Z for the given array field 2712 with each of a possible set of values, and/or with values that fall within different ranges of values. In particular, the value of a given array element 2709 of a given array structure 2718 in a particular column 2707 can be utilized as the random variable for the PMF and/or PDF of the column distribution data 2732 for the particular column 2707. The proportion of array elements 2709 across the array structures 2718 of all rows 1-Z for the given array field 2712 with each of a possible set of array element values can be determined based on utilizing all values stored in all array elements 2709 for all rows 1-Z for the given array field 2712. Alternatively, as the dataset 2705 may be very large and thus computationally expensive to iterate over to determine empirical distribution data as a histogram and/or based on the actual proportions, the dataset 2705 can be sampled, for example, via a statistical process, where only a proper subset of array elements 2709 1-Z have their corresponding values utilized for a given array field to determine the array field distribution data 2735.

The distribution data generator module 2720 can be implemented via one or more computing devices 18 and/or one or more other processing modules and/or memory modules of the database system 10. For example, the distribution data generator module 2720 can be implemented utilizing the parallelized data input sub-system 11 to generate distribution data for sets of rows received in a dataset all at once and/or received in a dataset as a stream over time. As another example, the distribution data generator module 2720 can be implemented utilizing the parallelized query and results sub-system 13 to generate distribution data for stored datasets utilized to process query requests received by the database system over time.

FIG. 26B illustrates a particular example of array field distribution data 2735 that is generated for one or more corresponding array fields 2712 via distribution data generator module 2720. Some or all features and/or functionality of the distribution data generator module 2720 and/or the array field distribution data 2735 of FIG. 26B can be utilized to implement the distribution data generator module 2720 and/or the array field distribution data 2735 of FIG. 26A, and/or any other embodiments of the distribution data generator module 2720 and/or the array field distribution data 2735 discussed herein.

In this example, array field distribution data 2735.A and 2735.B is generated by the distribution data generator module 2720 for the respective array fields 2712.A and 2712.B based on applying the second type of distribution scheme. Other column distribution data 2732 can optionally be generated for other ones of the set of columns 1-C, for example, based on applying the second type of distribution scheme.

In this example, the array field distribution data 2735.A is implemented as a PDF for values of the array elements 2709 in array structures 2718 of array field 2712.A. For example, the PDF is implemented in this case due to the domain of values for array elements array structures 2718 of array field 2712.A corresponding to a continuous variable with an infinite, or extremely large, set of options. The probability that the value that an array element 2709 included in array structures 2718 of array field 2712 falls within a range of values bounded by a first value a and a second value b can be expressed as:

$$P ( a \leq array element value \leq b ) = {\int }_{a}^{b} f ( x ) dx$$

The PDF function f(x) can be determined based on the values for some or all array elements 2709 for some or all rows 1-Z for the given array field 2712 as discussed previously. The distribution indicated by f(x) in FIG. 26B serves as an illustrative example, and other PDF functions f(x) can have any other types of distribution.

In this example, the array field distribution data 2735.B is implemented as a PMF for values of the array elements 2709 in array structures 2718 of array field 2712.B. For example, the PMF in this case is implemented due to the domain of values for array elements array structures 2718 of array field 2712.A corresponding to a discrete variable with a discrete set of options. The probability that the value that an array element 2709 included in array structures 2718 of array field 2712 is equal to a particular value x can be expressed as:

$$P ( array element value = x ) = g ( x )$$

The PMF function g(x) can be determined based on the values for some or all array elements 2709 for some or all rows 1-Z for the given array field 2712 as discussed previously. The distribution indicated by g(x) in FIG. 27B serves as an illustrative example, and other PMF functions g(x) can have any other types of distribution. Note that in some embodiments, all array field distribution data 2735 for all array fields are implemented as PDFs. In other embodiments, all array field distribution data 2735 for all array fields are implemented as PMFs.

In cases where the second type of distribution scheme applied to an array field includes generating a PMF and/or PDF for the values of array elements in array structures of the array field, this PMF and/or PDF can be utilized to derive distribution data indicating the probability that a given array structure includes at least one array element with a given value, and/or includes at least one array element with a value that falls within a given range of array element values, for example, as part of applying the second type of distribution scheme.

For example, the array elements of array structures can be treated as independently and identically distributed (i.i.d) random variables. This assumption of the array elements as i.i.d variables can be utilized to derive the probability that a given array structure includes at least one array element with a given value, and/or includes at least one array element with a value that falls within a given range of array element values from the PDF and/or PMF function for the array field distribution data 2735.

Consider the case where a PMF for a particular array field 2712 is generated for random variable X, where random variable X corresponds to the random variable for value that a given array elements in a given array structure of this array field. The probability that X equals x, for any possible value x for array elements in the array field, can be determined based on an empirical distribution of array element values across all rows, as discussed previously. This PMF can thus indicate probability that a given array element 2709 has value of x. For example, P(X=x)=proportion of the M*Z total array elements with values equal to x).

The probability that X is included as an array element in a given array structure can be derived as a function of this PMF based on the i.i.d. assumption:

$$\begin{matrix}P ( array structure includes at least one array element 2709. i with value x ) \\ = 1 - P ( array includes no array elements 2709. i with value x ) \\ = {\prod }_{i = 1}^{M} P ( array element 2709. i != x ) [ using i . i . d . assumption ] \\ = 1 - P P ( array element 2709 != x ) \hat{} M [ using i . i . d . assumption ] \\ = 1 - ( 1 - P ( X = x ) ) \hat{} M\end{matrix}$$

Note that the value of M can be equal to the length of the array structure if the given array field requires array structures be of a fixed length, as illustrated in FIG. 26A. Alternatively, if the array structures of the given array field are variable length, the value of M can be equal to mean length across all lengths of array structures in the given array field. The probability that an array structure has at least one array element with a value within a given range can be derived from a PDF of random variable X in a similar fashion.

FIG. 26C illustrates an embodiment of a query processing system 2510 that utilizes dataset distribution data 2730 to generate query plan data 2717 utilized to execute queries. Some or all features and/or functionality of the query processing system 2510 of FIG. 26C can be utilized to implement the query processing system 2510 and/or any other embodiment of the query processing system 2510 discussed herein.

The query processing system 2510 can include and/or access one or more memory modules 2734 that stores one or more dataset distribution data 2730 for one or more corresponding datasets 2705. For example, the distribution data generator module 2720 of FIG. 27A can facilitate storage of its generated distribution data 2730 in memory module 2734 based on generating the distribution data generator module 2720. The one or more memory modules 27314 can be implemented as memory drives 2425 of one or more nodes 37; can be implemented as disk memory 38 and/or main memory 40 of one or more computing devices 18; and/or can be implemented utilizing any other memory resources of the database system 10 accessible by the query processing system 2510.

The dataset distribution data 2730 of FIG. 26C can be generated by the distribution data generator module 2720 of FIG. 26A and/or 26B from the example dataset 2705 of FIG. 26A. The dataset distribution data 2730 of FIG. 26C can be implemented utilizing some or all features of the dataset distribution data 2730 of FIG. 26A. The column distribution data 2732 of column 2 and/or column C can be generated as array field distribution data 2735, for example, as discussed in conjunction with FIG. 26C.

For a given query expression 2511, a query plan generator module 2714 can generate query plan data 2717 that is utilized by query execution module to execute the corresponding query and generate a query resultant. The query plan generator module 2714 can be implemented via one or more computing devices 18 and/or via other processing resources and/or memory resources of the query processing system 2510.

The query plan generator module 2714 can be implemented utilizing the query operator execution flow 2517, where the query plan data 2717 includes and/or is based on the corresponding query operator execution flow 2517 as discussed previously. The query plan generator module 2714 can optionally generate other information relevant to execution of the query, such as assignment of nodes 37 for participation in a corresponding query execution plan 2405 and/or assignment to these participating nodes to one or more levels of the query execution plan. The query plan generator module 2714 can optionally sub-divide the query operator execution flow 2517 into a plurality of discrete portions for performance by nodes at different levels of the query execution plan 2405, where the assignment of each node to their respective query operator execution flow 2433 is indicated in by the query plan data 2717.

The query plan generator module 2714 can optionally select the query plan data 2717, such as the query operator execution flow 2517, the assignment of nodes to query execution plan 2405, and/or sub-dividing of the query operator execution flow 2517 into sub-flows, such as the query operator execution flows 2433 assigned to each level of the query execution plan 2405, from a plurality of valid options that would each render correct execution of the query. In particular, the query plan generator module 2714 can implement an optimizer and/or can otherwise intelligently select some or all of these portions of the query plan data 2717 to: minimize and/or improve processing resources required to execute the query; minimize and/or improve memory resources required to execute the query; minimize and/or improve execution time required to execute the query; minimize and/or improve computational complexity required to execute the query; minimize and/or improve the number of nodes 37 required to participate in execute the query via query execution plan 2405; minimize and/or improve the number or rows required and/or expected to be processed in each operator execution of the query operator execution flow 2517; arrange the query operator execution flow 2517 based on applying filtering operators expected to filter a larger number of rows before applying filtering operators expected to filter a smaller number of rows; and/or based on other optimizations and/or improvements to the query execution.

The dataset distribution data 2730 can be utilized by the query plan generator module 2714 in selecting the query plan data 2717 intelligently. For example, information regarding the distribution of values of various columns indicated by dataset distribution data 2730 and/or correlations between columns can be highly relevant in determining and/or estimating which filtering parameters specified by query predicates of the query expression will filter out the most columns. The query plan generator module 2714 can determine which filtering parameters that will be applied via one or more filtering operators, such as a join operator, a limit operator, an offset operator, a select operator, and/or a set operator, are expected to output small proportions of the set of rows and/or which filtering parameters that will be applied via one or more filtering operators are expected to output large proportions of the set of rows based on the column distribution data 2732 of dataset distribution data 2730 for one or more individual columns indicated in these various filtering parameters and/or based on multi-dimensional distribution data for a set of columns indicated in these various filtering parameters. Filtering operators that are expected to output small proportions of the set of rows can optionally be arranged before filtering operators that are expected to output large proportions of the set or rows, for example, to minimize the total number of operator executions required; to minimize the amount of memory required to store operator input data sets 2522, and/or to minimize the amount of data blocks being passed between nodes 37 of the query execution plans 2405.

As another example, information regarding the distribution of values in particular segments 2424 can be highly relevant in determining and/or estimating which segments storing rows of the dataset that need be accessed to execute the query. In some cases, a subset of segments can be determined to not store any rows meeting specified parameters of the query expression based on the dataset distribution data 2730, such a local distribution data generated for a plurality of segments of the dataset 2705. In such cases, the query plan generator module 2714 can indicate that this subset of segments need not be read at all via query execution module 2405, despite including rows of the specified dataset 2705.

The query predicates 2742 of a given query expression can optionally filter rows based on characteristics of the array structures included in one or more columns. For example, the query predicates 2742 can filter rows in the dataset 2705 based on at indicating selection of only rows with array structures 2718 that include: every value in a given list of literals identified in the query predicate as one or more of its array elements 2709; at least one value in a given list of literals identified in the query predicate as one or more of its array elements 2709; no values in given list of literals identified in the query predicate in its array elements 2709; and/or not all of the values in the given list of literals identified in the query predicate in its array elements 2709. In some cases, the query predicate indicates selection and/or filtering of rows in the dataset based on indicating selection of only rows with array structures that include values for array elements a one or more specified indexes of the array structure that meet criteria indicated in the query predicate. These set-based query predicates can optionally correspond to common types of query predicates performed upon the dataset.

In this example, the query predicates 2742 can indicate a first filtering parameter 2723.1 for rows outputted and/or processed by the query, requiring that the array structure in column 2 include either the value 1 or the value 5 as at least one of its array elements, or includes at least one element >50. The query predicates 2742 can indicate a second filtering parameter 2723.2 for rows outputted and/or processed by the query, requiring that the value 2708 of the integer stored in column 3 be greater than ten. The column 2 distribution data 2732.2 and/or column 3 distribution data 2732.3 of dataset distribution data 2730 can be utilized by the query plan generator module 2714 in selecting the query plan data 2717 based on the query predicates indicating column 2 and column 3. The multi-dimensional distribution data 2731 can optionally be utilized, for example, if the multi-dimensional distribution data 2731 involves both column 2 and column 3.

For example, if the first filtering parameter 2723.1 is expected to filter more rows than the second filtering parameter 2723.2, the query plan generator module 2714 can generate the query operator execution flow 2517 such that a first filtering operator corresponding to the filtering parameter 2723.1 can be applied to filter rows via access to values of column 2 serially before a second filtering operator corresponding to the filtering parameter 2723.1. The query plan generator module 2714 can perform other optimizations and/or further utilize the column 2 distribution data 2732.2 and/or column 3 distribution data 2732.3 in generating the resulting query plan data 2717.

FIG. 27A presents an embodiment of a query processing module that enables queries to be executed in this fashion. The operator flow generator module 2517 can be operable to generate query operator execution flows 2517 for incoming query expression 2511.

The query expression 2511 can indicate a plurality of operations be performed in accordance with a serialized expression ordering 2512. For example, as illustrated in FIG. 27A, the serialized expression ordering 2512 of the query expression 2511 can indicate that a particular expression evaluation operator 2524 be performed upon output of a filtering operator 2523, where the expression evaluation operator 2524 is thus only performed upon rows that satisfy filtering parameters of the filtering operator 2523. The query expression can be written as a SQL query expression and/or a query expression written in accordance with a different query and/or programming language.

The filtering operator 2523 can be implemented as a join operator, limit operator, offset operator, select operator, set operator, and/or any other operator that can filters out rows from given set of rows based on filtering parameters to output a subset of the set of rows. The expression evaluation operator 2524 can correspond to a mathematical expression, a Boolean expression, and/or any other expression that can be performed upon individual rows. The expression evaluation operator 2524 can optionally be implemented as any scalar query operator. Alternatively or in addition, the expression evaluation operator 2524 can be implemented as a type of operator that generates one or more output columns for a set of rows by computing a value for each given row in the set of rows as a function of other column values of the given row. The expression evaluation operator 2524 can correspond to an operator that can induce errors and/or cause exceptions to be thrown during its execution upon one or more rows, such as an expression that includes dividing by a value determined for each row that can cause exception being thrown due to the expression attempting to divide by zero for a given row.

The operator flow generator module 2517 can optionally generate a query operator execution flows 2517 by pushing down an expression evaluation operator 2524 of the query expression before one or more filtering operators 2523 of the query expression, for example, based on determining the ordering of the resulting query operator execution flow 2517 is optimal and/or has more favorable processing, resource utilization, and/or execution time than an alternative ordering of the resulting query operator execution flow 2517 where the expression evaluation operator 2524 indicated for performance after one or more filtering operators 2523 of the query expression. As illustrated in FIG. 26A, the serialized operator flow ordering 2518 can thus result in the expression evaluation operator 2524 being performed before the filtering operator 2523, despite the query expression indicating the expression evaluation operator 2524 being performed upon output of the filtering operator 2523, which could ordinarily require that the expression evaluation operator 2524 be performed after the filtering operator 2523.

The expression evaluation operator 2524 and/or the filtering operator 2523 can be implemented as particular operators 2520 of the operator execution flow 2517, where the operator execution flow 2517 is executed via the query execution module 2504. While not illustrated in FIG. 27A, the operator execution flow 2517 can include one or more other types of operators 2520 necessary for execution of the query expression 2511. While not illustrated in FIG. 27A, the operator execution flow 2517 can optionally have a plurality of parallelized branches of operators 2520.

However, rather than performing the expression evaluation operator 2524 and/or the filtering operator 2523 in a conventional fashion, the expression evaluation operator 2524 and/or the filtering operator 2523 can have their respective executions modified to enable delaying of exception throwing, accounting for the fact that the expression evaluation operator 2524 is intended for execution upon only rows included in the filtered output of the filtering operator 2523. The modified implementation of the expression evaluation operator 2524 and/or the filtering operator 2523 to delay enable delaying of exceptions can be indicated by the operator flow generator module 2514 in generating the query operator execution flow 2517.

For example, as illustrated in FIG. 27A, an exception column generation flag 2532 can be included and/or denote an ON and/or other binary value indicating an exception column should be generated in executing the expression evaluation operator 2524. In other embodiments, any other metadata and/or indication denoting whether the expression evaluation operator 2524 should generate an exception column can be indicated in the query operator execution flow 2517 generated by the operator flow generator module 2514. Operator executions of the expression evaluation operator 2524 in executing the corresponding query operator execution flow 2517 of FIG. 27A can be implemented to generate an exception column in accordance with the modified functionality of the expression evaluation operator 2524, for example, as discussed in conjunction with FIG. 26B, based on the exception column generation flag 2532 and/or other indication that the exception column be generated. Operator executions of other expression evaluation operators 2524 in executing the same or different query operator execution flow 2517 can be implemented to execute conventionally, without generating an exception column, based on not having the exception column generation flag 2532 and/or based on not having any indication that the exception column be generated. In particular, in some embodiments, an exception column is only generated for expression evaluation operators 2524 that are applied to output of one or more filtering operators 2523 in query expression 2511, and that were also pushed down before the corresponding one or more filtering operators 2523 for execution serially before these one or more filtering operators 2523 in the resulting query operator execution flow 2517 generated by the operator flow generator module 2514.

Similarly, as illustrated in FIG. 27A, an exception column check flag 2533 can be included and/or denote an ON and/or other binary value indicating an exception column should be checked in executing the filtering operator 2523. In other embodiments, any other metadata and/or indication denoting whether the expression evaluation operator 2523 should check an exception column can be indicated in the query operator execution flow 2517 generated by the operator flow generator module 2514. Operator executions of the filtering operator 2523 in executing the corresponding query operator execution flow 2517 of FIG. 27A can be implemented to check an exception column in accordance with the modified functionality of the expression evaluation operator 2524, for example, as discussed in conjunction with FIG. 27C, based on the exception column check flag 2533 and/or other indication that the exception column be checked. Operator executions of other filtering operators 2523 in executing the same or different query operator execution flow 2517 can be implemented to execute conventionally, without checking an exception column, based on not having the exception column check flag 2533 and/or based on not having any indication that the exception column be checked. In particular, in some embodiments, an exception column is only checked for filtering operators 2523 where one or more expression evaluation operators 2524 is applied to output the filtering operators 2523 in query expression 2511, and where these one or more expression evaluation operators 2524 were pushed down before filtering operators 2523 for execution serially before these one or more filtering operators 2523 in the resulting query operator execution flow 2517 generated by the operator flow generator module 2514.

FIG. 27B illustrates an embodiment of a query execution module 2504 that performs execution of an expression evaluation operator 2524. Executing the expression evaluation operator 2524 can include generating an exception column 2565. For example, the exception column 2565 is generated based on the expression evaluation operator 2524 being denoted to generate the exception column in the query operator execution flow 2517 via exception column generation flag 2532 and/or via a different indication.

In this example, the expression evaluation operator 2524 is performed upon an input data set 2551 that includes a plurality of rows 1-X. The plurality of rows 1-X can be received all at once, and/or can be received in a stream. The expression evaluation operator 2524 can be performed upon each row 1-X one at a time and/or multiple ones of the rows 1-X can be evaluated simultaneously and/or in parallel. For example, the expression evaluation operator 2524 is executed as a plurality of operator executions as rows in the set of rows 1-X are received one at a time, in data block groups, and/or all at once. The expression evaluation operator 2524 can be executed upon the set of rows 1-X based on: the plurality of rows 1-X being read from one or more segments and/or being read from memory; the plurality of rows 1-X being filtered and/or outputted by prior operators serially before the in the expression evaluation operator 2524 in the operator execution flow 2517, and/or based on rows 1-X being included in an operator input data set 2522 of the expression evaluation operator 2524 as discussed in conjunction with FIG. 25B.

Execution of the expression evaluation operator 2524 upon the plurality of rows 1-X can render generation of an output data set 2552. The output data set 2552 can include one or more column values for all of the plurality of rows 1-X based on the expression evaluation operator 2524 not filtering the plurality of rows 1-X. The rows in output data set 2552 can be generated and sent to other operators for processing one at a time, in data block groups, and/or all at once.

A corresponding expression of the expression evaluation operator 2524 can be evaluated for each row, for example, as a function of one or more columns of each row. In this example, the expression evaluation operator 2524 can be evaluated for each row as a function of the value of colA, colB, and/or colC. Output for each row 1-X indicating the result and/or output of the expression evaluated for each row can be generated, for example, as a new output column of the output data set 2552. For example, output for each row 1-X is generated in accordance with a conventional execution of the expression evaluation operator 2524. The output for some or all rows 1-X can be included in the query resultant and/or can be utilized by other operators, for example, where the output is included in an operator input data set 2522 of an operator that is serially after the expression evaluation operator 2524 in the serialized operator flow ordering 2518.

As the corresponding expression of the expression evaluation operator 2524 is evaluated for each row, an exception value 2560 can also be generated to render an exception column 2565, for example, based on the exception column generation flag of the expression evaluation operator 2524 and/or the indication to generate the exception column. A name identifying the exception columns can also be generated by the expression evaluation operator 2524, and can be guaranteed to be unique from names of other columns.

The exception value 2560 of each given row can denote whether or not an error condition occurred in evaluating the expression for the given row via expression evaluation operator 2524. For example, the exception value 2560 is optionally implemented as a binary value denoting whether or not an error occurred.

The exception value 2560 can optionally indicate further information, such as which one of a set of possible error types occurred. For example, if no error occurred and/or no exception would be thrown in performing the expression evaluation operator 2524 for a given row, the exception value for the given row can be set as zero, or a first value denoting no error occurred. If an error occurred in performing the expression evaluation operator 2524 for a given row, the particular type of error that occurred can be identified, and the exception value 2560 for the given row is set as one of a set of other values that are different from the first value, such as one of a set of different negative integer values, based on identifying which one of the set of other values corresponds to the particular type of error that occurred. As a particular example, the exception column 2565 can hold the values of SQLCode of the expression evaluation for each row indicating whether an exception would be thrown and/or which of a set of different exception types occurred.

The output data set 2552 can thus include the expression evaluation output generated for each row 1-X, the exception value 2560 generated for each row 1-X, and/or the values of one or more existing and/or previously generated columns such as colA, colB, and/or colC. The output data set 2552 can be processed by at least one subsequent operator 2520 of the plurality of operators in the operator execution flow 2517, such as filtering operator 2523 and/or one or more operators serially between the expression evaluation operator 2524 and the filtering operator 2523 in the serialized operator flow ordering 2518. For example, rows 1-X of output data set 2552 are included in the operator input data set 2522 of at least one subsequent operator 2520 of the plurality of operators in the operator execution flow 2517, such as filtering operator 2523 and/or one or more operators serially between the expression evaluation operator 2524 and the filtering operator 2523 in the serialized operator flow ordering 2518. In embodiments where one or more individual nodes execute the expression evaluation operator 2524, these nodes 37 can optionally send exception values 2560 of the exception column 2565 and/or other portions of output data set 2552 as output data blocks to a different node 37 for processing in accordance with the query execution plan 2405.

Generating the exception column 2565 in this fashion enables exception throwing and/or query aborting to be delayed, and for query execution to continue despite exceptions and/or errors that may have occurred in execution of expression evaluation operator 2524. In particular, by storing the information regarding these errors as exception values 2560 in exception column 2565, these exceptions can be delayed until the filtering operator 2523 is performed. Therefore, in these cases where the expression evaluation operator 2524 is indicated to generate an exception column 2565 as part of its execution, expression evaluation failure does not immediately terminate the query, it instead stores the corresponding SQLCode and/or information regarding the error in the exception column and continues. In particular, rather than throwing an exception and/or aborting the query execution when an error condition occurs in performing expression evaluation operator 2524 for a given row, information regarding the error is simply stored as the exception value 2560 for the corresponding row. The query execution can thus continue even when the exception value 2560 for one or more rows 1-X indicates an error condition occurred and/or an exception to be thrown, where the expression evaluation operator 2524 generates output data set 2552 to include all rows 1-X, and/or where other operators are optionally executed upon output data set 2552 despite any exceptions and/or errors that occurred in performing expression evaluation operator 2524 for one or more of the rows 1-X.

FIG. 27C illustrates an embodiment of a query execution module 2504 that performs execution of a filtering operator 2523. Executing the filtering operator 2523 can include checking an exception column 2565. for example, the exception column 2565 is checked based on the filtering operator 2523 being denoted to check the exception column in the query operator execution flow 2517 via exception column check flag 2533 and/or via a different indication.

In this example, the filtering operator 2523 is performed upon an input data set 2553 that includes plurality of rows 1-X. The plurality of rows 1-X can be received all at once, and/or can be received in a stream. The plurality of rows 1-X include an exception column 2565 that includes a plurality of exception values 2560. In some embodiments, this exception column 2565 was generated as output of an expression evaluation operator 2524 included in the same query operator execution flow 2517, for example, as discussed in conjunction with FIG. 26B.

The filtering operator 2523 can be performed upon each row 1-X one at a time and/or multiple ones of the rows 1-X can be evaluated simultaneously and/or in parallel. For example, the filtering operator 2523 is executed as a plurality of operator executions as rows in the set of rows 1-X are received one at a time, in data block groups, and/or all at once. The filtering operator 2523 can be executed upon the set of rows 1-X based on: the plurality of rows 1-X being outputted by the expression evaluation operator 2524; the plurality of rows 1-X being filtered and/or outputted by prior operators serially before the filtering operator 2523 and serially after the in the expression evaluation operator 2524 in the operator execution flow 2517; and/or based on rows 1-X being included in an operator input data set 2522 of the filtering operator 2523 as discussed in conjunction with FIG. 25B.

Execution of filtering operator 2523 upon the plurality of rows 1-X can render generation of an output data set 2554. The output data set 2554 can include a subset of the plurality of rows, where one or more column values for only one of the plurality of rows 1-X that meet and/or otherwise compare favorably to filtering parameters of the filtering operator 2523. For example, the filtering parameters denote whether each given one of the plurality of rows be included in the output data set 2554 as a function of column values of colA, colB, and/or colC. Note that in some embodiments, the filtering parameters are not a function of the output values of the expression evaluation operator 2524 based on the expression evaluation operator 2524 being expressed to be performed upon output of the filtering operator 2523 in the query expression 2511. Rows in output data set 2552 can be generated and sent as resultant data blocks and/or data block for processing via other operators for processing one at a time, in data block groups, and/or all at once.

In this example, the subset of the plurality of rows 1-X includes at least row 2 and row X based on row 2 and row X adhering to the filtering parameters. However, the subset of the plurality of rows 1-X in this example does not include row 1 based on row 1 not adhering to the filtering parameters.

Once a given rows of the set of rows 1-X is processed via filtering operator 2523 and determined to meet the filtering parameters, rather than being included in the output data set 2554 automatically, these adhering rows first have their exception value 2560 checked. For example, the exception value 2560 of each row determined to meet the filtering parameters can be checked based on the exception column check flag of the expression evaluation operator 2524 and/or the indication to generate the exception column. In some embodiments, the exception values of the exception column 2565 are checked based on a name of the exception column 2565 generated by the expression evaluation operator 2524 that is known and/or communicated to the filtering operator 2523, for example, in conjunction with denoting checking of the exception column via the exception column check flag.

Note that any rows that are not determined to meet the filtering parameters need not have their exception value 2560 checked, as these rows were never intended to be evaluated via the expression evaluation operator 2524 based on the query expression 2511 indicating the expression evaluation operator 2524 be applied only to the output of the filtering operator 2523. In this example, row 2 and row X have their exception value 2560 checked based on adhering to the filtering parameters, while row 1 does not have its exception value 2560 checked based on not adhering to the filtering parameters.

As the filtering operator 2523 writes and/or otherwise outputs rows at runtime, it must check the exception column and make sure the corresponding exception value 2560 is zero and/or otherwise indicates no error. If exception value 2560 of a given row being checked is non-zero and/or otherwise indicates an error condition occurred when the expression was evaluated for the given row via expression evaluation operator 2524, the query can be aborted.

In cases where the exception value 2560 indicates the code for a particular exception, the particular exception can be thrown based on being indicated in exception value 2560. For example, the correct exception is generated and thrown at that time, based on the SQLCode value or other unique value of the exception value 2560 identifying the exception. This can include transmitting the exception value 2560 indicating the error condition occurred to a client device for display via a display device. If the exception value 2560 indicates a particular error, the error code of exception value 2560 and/or corresponding descriptive text mapped to the particular error code can be transmitted to the client device for display via a display device. For example, this client device can correspond to a particular client device and/or end user from which the query expression was received. As another example, this client device can correspond to a user and/or administrator of the database system 10, such as a client device implemented as a computing device 18 of administrative subsystem 15 and/or another computing device communicating with the database system 10. The exception value 2560 and/or other corresponding information regarding the error can be transmitted via external network 17 and/or system communication resources 14.

If exception value 2560 of every given row that is checked by the filtering operator 2523 indicates no error condition occurred when the expression was evaluated for each of these given rows via expression evaluation operator 2524, the query can continue. In particular, the query only continues when every one of the set of rows 1-X identified to adhere to the filtering parameters of the filtering operator 2523, and that thus are outputted as the subset of rows in output data set 2554, have exception values 2560 indicating no error and/or no exception thrown. The output data set 2554 is thus generated normally, and can be included in a query resultant and/or can be sent to another operator for processing, for example, via inclusion in an operator input data set 2522 of a subsequent operator sequentially after the filtering operator 2523 in the operator execution flow 2517. As illustrated in FIG. 27C, the exception column 2565 can be projected out, where the output data set 2554 does not include exception values 2560 for any of its rows, as these exception values 2560 are no longer necessary.

Note that the query continues even if one or more rows 1-X in the input data set 2553 have exception values 2560 indicating errors occurred, so long as all of these more rows 1-X in the input data set 2553 have exception values 2560 indicating errors occurred do not adhere to the filtering parameters of the filtering operator 2523. In particular, these errors are not relevant, as the corresponding rows were never intended to have the expression evaluation operator 2524 performed because they are not included in the output of the filtering operator 2523 and because the query expression indicated the expression evaluation operator 2524 be performed upon only some or all rows that were outputted by the filtering operator 2523.

Some or all features and/or functionality of execution of the filtering operator 2523 of FIG. 26C can be optionally by performed by the query processing module 2435 of one or more individual nodes 37, for example, in accordance with executing a query operator execution flow 2433 that includes the expression evaluation operator 2524 and/or that is derived from the query operator execution flow 2517. As a particular example, a first one or more nodes 37 executes the expression evaluation operator 2524 for a given operator execution flow 2517 based on being included in a first level of the query execution plan 2405 assigned to execute the expression evaluation operator 2524, and a second one or more nodes 37 executes the filtering operator 2523 for the given operator execution flow 2517 based on being included in a second level of the query execution plan 2405 assigned to execute the filtering operator 2523 that is above the first level. The first set of nodes 37 can each send their output, including the exception values 2560 of the exception column 2565 and/or other portions of output data set 2552, to an assigned one of the second one or more nodes 37 included in the second level of the query execution plan 2405. Each of the second one or more nodes 37 can execute the filtering operator 2523 by accessing and checking exception values 2560 of the exception column 2565 received from one or more child nodes in the first level, or another level between the first level and the second level.

FIGS. 27D and 27E illustrate embodiments of a query execution module 2504 that executes example operator execution flows 2517 that include an expression evaluation operator 2524, and a filtering operator 2523 serially after the expression evaluation operator 2524. The expression evaluation operator 2524 of both FIG. 27D and FIG. 27E can have its exception column generation flag 2532 set to “ON” and/or can otherwise be denoted to generate the exception column as discussed in conjunction with FIG. 27B. The filtering operator 2523 of both FIG. 27D and FIG. 27E can have its exception column check flag 2533 set to “ON” and/or can otherwise be denoted to check the exception column as discussed in conjunction with FIG. 27C.

FIG. 27D illustrates an example where the execution of the query continues and is not interrupted. In this example, the expression evaluation operator 2524 divides 10 by the value of colA of each row in the input data set 2551. In this example, row 4 thus renders an error in performing expression evaluation operator 2524 upon row 4 based on colA of row 4 having a value of zero. The exception value 2560 for row 4 can indicate an error occurred. In this example, the exception value 2560 for row 4 is set as −1476 to denote the SQLCode for the exception caused due to attempting to divide by zero.

In this example, the other rows 1, 2, and 3 render no errors when expression evaluation operator 2524 is performed upon these rows, and thus have exception values 2560 indicating no error occurred. In this the exception value 2560 for rows 1, 2, and 3 is set as 0 to denote the SQLCode indicating no exception.

These exception values 2560 are generated as output data set 2552 of expression evaluation operator 2524, which is utilized as input data set 2553 of filtering operator 2523. The filtering parameters of filtering operator 2523 in this example is colA >0. Only rows 1, 2, and 3 are identified to meet the filtering parameters of filtering operator 2523 and therefore, only the exception values 2560 of rows 1, 2, and 3 are checked. Because the exception values 2560 of all rows that pass the filtering parameters of filtering operator 2523 indicate no errors in this example, the execution continues with no errors. In particular, while row 4 has an exception value 2560 denoting an error, this exception value is not checked because row 4 does not meet the filtering parameters of filtering operator 2523 due to its value of colA being zero.

FIG. 27E illustrates a similar example where the execution of the query is aborted. In this example, the expression evaluation operator 2524 again divides 10 by the value of colA of each row in the input data set 2551. The same output data set 2552 as the example of FIG. 27D is therefore generated, where row 4 again renders an error in performing expression evaluation operator 2524 upon row 4 based on colA of row 4 having a value of zero, and where the other rows 1, 2, and 3 render no errors when expression evaluation operator 2524 is performed upon these rows.

In this example, the filtering parameters of filtering operator 2523 is colA >4. Therefore, rows 4 is identified to meet the filtering parameters of filtering operator 2523 and has its exception values 2560 checked. Because the exception values 2560 of row 4, which passes the filtering parameters of filtering operator 2523, indicates an error in this example, the execution aborts. In particular, an error 2566 can be generated and/or displayed, for example, as an exception that is thrown. In particular, the SQLCode for the exception caused due to attempting to divide by zero can be thrown and/or displayed to a user via a display device of a client device based on this type of error being mapped to row 4's exception values 2560 of −1476.

FIG. 27F illustrates an embodiment of a query processing system 2510 that selects and executes a query operator execution flow 2517 where an expression evaluation operator 2524 is pushed down before multiple filtering operators 2523.1-2523.H. Some or all features and/or functionality of the query processing system 2510 of FIG. 27F can be utilized to implement the query processing system 2510 and/or any other embodiment of the query processing system 2510 discussed herein.

As illustrated in FIG. 27F, a query expression 2511 can include an expression evaluation operator 2524 to be performed upon output of multiple filtering operators 2523.1-2525.H. The filtering operators 2523.1-2523.H can correspond to the same or different type of operator, for example, where one of the set of filtering operators 2523.1-2523.H is a SELECT operator and another one of the set of filtering operators 2523.1-2523.H is a JOIN operator. The operator flow generator module 2514 can determine to push the expression evaluation operator 2524 before some or all of this set of multiple filtering operators 2523.1-2523.H, for example, based on an optimizer of the operator flow generator module 2514 determining that performance of the expression evaluation operator 2524 before some or all of this set of multiple filtering operators 2523.1-2523.H renders optimal and/or improved execution compared to performance of the expression evaluation operator 2524 after this set of multiple filtering operators 2523.1-2523.H. While not illustrated in FIG. 27F, the operator flow generator module 2514 can also optionally rearrange the ordering of the filtering operators 2523.1-2523.H in the serialized operator flow ordering 2518 to be different from a specified ordering of the filtering operators 2523.1-2523.H in the serialized expression ordering 2512.

Rather than checking the exception column via every filtering operator 2523.1-2523.H, the operator flow generator module 2514 can denote that only a final one of the set of filtering operators 2523.1-2523.H in the serialized operator flow ordering 2518 checks the exception column. In FIG. 27F, this is illustrated as only filtering operator 2523.H having its exception column check flag 2533 set to ON, while all other filtering operators 2523.1-2523.H-1 have their exception column check flags 2533 set to OFF. Thus, despite the expression evaluation operator 2524 being pushed down before all of these filtering operators 2523.1-2523.H, only the final filtering operator 2523.H performs the exception column check, while the other filtering operators 2523.1-2523.H are executed to perform their filtering conventionally and/or without checking the exception column. This still renders a correct query result, as the subset of rows outputted by the final filtering operators 2523.1-2523.H corresponds to the subset of rows rendered by applying all filtering operators 2523.1-2523.H, due to the other filtering operators 2523.1-2523.H-1 being applied before the final filtering operators 2523.1-2523.H to perform their own respective filtering. Performing the exception column check via only one of these filtering operators, rather than all of these filtering operators, further improves the technology of database systems by decreasing the number of exception column checks that are performed, which improves query execution efficiency while still guaranteeing that exceptions are thrown correctly.

FIG. 27G presents an embodiment a query execution module 2504 illustrating execution of a filtering operator 2523 implemented as a set intersection operator 2573. Some or all features and/or functionality of query execution module 2504 of FIG. 27G can be utilized to implement the query processing system 2510 and/or any other embodiment of the query processing system 2510 discussed herein. The set intersection operator 2573 of FIG. 27G can implement the filtering operator 2523 of FIG. 27A and/or can implement any one of the filtering operators 2523.1-2523.H of FIG. 27F.

In particular, the set intersection operator 2573 of FIG. 27G is operable to handle exception columns 2560 generated by an expression evaluation operator 2524 that was pushed down before the set intersection operator in generating of the query operator execution flow. In this example, the set intersection operator 2573 of FIG. 26G does not check the exception columns 2560, for example, based on not having an exception column check flag 2533 turned ON and/or based on being performed before another filtering operator 2523 that is designated to perform the exception column check as discussed in conjunction with FIG. 26F. While not illustrated in FIG. 27G, the set intersection operator 2573 of FIG. 27G can be further operable to check and/or project out the exception columns 2560 as discussed in FIG. 27C, for example, when the set intersection operator is a final filtering operator of a set of filtering operators 2523.1-2523.H and/or is otherwise designated to perform the exception column check.

Whether the set intersection operator 2573 is performing the exception column check or not, the set intersection operator must be modified from its conventional execution to handle the exception column received as input. In particular, as the exception column 2565 is not an actual column of the corresponding rows and is only generated for the purposes of delaying exceptions, the exception values in these columns should not influence the output of the set intersection operator 2573, as doing so could render an incorrect query resultant.

This can be achieved via a denoted set of one or more ignored columns 2570. Any columns in the input data sets 2553.A and 2553.B to the set intersection operator 2573 that are denoted as ignored columns 2570 for the set intersection operator 2573 are thus ignored by the set intersection operator when determining output data set 2554 as the set interaction of input data sets 2553.A and 2553.B. In particular, rather than operating conventionally by using every column in the input data sets 2553.A and 2553.B to perform a hash computation to check for duplicates where these duplicates correspond to rows to of the set intersection of these input data sets to be included in the output, the set intersection operator 2573 can perform modified functionality by not utilizing the one or more ignored columns 2570 when performing this hash computation to check for duplicates. In some embodiments, other types of set operators that perform hash computations upon all column values of one or more input sets of rows can similarly be modified to not perform these hash computations upon a denoted one or more ignored columns 2570.

The ignored columns 2570 for one or more set intersection operators 2573 and/or one or more other operators 2520 optionally can be determined by the operator flow generator module 2514 and/or can be indicated as metadata or other information in the resulting operator execution flow 2517. The ignored columns 2570 can be denoted based on names of the corresponding columns or other identifiers of the corresponding columns.

In this case, the ignored columns 2570 denotes the exception column 2565. For example, the name of the exception column 2565 and/or other information identifying the exception column 2565 can be utilized by the set intersection operator 2573 and/or can be included in a set of ignored columns 2570 communicated to the set intersection operator 2573 and/or indicated in metadata of the query operator execution flow 2517. In particular, to ensure that all necessary exception values are preserved and eventually checked, the operator flow generator module 2514 can determine and exception column 2565 be indicated as ignored columns 2570 for one or more set intersection operators 2573 of the query operator execution flow 2517 based on these one or more set intersection operators 2573 being serially after one or more corresponding expression evaluation operators 2524 that generate exception columns, and based on these one or more set intersection operators 2573 being serially before a final filtering operator designated to check these exception columns.

Based on the ignored columns 2570 of the set intersection operator 2573 indicating the exception column 2565, the exception column is thus not utilized by the set intersection operator 2573 in generating its output data set 2554 as the set intersection of input data sets 2553.A and 2553.B. In the example illustrated in FIG. 27G, input data set 2553.A includes row A.1 with a colA value of 1, a colB value of 10, and an exception value 1660 of 0. Input data set 2553.B includes row B.3 with a colA value of 1, a colB value of 10, and an exception value 1660 of −1. If the set intersection operator 2573 was performed conventionally, these rows would not render an intersection between input data set 2553.A and 2553.B based on having different exception values, and thus not having all columns with equal values. However, by ignoring the exception column 2565 of each of these input data sets 2553 based on the exception column 2565 being indicated as an ignored column 2570, only colA and colB values are evaluated, and the intersection is thus generated to include a row with a colA of value 1 and a colB value of 10. Note that other rows with equal column values, including equal exception values 2560, are also included in the set intersection, even though their exception values 2560 were ignored and did not influence their inclusion in the set intersection.

As illustrated in FIG. 27G, the set intersection operator 2573 can further preserve the exception columns 2565 of one or both input data sets in the output, despite these exception columns 2565 being ignored by the set intersection operator 2573. This can be important when these exception columns 2565 still need to be checked by a filtering operator 2523 that is serially after the set intersection operator 2573 in the operator execution flow 2517.

In the example illustrated in FIG. 27G, both exception values 2560 for each duplicate pair of rows are included in output data set 2554. The output data set 2554 can thus include two exception columns and/or a single exception column with an exception value expressed as a tuple indicating both exception values 2560. In such embodiments, a subsequently performed filtering operator 2523 that is denoted to check the exception column can check all exception values 2560 indicated for every row, such as both exception values 2560 indicated in output data set 2554, to ensure that any error in performing the corresponding expression evaluation operator 2524 is checked.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

The preceding technical discussion may include a discussion regarding one or more of: an advantage(s) of a solution(s) to a problem(s), a benefit(s) of a solution(s) to a problem(s), an issue(s) giving rise to a problem(s), a market need(s) for a solution(s) to a problem(s), a value proposition(s) of a solution(s) to a problem(s), and/or the like. As may be applicable, the determining of an advantage(s) of a solution(s) to a problem(s), the determination of a benefit(s) of a solution(s) to a problem(s), the determination of an issue(s) giving rise to a problem(s), the determination of a market need(s) for solving a problem(s), the determination of a value proposition(s) for solving a problem(s), and/or the like can be deemed as one or more discoveries that constitute an invention and/or constitute part of an inventive step to create an invention.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A database system comprises:
a data input sub-system is operable to:
receive, over time, a dataset that includes a plurality of rows of columnar data;
as the dataset is being received, store sets of rows of columnar data as pages of data, wherein a set of rows of columnar data corresponds to a page of data;
when a data segment amount of pages of data have been stored, process the data segment amount of pages of data to produce a data segment;
provide the data segment to a store and compute sub-system for storage therein;
a query and response sub-system is operable to:
obtain a query regarding data of the dataset prior to the dataset being stored in the store and compute sub-system as a plurality of data segments; and
provide a query operation regarding the query to the store and compute sub-system; and
the store and compute sub-system is, for the query operation, operable to:
identify data of the dataset for processing via the query operation;
determine whether the identified data is stored as a set of data segments within the store and compute sub-system;
when the identified data is not stored within the store and compute sub-system:
send a request for the identified data to the data input sub-system;
receive a set of pages in response to the request; and
execute the query operation on the received set of pages to produce a query result.

2. The database system of claim 1, wherein the data input sub-system is further operable to:
process, in accordance with a set of segment factors, the data segment amount of pages of data to produce the data segment, wherein the set of segment factors includes one or more segment factors, wherein a segment factor of the set of segment factors includes one of: an indication of a number of records to include in the data segment, an indication of a number of segments to include in a segment group. an identification of how to segment a data partition based on storage capabilities of the store and compute sub-system, and an indication of a number of data segments for a data partition based on a redundancy storage encoding scheme.

3. The database system of claim 1, wherein the data input sub-system is further operable to process the data segment amount of pages of data to produce the data segment by one or more of:
dividing the rows of columnar data of the data segment amount of pages of data into a plurality of data slabs;
generating a primary index for the rows of columnar data of the data segment amount of pages of data and associating the primary index with the data segment;
generating a secondary index for the rows of columnar data of the data segment amount of pages of data and associating the secondary index with the data segment;
error encoding the rows of columnar data of the data segment amount of pages of data; and
generating a manifest regarding metadata of the rows of columnar data of the data segment amount of pages of data and associating the manifest with the data segment.

4. The database system of claim 1, wherein the query and response sub-system is further operable to obtain the query by:
receiving an initial query that includes a plurality of initial query operations,
determining a set of optimizations for the initial query; and
implementing the set of optimizations on the plurality of initial query operations to produce the query.

5. The database system of claim 1, wherein the store and compute sub-system comprises:
a plurality of computing device clusters, wherein a computing device cluster of the plurality of computing device clusters includes a plurality of computing devices, wherein a computing device of the plurality of computing devices includes a plurality of computing nodes, and wherein a computing node of the plurality of computing nodes includes a plurality of processing core resources.

6. The database system of claim 5 further comprises:
a lead computing device of a first computing device cluster of the plurality of computing device clusters is operable to:
receive the data segment from the data input sub-system;
identify a target computing device of the first computing device to store the data segment; and
send the data segment to the target computing device;
a lead computing node of the target computing device is operable to:
divide the data segment into a plurality of a sub-segments; and
send the plurality of sub-segments to the plurality of computing nodes of the target computing device;
a lead processing core resource of a first computing node of the plurality of computing nodes of the target computing device is operable to:
receive a sub-segment of the plurality of sub-segments of the data segment;
divide the sub-segment into a plurality of divisions of the sub-segment; and
send the plurality of divisions of the sub-segment to the plurality of processing core resources of the first computing node.

7. The database system of claim 5 further comprises:
a lead computing device of a first computing device cluster of the plurality of computing device clusters is operable to:
receiver the query operations that identify the data of the dataset;
determine that the identified data is not stored as the set of data segments within the store and compute sub-system;
receive the set of pages from the data input sub-system regarding the identified data;
identify a target computing device of the first computing device to store the sets of pages; and
send the sets of pages to the target computing device;
a lead computing node of the target computing device is operable to:
divide the sets of pages into a plurality of a sub-sets of pages; and
send the plurality of sub-sets of pages to the plurality of computing nodes of the target computing device;
a lead processing core resource of a first computing node of the plurality of computing nodes of the target computing device is operable to:
receive a sub-set of pages of the plurality of sub-sets of pages;
divide the sub-set of pages into a plurality of divisions of the sub-set; and
send the plurality of divisions of the sub-set to the plurality of processing core resources of the first computing node; and
the plurality of processing core resources of the first computing node are operable to execute the query operation on the plurality of divisions of the sub-set to produce a first portion of the query result.

8. The database system of claim 1, wherein the store and compute sub-system is further operable to:
when the identified data is stored within the store and compute sub-system:
identify stored data segments that correspond to the identified data; and
execute the query operation on the stored data segments to produce the query result.

9. The database system of claim 1 further comprises one or more of:
the set of rows of columnar data including one or more rows of columnar data;
the set of data segments including one or more data segments;
the set of pages of data including a plurality of pages of data;
the data of the dataset includes one or more rows of the plurality of rows of columnar data;
the query operation includes one or more query operators, and
a query operator is a specific function performed on data.

10. A computer readable memory comprises:
a first memory that stores operational instructions that, when executed by a data input sub-system of a database system, causes the data input sub-system to:
receive, over time, a dataset that includes a plurality of rows of columnar data;
as the dataset is being received, store sets of rows of columnar data as pages of data, wherein a set of rows of columnar data corresponds to a page of data;
when a data segment amount of pages of data have been stored, process the data segment amount of pages of data to produce a data segment;
provide the data segment to a store and compute sub-system for storage therein;
a second memory that stores operational instructions that, when executed by a query and response sub-system of the database system, causes the query and response sub-system to:
obtain a query regarding data of the dataset prior to the dataset being stored in the store and compute sub-system as a plurality of data segments; and
provide a query operation regarding the query to the store and compute sub-system; and
a third memory that stores operational instructions that, when executed by a store and compute sub-system of the database system, causes the store and compute sub-system to:
identify data of the dataset for processing via the query operation;
determine whether the identified data is stored as a set of data segments within the store and compute sub-system;
when the identified data is not stored within the store and compute sub-system:
send a request for the identified data to the data input sub-system;
receive a set of pages in response to the request; and
execute the query operation on the received set of pages to produce a query result.

11. The computer readable memory of claim 10, wherein the third memory further stores operational instructions that, when executed by the store and compute sub-system, causes the store and compute sub-system to:
process, in accordance with a set of segment factors, the data segment amount of pages of data to produce the data segment, wherein the set of segment factors includes one or more segment factors, wherein a segment factor of the set of segment factors includes one of: an indication of a number of records to include in the data segment, an indication of a number of segments to include in a segment group. an identification of how to segment a data partition based on storage capabilities of the store and compute sub-system, and an indication of a number of data segments for a data partition based on a redundancy storage encoding scheme.

12. The computer readable memory of claim 10, wherein first memory further stores operational instructions that, when executed by the data input sub-system, causes the data input sub-system to process the data segment amount of pages of data to produce the data segment by one or more of:
dividing the rows of columnar data of the data segment amount of pages of data into a plurality of data slabs;
generating a primary index for the rows of columnar data of the data segment amount of pages of data and associating the primary index with the data segment;
generating a secondary index for the rows of columnar data of the data segment amount of pages of data and associating the secondary index with the data segment;
error encoding the rows of columnar data of the data segment amount of pages of data; and
generating a manifest regarding metadata of the rows of columnar data of the data segment amount of pages of data and associating the manifest with the data segment.

13. The computer readable memory of claim 10, wherein second memory further stores operational instructions that, when executed by a query and response sub-system of the database system, causes the query and response sub-system to obtain the query by:
receiving an initial query that includes a plurality of initial query operations;
determining a set of optimizations for the initial query; and
implementing the set of optimizations on the plurality of initial query operations to produce the query.

14. The computer readable memory of claim 10, wherein the store and compute sub-system comprises:
a plurality of computing device clusters, wherein a computing device cluster of the plurality of computing device clusters includes a plurality of computing devices, wherein a computing device of the plurality of computing devices includes a plurality of computing nodes, and wherein a computing node of the plurality of computing nodes includes a plurality of processing core resources.

15. The computer readable memory of claim 14, wherein the third memory further stores operational instructions that causes:
a lead computing device of a first computing device cluster of the plurality of computing device clusters to:
receive the data segment from the data input sub-system;
identify a target computing device of the first computing device to store the data segment; and
send the data segment to the target computing device;
a lead computing node of the target computing device to:
divide the data segment into a plurality of a sub-segments; and
send the plurality of sub-segments to the plurality of computing nodes of the target computing device;
a lead processing core resource of a first computing node of the plurality of computing nodes of the target computing device to:
receive a sub-segment of the plurality of sub-segments of the data segment;
divide the sub-segment into a plurality of divisions of the sub-segment; and
send the plurality of divisions of the sub-segment to the plurality of processing core resources of the first computing node.

16. The computer readable memory of claim 14, wherein the third memory further stores operational instructions that causes:
a lead computing device of a first computing device cluster of the plurality of computing device clusters to:
receiver the query operations that identify the data of the dataset;
determine that the identified data is not stored as the set of data segments within the store and compute sub-system;
receive the set of pages from the data input sub-system regarding the identified data;
identify a target computing device of the first computing device to store the sets of pages; and
send the sets of pages to the target computing device;
a lead computing node of the target computing device to:
divide the sets of pages into a plurality of a sub-sets of pages; and
send the plurality of sub-sets of pages to the plurality of computing nodes of the target computing device;
a lead processing core resource of a first computing node of the plurality of computing nodes of the target computing device to:
receive a sub-set of pages of the plurality of sub-sets of pages;
divide the sub-set of pages into a plurality of divisions of the sub-set; and
send the plurality of divisions of the sub-set to the plurality of processing core resources of the first computing node; and
the plurality of processing core resources of the first computing node are operable to execute the query operation on the plurality of divisions of the sub-set to produce a first portion of the query result.

17. The computer readable memory of claim 10, wherein the third memory further stores operational instructions that, when executed by the store and compute sub-system, causes the store and compute sub-system to:
when the identified data is stored within the store and compute sub-system:
identify stored data segments that correspond to the identified data; and
execute the query operation on the stored data segments to produce the query result.

18. The computer readable memory of claim 10 further comprises one or more of:
the set of rows of columnar data including one or more rows of columnar data;
the set of data segments including one or more data segments;
the set of pages of data including a plurality of pages of data;
the data of the dataset includes one or more rows of the plurality of rows of columnar data;
the query operation includes one or more query operators; and
a query operator is a specific function performed on data.
